(19) United States
(12) Patent Application Publication
(10) Pub. No.: US 2026/0055002 A1
(43) Pub. Date: Feb. 26, 2026

(54) HIGHLY-POROUS ELONGATE CERAMIC PARTICLES FOR TRANSITION METAL GETTERING IN BATTERIES

(71) Applicant: Sila Nanotechnologies, Inc., Alameda, CA (US)

(72) Inventors: Ahmed ELDESOKY, Oakland, CA (US); Jason CHAN, Hayward, CA (US); David Michael LYNCH, Menlo Park, CA (US); Justin Michael VIRGILI, Berkeley, CA (US); Gleb Nikolayevich Yushin, Atlanta, GA (US)

(21) Appl. No.: 19/305,486

(22) Filed: Aug. 20, 2025

Related U.S. Application Data
(60) Provisional application No. 63/685,598, filed on Aug. 21, 2024.

(51) Int. Cl. C01F 7/02; H01M 10/0525; H01M 50/434; H01M 50/46

(52) U.S. Cl. CPC C01F 7/02; H01M 10/0525; H01M 50/434; H01M 50/46; C01P 2002/72; C01P 2004/03; C01P 2004/61; C01P 2004/62; C01P 2004/64; C01P 2006/12; C01P 2006/14; C01P 2006/16

(57) ABSTRACT

Disclosed are elongate ceramic (nano)particles that include γ-alumina. In some implementations: a mass fraction of the γ-alumina in the elongate ceramic (nano)particles is in a range of about 70 to about 100 wt. %, a Brunauer-Emmett-Teller specific surface area (BET-SSA) of the elongate ceramic (nano)particles is in a range of about 30 to about 400 m²/g, an average aspect ratio of the elongate ceramic (nano)particles is at least about 3, and a cumulative pore volume of the elongate ceramic (nano)particles in a pore width range of 7 to 20 nm is in a range of about 1.0×10⁻² to about 1.0 cm³/g. A separator, an integrated electrode-separator component, and a lithium-ion battery incorporating the elongate ceramic (nano)particles are also disclosed. Related methods of making a separator, an integrated electrode-separator component, and a lithium-ion battery are also disclosed.

### CROSS-REFERENCE TO RELATED APPLICATIONS

The present Application for Patent claims the benefit of U.S. Provisional Application No. 63/685,598, entitled “HIGHLY-POROUS ELONGATE CERAMIC PARTICLES FOR TRANSITION METAL GETTERING IN BATTERIES,” filed Aug. 21, 2024, assigned to the assignee hereof, and expressly incorporated herein by reference in its entirety.

### BACKGROUND

### Field

Aspects of the present disclosure relate generally to energy storage devices and, more particularly, to battery technology and the like. Aspects of the present disclosure relate to ceramic (nano)fiber membranes and their use as a separator in an anode-separator composite for a battery, a supercapacitor or another energy storage device. Aspects of the present disclosure relate to methods of making a ceramic (nano)fiber membrane.

### Background

As the demand for energy storage continues to surge driven by growth in energy sectors such as portable consumer electronics, electric vehicles and grid energy storage systems, there is an incessant need to improve energy and power densities of lithium-ion batteries (LIBs) without compromising safety. To achieve this target, higher areal loading or higher energy density electrodes are necessary, which often increase mechanical stresses and self-heating and thus associated safety risks of the resultant batteries. Advanced separators, whose primary roles are to enable ion transport and to prevent a short circuit by avoiding a direct electrical contact between the electrodes, can play important roles to both enhance cell power density and improve safety features. The LIB separators typically satisfy several basic criteria for their use, such as: (a) high open porosity, low tortuosity, and (for applications that use liquid electrolyte) high wettability by liquid electrolyte(s) to facilitate rapid molecule/Li-ion transport, (b) good chemical and electrochemical stability in contact with the electrolyte and electrode materials across an operational potential range (that may result in strong oxidizing and reducing environments during charge/discharge), and (c) strong mechanical stability for materials manufacturing and cell assembly. Indeed, LIB rate performance may be significantly reduced if a separator does not allow fast ion transport at high areal current density, while high separator shrinkage during heating or high-temperature operations may induce formation of internal short-circuits in LIBs. In addition, separators should ideally be flame-retardant to minimize the probability of catastrophic events, such as fire or explosion originating from either a thermal runaway reaction and/or a short circuit.

Commonly employed LIB separators are manufactured from either polyethylene (PE) or polypropylene (PP), which have advantages in terms of low cost, excellent electrochemical stability and mechanical strength, but do not meet all of the above desired LIB separator criteria. In particular, conventional LIB separators exhibit poor thermal stability (e.g., glass transition temperature (T_{g}) of −110 and −20° C., low melting temperature (Tm) of 135 and 170° C., and thermal decomposition temperature (T_{d}) of 325-450° C. and 328-410° C., respectively, for PE and PP separators) could result in serious safety issues (e.g., smoke, fire or even explosion) when operated at elevated temperature or under extreme conditions. Moreover, conventional LIB separators' non-polar chemical structure (e.g., dielectric constant value F=1.6 and 2.1, respectively, for PE and PP), small porosity and high tortuosity lead to the poor electrolyte wettability and low ion conductivity. Although these issues may be somewhat alleviated when the surfaces of PE or PP separators are coated with particulate inorganic materials, such fabrication procedures are complex, costly, increase separator thickness, reduce separator flexibility and processability, often enhance moisture entrapment and offer limited improvements. Thus, improved separators based on ceramic (nano)particles have been developed, which may be formed by simpler fabrication methods. Elongate ceramic (nano)particles (e.g., ceramic (nano)fibers) may be employed to make thin separator membranes with good mechanical, thermal, and electrochemical stability characteristics.

Cathode active materials comprising manganese (Mn) have been employed in lithium-ion batteries. Mn-comprising cathode active materials include (1) layered transition metal oxides (e.g., NMC (lithium nickel cobalt manganese oxide) compounds), (2) spinel-type lithium manganese oxide (LMO) compounds, (3) spinel-type lithium manganese nickel oxide (LMNO) compounds, and (4) olivine-type lithium manganese iron phosphate (LMFP) compounds. NMC compounds have been widely used for some lithium-ion batteries (e.g., automotive applications). LMO and LMNO cathodes can achieve relatively high voltages and relatively high energy densities (e.g., ˜650 Wh/kg for LMNO) without the use of any cobalt (Co) and exhibit relatively fast charging and discharging speeds (due to low internal resistance). LMFP is known to offer higher energy densities than LFP (lithium iron phosphate) (e.g., higher by about 15 to 20% in some cases) due to higher voltages, accompanied by similar levels of safety and thermal stability characteristics. Accordingly, there is potential benefit in wider adoption of some Mn-comprising (including Mn-dominant) cathode materials (e.g., Mn-rich NCM, LMO, LMNO, LMFP) in lithium-ion batteries. Herein, the term Mn-rich NCM refers to NCM compositions in which the atomic fraction of Mn in the mixture of Ni, Co, and Mn exceeds 50 at. %. However, Mn ions may dissolve into the electrolyte from some Mn-comprising cathode materials. When these Mn ions migrate to the anode and deposit on the anode surface, parasitic reactions may occur leading to capacity loss. Some of such reactions may be autocatalytic, which would accelerate the rate of battery degradation over time. In addition to Mn, dissolution of other transition metals in such cathodes or other cathodes (e.g., Ni, Co, Fe, among others) may induce similar negative issues and lead to battery degradation, especially when operating at elevated temperatures.

Accordingly, there remains a need for improved elongate ceramic (nano)particles that can getter (remove) transition metal ions (e.g., Mn ions, Ni ions, Co ions, Fe ions, Mo ions, Cr ions, Ti ions, and/or Nb ions) dissolved in an electrolyte and significantly slow down battery degradation. Furthermore, there remains a need for improved separators (membranes) and integrated electrode-separator components incorporating such improved elongate ceramic (nano)particles. Yet furthermore, there remains a need for improved lithium-ion batteries incorporating such separators or integrated electrode-separator components in which the dissolved transition metal ions are removed from the electrolyte, thereby reducing the occurrence of anode degradation.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, elongate ceramic particles includes 7-alumina, wherein: a mass fraction of the γ-alumina in the elongate ceramic particles is in a range of about 70 to about 100 wt. %; a Brunauer-Emmett-Teller specific surface area (BET-SSA) of the elongate ceramic particles is in a range of about 30 to about 400 m²/g; an average aspect ratio of the elongate ceramic particles is at least about 3; and a cumulative pore volume of the elongate ceramic particles in a pore width range of 7 to 20 nm is in a range of about 1.0×10⁻² to about 1.0 cm³/g.

In an aspect, a method comprising: providing a polymer membrane; coating a dispersion comprising elongate ceramic particles comprising 7-alumina on the polymer membrane to form a separator coating on the polymer membrane, a separator comprising the polymer membrane and the separator coating disposed on the polymer membrane, wherein: a mass fraction of the γ-alumina in the elongate ceramic particles is in a range of about 70 to about 100 wt. %; a Brunauer-Emmett-Teller specific surface area (BET-SSA) of the elongate ceramic particles is in a range of about 30 to about 400 m²/g; an average aspect ratio of the elongate ceramic particles is at least about 3; and a cumulative pore volume of the elongate ceramic particles in a pore width range of 7 to 20 nm is in a range of about 1.0×10⁻² to about 1.0 cm³/g.

In an aspect, a method includes providing an electrode coating disposed on a current collector and comprising electrode active material; and coating a dispersion comprising elongate ceramic particles comprising γ-alumina on the electrode coating to form a separator coating on the electrode coating, an integrated electrode-separator component comprising the electrode coating disposed on the current collector and the separator coating disposed on the electrode coating, wherein: a mass fraction of the γ-alumina in the elongate ceramic particles is in a range of about 70 to about 100 wt. %; a Brunauer-Emmett-Teller specific surface area (BET-SSA) of the elongate ceramic particles is in a range of about 30 to about 400 m²/g; an average aspect ratio of the elongate ceramic particles is at least about 3; and a cumulative pore volume of the elongate ceramic particles in a pore width range of 7 to 20 nm is in a range of about 1.0×10⁻² to about 1.0 cm³/g.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw a contrast between different components, elements, features, etc., and are not meant to convey the use of particular materials, colors, or other properties that may be defined outside of the present disclosure for the specific pattern employed.

FIG. 1 illustrates an exemplary Li-ion battery in which the components, materials, processes, and other techniques described herein may be implemented.

FIG. 2 is a flow diagram of a process of making a Li-ion battery according to one aspect.

FIG. 3 is a flow diagram of a process of making a separator coating in one aspect.

FIG. 4A is a flow diagram of a process of sequentially forming an electrode coating and a separator coating in one aspect.

FIG. 4B is a flow diagram of a process of making a Li-ion battery in which the process of FIG. 4A is employed.

FIG. 4C is a flow diagram of another process of making a Li-ion battery in which the process of FIG. 4A is employed.

FIG. 5 is a flow diagram of a process of making elongate ceramic (nano)particles in one aspect.

FIG. 6A shows a scanning electron microscope (SEM) image of a sample of elongate ceramic (nano)particles.

FIG. 6B shows an SEM image of a sample of commercially available ceramic particles.

FIGS. 7A and 7B show plan view and cross-sectional view SEM images, respectively, of a coating of a sample of elongate ceramic (nano)particles.

FIG. 8 is a flow diagram of a process of carrying out testing (e.g., storage testing, cycling) of Li-ion battery test cells of respective types.

FIG. 9 (Table 1) shows selected data relating to composition and properties of elongate ceramic (nano)particle-based examples and comparative examples.

FIGS. 10A and 10B show cumulative pore volume and incremental pore volume data, respectively, of elongate ceramic (nano)particle examples and a comparative example.

FIGS. 11A and 11C show cumulative pore volume and incremental pore volume data, respectively, of elongate ceramic (nano)particle examples of respective mass fractions of γ-alumina and α-alumina phases. FIG. 11B shows cumulative pore volume data of two of the elongate ceramic (nano)particle examples of FIG. 11A in greater detail.

FIGS. 12A and 12B show cumulative pore volume and incremental pore volume data, respectively, of an elongate ceramic (nano)particle example and comparative examples.

FIGS. 13A, 13B, and 13C show the dependence of the reduction of Mn ion concentration on total mesopore pore volume, total micropore pore volume, and total macropore pore volume, respectively, for elongate ceramic (nano)particle examples and a comparative example.

FIG. 14 shows x-ray diffraction data of elongate ceramic (nano)particle examples and comparative examples.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternative embodiments may be devised without departing from the scope of the invention. Additionally, well-known elements of the invention may not be described in detail or may be omitted so as not to obscure other, more relevant details.

Any numerical range described herein with respect to any embodiment of the present invention is intended not only to define the upper and lower bounds of the associated numerical range but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about,” “approximately,” “around,” “≈” or “˜” 80%, which encompasses “exactly” 80% (e.g., 80.0000 . . . %) plus some range around 80%. In some designs, the range encompassed around a measurement or threshold via the “about,” “approximately,” “around,” or “˜” qualifier may encompass the level of precision for which the respective measurement or threshold is capable of being measured by the most accurate commercially available instrumentation as of the priority date of the subject application.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denote the weight relationship between the element or component and any other elements or components in the composition or article for which a part by weight is expressed. Thus, in a mixture containing 2 parts by weight of component X and 5 parts by weight of component Y, components X and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

In the following description, various material properties are described so as to characterize materials (e.g., binders, molecules, particles, powders, slurries, electrodes, separators, electrolytes, battery cells, etc.) in various states. Note that a person of ordinary skill in the art (POSITA) is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types, such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| Material | Property | Measurement | Measurement |
|---|---|---|---|
| Type | Type | Instrumentation | Technique |
| Active | Coulombic | Potentiostat | Charge (current) is passed to |
| Material | Efficiency | | an electrode containing the |
| | | | active material of interest |
| | | | until a given voltage limit is |
| | | | reached. Then, the current is |
| | | | reversed (discharge current) |
| | | | until a second voltage limit is |
| | | | reached. The ratio of the two |
| | | | charges passed determines |
| | | | the Coulombic Efficiency |
| | | | (CE). In the simplest case, |
| | | | the charge and discharge |
| | | | currents may be constant |
| | | | and often have absolute |
| | | | values that are the same or |
| | | | close to each other. It should |
| | | | be understood though that in |
| | | | some experiments, either |
| | | | charge current or discharge |
| | | | current or both may be |
| | | | changing during such |
| | | | experiments (e.g., be initially |
| | | | constant and when the |
| | | | voltage limit is reached, |
| | | | diminishing to a |
| | | | predetermined value). In |
| | | | addition, the absolute value |
| | | | of the charge and discharge |
| | | | currents may differ. |
| Active | Partial | Manometer | The partial vapor pressure |
| Material | Vapor | | of an active material in a |
| | Pressure | | mixture (e.g., composite |
| | (e.g., Torr.) | | particle) at a particular |
| | at a | | temperature is given by the |
| | Temperature | | known vapor pressure of the |
| | (e.g., K) | | active material multiplied by |
| | | | its mole fraction in the |
| | | | mixture. |
| Active | Volume | Gas pycnometer | Gas pycnometer measures |
| Material | | | the skeletal volume of a |
| Particle | | | material by gas displacement |
| | | | using the volume-pressure |
| | | | relationship of Boyle's Law. |
| | | | A sample of known mass is |
| | | | placed into the sample |
| | | | chamber and maintained at |
| | | | a constant temperature. An |
| | | | inert gas, typically helium, is |
| | | | used as the displacement |
| | | | medium. |
| | | | Note: A vol. % change may |
| | | | be calculated from two |
| | | | volume measurements of the |
| | | | active material particle. |
| Active | Open | nitrogen | Nitrogen sorption/desorption |
| Material | Internal | sorption/desorption | isotherm (typically at 77 K) is |
| Particle | Pore Volume | isotherm | collected and analyzed to |
| | (e.g., cc/g or | | estimate the total amount of |
| | cm³/g) | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such |
| | | | as Non-Local Density |
| | | | Functional Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in |
| | Size | electron microscope | combination with image |
| | Distributions | (TEM), scanning | analyses, laser microscopy |
| | (e.g., nm) | transmission | (for larger particles and |
| | | microscope (STEM), | larger pores) in combination |
| | | laser microscope, | with image analyses, optical |
| | | Synchrotron X-ray, | microscopy (for larger |
| | | X-ray microscope | particles and larger pores), |
| | | | neutron scattering, X-ray |
| | | | scattering, X-ray microscopy |
| | | | imaging may be employed to |
| | | | measure pore sizes (average |
| | | | pore size or pore size |
| | | | distribution) in different size |
| | | | ranges (in addition to the |
| | | | analysis of the |
| | | | sorption/desorption |
| | | | isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas |
| | | | pycnometer and comparing |
| | | | them to the theoretical |
| | | | density of the individual |
| | | | material components present |
| | | | in Si-comprising particles. In |
| | | | addition, closed internal |
| | | | pore volume may be |
| | | | estimated by comparing the |
| | | | total pore volume estimated |
| | | | from neutron scattering and |
| | | | the nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced |
| | (e.g., nm) | | by a solid can be determined. |
| Active | Size | TEM, STEM, SEM, | Laser particle size |
| Material | (e.g., nm, μm, | X-Ray, PSA, etc. | distribution analysis (LPSA), |
| Particle | etc.) | | laser image analysis, electron |
| | | | microscopy, optical |
| | | | microscopy or other suitable |
| | | | techniques |
| | | | transmission electron |
| | | | microscopy (TEM), scanning |
| | | | transmission electron |
| | | | microscopy (STEM), |
| | | | scanning electron |
| | | | microscopy (SEM)), X-ray |
| | | | microscopy, X-ray |
| | | | diffraction, neutron |
| | | | scattering and other suitable |
| | | | techniques |
| Active | Composition | Balance | Note #1: A wt. % change |
| Material | (e.g., mass | | may be calculated by |
| Particle | fraction or | | comparing the mass fraction |
| | wt. %, mg, | | of a material in the particle |
| | number of | | relative to the total particle |
| | atoms, etc.) | | mass. |
| | | | Note #2: The capacity |
| | | | attributable to particular |
| | | | active material(s) in the |
| | | | particle may be derived from |
| | | | the composition, based on |
| | | | the known (e.g., theoretical |
| | | | or practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition of may |
| | | | alternatively be |
| | | | characterized by a number |
| | | | of atoms of a particular |
| | | | element (e.g., Si, C, etc.). In |
| | | | case of atoms, the number of |
| | | | atoms may be estimated |
| | | | from the weight of that atom |
| | | | in the particle (e.g., based on |
| | | | gas chromatography) |
| Active | Composition | X-ray Fluorescence | |
| Material | (e.g., mass | (XRF), Inductively | |
| Particle | fraction or | Coupled Plasma | |
| | wt. % of | Optical Emission | |
| | various | Spectroscopy (ICP- | |
| | atomic | OES); Energy | |
| | elements or | Dispersive | |
| | molecules, | Spectroscopy (EDS), | |
| | atomic | Wavelength | |
| | fraction or | Dispersive | |
| | at. % of | Spectroscopy | |
| | various | (WDS), Electron | |
| | elements, | Energy Loss | |
| | etc.) | Spectroscopy | |
| | | (EELS), Nuclear | |
| | | Magnetic Resonance | |
| | | (NMR); Secondary | |
| | | Ion Mass | |
| | | Spectrometry | |
| | | (SIMS); X-Ray | |
| | | Photoelectron | |
| | | Spectroscopy (XPS); | |
| | | Fourier Transform | |
| | | Infrared | |
| | | Spectroscopy (FTIR) | |
| | | and Raman | |
| | | Spectroscopy | |
| | | (Raman) | |
| Active | Specific | Potentiostat | An electrode containing an |
| Material | Capacity | | active anode or cathode |
| Particle, | | | material of interest is |
| Battery | | | charged or discharged (by |
| Half-Cell | | | passing electrical current to |
| | | | the electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) |
| | | | gives this quantity (e.g., in |
| | | | mAh/g). The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET-SSA | BET instrument | A sample is placed into a |
| Material | (e.g., m²/g) | | sealed chamber at 77 K, |
| Particle | | | where nitrogen is introduced |
| | | | at increasing pressure. The |
| | | | change in pressure of the |
| | | | nitrogen is used to calculate |
| | | | the surface area of the |
| | | | sample. |
| Active | Aspect Ratio | SEM, TEM | The dimensions and shape of |
| Material | | | the particles are typically |
| Particle | | | measured by using SEM or |
| | | | TEM or (for large particles) |
| | | | by using optical microscopy. |
| Active | True Density | Argon Gas | True density values may be |
| Material | of Particle | Pycnometer | measured by using an argon |
| Particle | (e.g., g/cc or | | gas pycnometer and |
| | g/cm³) | | comparing to the theoretical |
| | | | density of the individual |
| | | | material components present |
| | | | in the particle. |
| Active | Particle Size | Dynamic light | laser particle size |
| Material | Distribution | scattering particle | distribution analysis (LPSA) |
| Particle | (e.g., nm or | size analyzer, | on well-dispersed particle |
| Population | μm) | scanning electron | suspensions in one example |
| | | microscope | or by image analysis of |
| | | | electron microscopy images, |
| | | | or by other suitable |
| | | | techniques. While there are |
| | | | diverse processes of |
| | | | measuring PSDs, laser |
| | | | particle size distribution |
| | | | analysis (LPSA) is quite |
| | | | efficient for some |
| | | | applications. Note that other |
| | | | types of particle size |
| | | | distribution (e.g., by SEM |
| | | | image analysis) could also be |
| | | | utilized (and may even lead |
| | | | to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D₁₀), a |
| | | | fiftieth-percentile volume- |
| | | | weighted particle size |
| | | | parameter (e.g., abbreviated |
| | | | as D₅₀), a ninetieth-percentile |
| | | | volume-weighted particle |
| | | | size parameter (e.g., |
| | | | abbreviated as D₉₀), and a |
| | | | ninety-ninth-percentile |
| | | | volume-weighted particle |
| | | | size parameter (e.g., |
| | | | abbreviated as D₉₉). |
| Active | Width (e.g., | PSA | Parameters relating to |
| Material | nm) | | characteristic widths of the |
| Particle | | | PSD may be derived from |
| Population | | | these particle size |
| | | | parameters, such as D₅₀ − |
| | | | D₁₀ (sometimes referred to |
| | | | herein as a left width), D₉₀ − |
| | | | D₅₀ (sometimes referred to |
| | | | herein as a right width), and |
| | | | D₉₀ − D₁₀ (sometimes |
| | | | referred to herein as a full |
| | | | width). |
| Active | Cumulative | Computed via LPSA | A cumulative volume |
| Material | Volume | data | fraction, defined as a |
| Particle | Fraction | | cumulative volume of the |
| Population | | | composite particles with |
| | | | particle sizes of a threshold |
| | | | particle size or less, divided |
| | | | by a total volume of all of the |
| | | | composite particles, may be |
| | | | estimated by LPSA. |
| Active | Composition | Balance | The mass of active materials |
| Material | (e.g., wt. %) | | added to the electrode |
| Particle | | | divided by the total mass of |
| Population | | | the electrode. |
| Active | BET-SSA | BET Isotherm | obtained from the data of |
| Material | (e.g., m²/g) | | nitrogen sorption-desorption |
| Particle | | | at cryogenic temperatures, |
| Population | | | such as about 77 K |
| Electrolyte | Salt | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar mass of the salt is then |
| | | | used to calculate the total |
| | | | number of moles of salt in |
| | | | the solution. The moles of |
| | | | salt is then divided by the |
| | | | total volume to obtain the |
| | | | solvent concentration in M |
| | | | (mol/L). |
| Electrolyte | Solvent | balance, volumetric | Total volume of the solution |
| | Concentration | pipette | is computed either via the |
| | (e.g., M or | | sum of the volume of the |
| | mol. %) | | constituents (measured by a |
| | | | volumetric pipette), or by |
| | | | the mass of the constituents |
| | | | divided by the density. The |
| | | | molar volume of each solvent |
| | | | is then used to calculate the |
| | | | total number of moles of |
| | | | solvent in the solution. The |
| | | | moles of solvent is then |
| | | | divided by the total volume |
| | | | to obtain the solvent |
| | | | concentration in M (mol/L). |
| Electrode | Composition | Balance | The mass fraction of a |
| | (e.g., mass | | material (e.g., active |
| | fraction or | | material, active material |
| | wt. %) | | particle, binder, etc.) in the |
| | | | electrode is calculated based |
| | | | on a measured or estimated |
| | | | mass of the material and a |
| | | | measured or estimated mass |
| | | | of the electrode, excluding |
| | | | the electrode current |
| | | | collector. |
| | | | Note: The mass of individual |
| | | | components (e.g., composite |
| | | | active material particles, |
| | | | graphite particles, binder, |
| | | | function additive(s), etc.) of |
| | | | the battery electrode |
| | | | composition may be |
| | | | measured before being |
| | | | mixed into a slurry to |
| | | | estimate their mass in a |
| | | | casted electrode. The mass of |
| | | | materials deposited onto |
| | | | and/or into the casted |
| | | | electrode may be measured |
| | | | by comparing the weight of |
| | | | the casted electrode |
| | | | before/after the material |
| | | | deposition. |
| Electrode | Areal Binder | balance | A mass fraction of the |
| | Loading (e.g., | | binder in the battery |
| | mg/m²) | | electrode, divided by a |
| | | | product of (1) a mass |
| | | | fraction of the active |
| | | | material (e.g., Si—C |
| | | | (nano)composite, etc.) |
| | | | particles in the battery |
| | | | electrode, and (2) a |
| | | | Brunauer-Emmett-Teller |
| | | | (BET) specific surface area |
| | | | of the active material |
| | | | particle population. |
| Electrode | Capacity | Calculated | Measure the mass (wt.) of |
| | Attributable | | active material in the |
| | to Active | | electrode, and calculate |
| | Material | | electrode capacity based on |
| | (active | | the known theoretical |
| | material | | capacity of the active |
| | capacity | | material. For example, the |
| | fraction) | | average wt. % of active |
| | | | material in each active |
| | | | material particle may be |
| | | | measured and used to |
| | | | calculate the mass of the |
| | | | active material based on the |
| | | | mass of the active material |
| | | | particles before being mixed |
| | | | in the slurry. This process |
| | | | may be repeated if the |
| | | | electrode includes two or |
| | | | more active materials to |
| | | | calculate the relative |
| | | | capacity attribution for each |
| | | | active material in the |
| | | | electrode. |
| Electrode | Capacity | Potentiostat and | Determine the average |
| | Attributable | balance | specific capacity (mAh/g) of |
| | to Active | | active material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may |
| | | | be repeated if the electrode |
| | | | includes two or more active |
| | | | material particle types to |
| | | | calculate the relative |
| | | | capacity attribution for each |
| | | | active material particle type |
| | | | in the electrode. |
| Electrode | Mass of | balance | The average wt. % of active |
| | Active | | material in each active |
| | Material in | | material particle may be |
| | Electrode | | measured, and used to |
| | | | calculate the mass of the |
| | | | active material based on the |
| | | | mass of the active material |
| | | | particles before being mixed |
| | | | in slurry. |
| Electrode | Mass of | balance | Measure the active material |
| | Active | | particle before the active |
| | Material | | material particle type is |
| | Particle in | | mixed in the slurry. |
| | Electrode | | |
| Electrode | Areal | Potentiostat and | Areal capacity loading is the |
| | Capacity | balance | weight of the coated active |
| | Loading (e.g., | | material per unit area |
| | mAh/cm²) | | (g/cm²) multiplied by the |
| | | | gravimetric capacity of the |
| | | | active material (not the |
| | | | electrode, but the active |
| | | | material itself with zero |
| | | | binder and zero electrolyte; |
| | | | mAh/g). |
| Electrode | Coulombic | Potentiostat | The change in charge |
| | Efficiency | | inserted (or extracted) to an |
| | | | electrode divided by the |
| | | | charge extracted (or |
| | | | inserted) from the electrode |
| | | | during a complete |
| | | | electrochemical cycle within |
| | | | given voltage limits. Because |
| | | | the direction of charge flow |
| | | | is opposite for cathodes and |
| | | | anodes, the definition is |
| | | | dependent on the electrode. |
| | | | Coulombic Efficiency is |
| | | | measured for both materials |
| | | | by constructing a so-called |
| | | | half-cell, which is an |
| | | | electrochemical cell |
| | | | consisting of a cathode or |
| | | | anode material of interest as |
| | | | the working electrode and a |
| | | | lithium metal foil which |
| | | | functions as both the counter |
| | | | and reference electrode. |
| | | | Then, charge is either |
| | | | inserted or removed from |
| | | | the material of interest until |
| | | | the cell voltage reaches an |
| | | | appropriate limit. Then, the |
| | | | process is reversed until a |
| | | | second voltage limit is |
| | | | reached, and the charge |
| | | | passed in both steps is used |
| | | | to calculate the Coulombic |
| | | | Efficiency, as described |
| | | | above. |
| Battery Cell | Rate | Potentiostat | This is the time it takes to |
| | Performance | | charge or discharge a |
| | | | battery between a given state |
| | | | of charge. It is measured by |
| | | | charging or discharging a |
| | | | battery and measuring the |
| | | | time until a specified amount |
| | | | of charge is passed, or until |
| | | | the battery operating voltage |
| | | | reaches a specified value. |
| Battery Cell | Cell | Potentiostat | A battery consisting of a |
| | Discharge | | relevant anode and cathode |
| | Voltage (e.g., | | is charged and discharged |
| | V) | | within certain voltage limits |
| | | | and the charge-weighted cell |
| | | | voltage during discharge is |
| | | | computed. |
| Battery Cell | Operating | Potentiostat and | Average temperature of |
| | Temperature | thermocouples | battery cell as measured at |
| | | | the positive/negative |
| | | | terminal/cell shaft/etc. |
| | | | while charging/discharging, |
| | | | or at a certain voltage level, |
| | | | or while a load is applied, |
| | | | etc. |
| Battery | Anode | Potentiostat | An electrode containing an |
| Half-Cell | Discharge | | active anode material (or a |
| | (de- | | mixture of active materials) |
| | lithiation) | | of interest is charged and |
| | Potential | | discharged (by passing |
| | (e.g., V) | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to de- |
| | | | lithiation of the anode) is |
| | | | computed. |
| Battery | Cathode | Potentiostat | An electrode containing an |
| Half-Cell | Discharge | | active cathode material (or a |
| | (lithiation) | | mixture of active materials) |
| | Potential | | of interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell |
| | | | potential upon discharge |
| | | | (corresponding to lithiation |
| | | | of the cathode) is computed. |
| Battery Cell | Volumetric | Potentiostat | The VED is calculated by |
| | Energy | | first calculating the energy |
| | Density | | per unit area of the battery, |
| | (VED) | | and then dividing the energy |
| | | | per unit area by the sum of |
| | | | the illustrative anode, |
| | | | cathode, separator, and |
| | | | current collector thicknesses |
| Battery Cell | Internal | Potentiostat | The internal resistance (also |
| | Resistance | | known as impedance in |
| | (impedance) | | many contexts) is measured |
| | | | by applying small pulses of |
| | | | current to the battery cell |
| | | | and recording the |
| | | | instantaneous change in cell |
| | | | voltage. |

In certain aspects, the disclosure relates to batteries. While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.) as well as electrochemical capacitors and hybrid energy storage devices.

While the description below may describe certain examples in the context of metal oxide (nano)wires or nanofibers or fibers, it will be appreciated that various aspects may be applicable to metal fluoride, metal oxy-fluoride, metal hydroxide, metal oxyhydroxide and other ceramic (nano)wires or nanofibers or fibers.

While the description below may describe certain examples of aluminum (Al)-based ceramic (nano)wires or nanofibers or fibers (e.g., Al₂O₃ or AlO(OH) or Al(OH)₃), it will be appreciated that metals other than Al or their various combinations (incl. various combinations with Al) may be used for the formation of such ceramic (nano)wires or nanofibers or fibers (e.g., silicon (Si), magnesium (Mg), niobium (Nb), lithium (Li), sodium (Na), potassium (K), calcium (Ca), zinc (Zn), etc.). In some designs, more than one metal may be utilized in the ceramic (nano)wires or nanofibers or fibers. The optimum ceramic composition may be affected by the desired mechanical, physical, chemical and electrochemical stability properties needed for a given application and a given battery electrode chemistry. For example, ceramic fibers are used in a separator for a LIB with a low-potential anode (e.g., Li metal anode or graphite anode or Si-based anode), it is important that there would be a low probability for these to get electrochemically reduced during LIB operation and so their composition and distribution within a membrane may be selected accordingly. In some designs, for example, a portion of the composite membrane (e.g., about 0.005-5.0 micron (μm)) in a direct contact with an anode may preferably not comprise any ceramic (nano)wires or nanofibers or fibers in order to prevent their electrochemical reduction.

As used herein, elongate (nano)particles (such as dense and porous (nano)fibers, (nano)wires, whiskers, (nano)tubes, (nano)ribbons, etc.) of suitable size (e.g., diameter [or, more generally, average transverse dimensions (e.g., widths) in directions perpendicular to the elongate direction (longitudinal direction)] from around 1.0 nm to around 950.0 nm; in some designs, from around 20 nm to around 200 nm, or from around 200 nm to around 400 nm, or from around 20 nm to around 400 nm), shape, aspect ratios, density, porosity, crystal structure, and morphology may be generally referred to herein as either “(nano)fibers” or “(nano)wires”. Herein, the terms “elongate (nano)particles,” “(nano)fibers,” and “(nano)wires” may be used interchangeably.

While the description below may describe certain examples in the context of solid or porous ceramic (nano)wires (or (nano)fibers), it will be appreciated that other shapes of solid or porous ceramic materials (e.g., dendritic particles and (nano)particles; branched fibers or nanofibers; flakes or (nano)flakes; etc.) and their various combinations may be utilized in some membrane designs.

While the description below may describe certain examples in the context of one type of ceramic (nano)wire (or (nano)fiber) composition, it will be appreciated that two, three or more distinctly different (nano)wire (or (nano)fiber) compositions may be advantageously used in some designs. It may be, in fact, advantageous to combine (nano)wires (or (nano)fibers) having different dimensions (e.g., use larger diameter and longer dimensions nanofibers or fibers for enhanced dimensional stability and mechanical properties in combination with smaller diameter and shorter (nano)fibers for templating smaller pores, etc.). In some designs, the (nano)wires or (nano)fibers having different dimensions or composition, may also exhibit different chemical formula or microstructure or aspect ratio or roughness or porosity or other chemical or physical properties or belong to entirely different class of materials (e.g., one being a ceramic and another being a polymer or a polymer composite).

While the description below may describe certain examples in the context of ceramic (nano)wire (or (nano)fiber) composition, it will be appreciated that in some designs the separator membrane or the separator layer (separator coating) may comprise polymer nanofibers (or fibers) (e.g., on their own or in combination with the elongate ceramic (nano)particles). In some designs, such polymer nanofibers or fibers may exhibit the ability to getter (remove) transition metal ions (e.g., Ni ions, Mn ions, Ni ions, Co ions, and/or Fe ions) dissolved in an electrolyte. In other designs, such polymer nanofibers or fibers may primarily serve other purposes (e.g., tune mechanical or thermal properties, provide a buffer from the electrode, provide a separation from the anode, etc.). In some designs, composite polymer-ceramic nanofibers or fibers may be used instead of or in addition to the polymer nanofibers or fibers.

Depending on the application, in an example, the suitable true density (taking into consideration closed porosity) of ceramic (nano)fibers (or (nano)wires) may range from around 0.3 to around 4 g/cm³ (e.g., for ceramic particles comprising only Al metal in their composition) and to around 6 g/cm³ (e.g., for particles comprising metals other than Al in their composition) in the context of one or more embodiments of the present description. Depending on the application and the processing conditions, in an example, the suitable pore volume (e.g., open pore volume) within individual fibers or nanofibers may range from around 0 to around 5 cm³/g (e.g., in some designs, from around 0.01 cm³/g to around 3 cm³/g; in some designs, from around 0.05 cm³/g to around 1 cm³/g). Depending on the application and the processing conditions, in an example, the microstructure may range from amorphous to (nano)crystalline to polycrystalline to single crystalline to a mixture of those to other types. Depending on the application and processing conditions, in an example, the suitable surface roughness of the (nano)fibers may range from around 0 nm to around 100 nm.

Depending on the application, in an example, the suitable Brunauer-Emmett-Teller (BET) specific surface area (SSA) of the (nano)wires (or (nano)fibers) may range from around 2.0 m²/g to around 4000.0 m²/g. In some designs, the optimal range may depend on the specific membrane composition, properties of (nano)wires/(nano)fibers (such as composition, morphology, crystal structure, porosity, etc.), desired mechanical properties of the membrane required for battery cell assembling or safe cell operation, among other factors. In some designs, the optimal BET-SSA may range, for example, from around 2.0 m²/g to around 50.0 m²/g; from around 50.0 m²/g to around 100.0 m²/g; from around 100.0 m²/g to around 250.0 m²/g; from around 250.0 m²/g to around 500.0 m²/g; from around 500.0 m²/g to around 1000.0 m²/g; from around 1000.0 m²/g to around 4000.0 m²/g; from around 2.0 m²/g to around 30.0 m²/g; from around 30.0 m²/g to around 50.0 m²/g; from around 250.0 m²/g to around 400.0 m²/g; from around 400.0 m²/g to around 500.0 m²/g; or from around 3.0 m²/g to around 400.0 m²/g.

In one or more embodiments of the present disclosure, the suitable diameter (or width) of individual (nano)wires/(nano)fibers (of various compositions) may range from around 1.0 nm to around 950.0 nm (e.g., in a range of about 5.0 nm to about 500.0 nm; in a range of about 5.0 nm to about 950.0 nm; in a range of about 1.0 nm to about 500.0 nm; in a range of about 1.0 nm to 20.0 nm; in a range of about 20.0 nm to 50.0 nm; in a range of 50.0 nm to 200.0 nm; in a range of 200.0 nm to 400.0 nm; in a range of 20.0 nm to 400.0 nm; in a range of 200.0 nm to 500.0 nm; or in a range of about 500.0 nm to about 950.0 nm).

In one or more embodiments of the present disclosure, the suitable length (e.g., average length) of elongate (nano)particles (of various compositions) may range from around 50.0 nm to around 5.0 mm (in some designs, an average length may range from around 250.0 nm to around 500.0 μm; in other designs an average length may range from around 50.0 nm to around 0.5 μm; in other designs an average length may range from around 0.5 μm to around 2.5 μm; in other designs an average length may range from around 2.5 μm to around 25.0 μm; in other designs an average length may range from around 25.0 μm to around 100.0 μm; in other designs an average length may range from around 100.0 μm to around 5.0 mm; in other designs an average length may range from around 2.0 μm to around 25.0 μm; in other designs an average length may range from around 25.0 μm to around 50.0 μm; in other designs an average length may range from around 2.0 μm to around 50.0 mm).

In one or more embodiments of the present disclosure, the suitable aspect ratio (width-to-length) of individual elongate (nano)particles (of various compositions) may preferably range from around 1:3 to around 1:1,000,000 (in some designs, from around 1:3 to around 1:10; in some designs, from around 1:10 to around 1:30; in some designs, from around 1:30 to around 1:100; in some designs, from around 1:3 to around 1:30; in some designs, from around 1:10 to around 1:100,000; in some designs, from around 1:10 to around 1:100; in other designs from around 1:100 to around 1:1,000; in other designs from around 1:100 to around 10,000; in other designs from around 1:1,000 to around 10,000; in other designs from around 1:10,000 to around 1:100,000, in other designs from around 100,000 to around 1,000,000). Too high aspect ratio may make it difficult for the (nano)fibers to be properly dispersed in a slurry formulation, while too low aspect ratio may make them less effective. In some designs, an aspect ratio in the range from around 1:3 to around 1:100 (in some designs, from around 1:3 to around 1:30) may be advantageously used. Herein, an aspect ratio of 1:x (e.g., 1:3) is also sometimes written as x (e.g., 3).

In some designs and applications, the individual (nano)fibers may be agglomerated into bundles or into flexible threads or into flexible yarns and may be parts of the final membrane composition.

In one or more embodiments of the present disclosure, the elongate (nano)particles comprise ceramic material, and hence may be referred to as elongate ceramic (nano)particles. In some implementations, the ceramic material may comprise aluminum (Al) and/or magnesium (Mg) and may comprise an oxide, an oxyhydroxide, and/or a hydroxide. In some implementations, the ceramic material may additionally comprise lithium (Li) (in some designs, the fraction of Li may range from about 10 ppm to about 1 at. % relative to the total ceramic material composition; in some cases, the ceramic material may be referred to as being lithium-doped). In implementations in which the ceramic comprises Al, the ceramic may comprise aluminum oxide (e.g., alumina (Al₂O₃) such as γ-alumina and α-alumina), aluminum oxyhydroxide (e.g., boehmite (AlO(OH)) or another polymorph crystalline or amorphous microstructure), and/or aluminum hydroxide (e.g., Al(OH)₃—having, for example, bayerite, gibbsite, nordstrandite, pseudoboehmite, or another polymorph microstructure). In some implementations, the ceramic material may comprise aluminum phosphate.

In the context of one or more embodiments of the present description, the term “dispersion” refers to a mixture of solid(s) and liquid(s) whereas the solid(s) interact(s) with the liquid(s) in a way which changes the fluid properties of both the solid(s) and liquid(s). For example, solid (nano)particles of various shapes and sizes may be dispersed in a liquid causing the viscosity of the liquid to increase and the Brownian motion of the particles to increase. The term “dispersion” may further refer to the condition where solid (nano)particles of various shapes and sizes are being suspended in a liquid (solvent). In the context of one or more embodiments of the present description, the term “stable dispersion” refers to the conditions where particles (such as fibers, flakes, (nano)particles or particles of various other shapes and sizes) remain suspended for a timescale that is sufficient for a given processing stage (e.g., such as casting the dispersion into a film on a substrate, etc.).

While the description below may also describe certain examples of the material formulations in a Li-free state (for example, as in silicon-comprising (nano)composite anodes or metal fluoride cathodes or sulfur cathodes, etc.), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, Zr, Ti, Mg, Nb, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated intercalation-type cathode materials, partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Unless stated or implied otherwise, reference to such Li-dependent anode material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

While the description below may describe certain examples in the context of some specific alloying-type, conversion-type and intercalation-type chemistries for anode active materials and conversion-type and intercalation-type chemistries for cathode active materials for Li-ion batteries (such as silicon-comprising anodes or metal fluoride-comprising or lithium sulfide-comprising cathodes), it will be appreciated that various aspects may be applicable to other chemistries for Li-ion batteries (such as comprising other conversion-type and alloying-type anode and cathode active materials in the electrodes, various intercalation-type anodes and cathodes and various combinations of intercalation-type, conversion-type and/or alloying-type active materials in the electrodes) as well as to other battery chemistries. In the case of metal-ion batteries (such as Li-ion batteries), examples of other suitable conversion-type electrodes include metal fluorides, metal oxyfluorides, metal chlorides, metal iodides, metal bromides, sulfur, metal sulfides (including lithium sulfide), selenium, metal selenide (including lithium sulfide), metal oxides, metal nitrides, metal phosphides, metal hydrides, their various mixtures, composites (including (nano)composites) and alloys and others.

During battery (such as a Li-ion battery) operation, conversion materials change (convert) from one crystal structure to another (hence the name “conversion”-type), where a material structure and composition may chemically and structurally change to one or multiple structures. This process is also accompanied by breaking chemical bonds and forming new ones. During battery (e.g., Li-ion battery) operation, Li ions are inserted into alloying-type materials forming lithium alloys (hence the name “alloying”-type). Sometimes, “alloying”-type electrode materials are considered to be a subclass of “conversion”-type electrode materials.

While the description below may describe certain examples in the context of Si—C composite (e.g., (nano)composite) anode active materials (e.g., (nano)composite particles which comprise silicon (Si) and carbon (C) and may comprise other elements, such as nitrogen (N), phosphorus (P), boron (B), oxygen (O), hydrogen (H), sulfur (S), fluorine (F), to name a few and where a total mass of the Si and the C atoms may contribute from about 75 wt. % to about 100 wt. % of the total mass of the composite particles), it will be appreciated that various aspects may be applicable to other types of the high-capacity silicon-comprising anode active materials (including, for example, various silicon-comprising or silicon oxide-comprising or silicon nitride-comprising or silicon oxy-nitride-comprising or silicon phosphide-comprising particles or particles comprising a mixture or alloy or other combinations of such active materials, various other types of Si-comprising composites including core-shell or hierarchical or (nano)composite particles, etc.).

An aspect is directed to a battery anode composition comprising a population of Si-comprising particles (e.g., (nano)composite particles, among others), in which some or all of the Si-comprising particles comprise silicon (Si) and carbon (C) elements and may comprise other elements, such as nitrogen (N), phosphorus (P), boron (B), oxygen (O), hydrogen (H), sulfur (S), fluorine (F), to name a few. In some embodiments, the total mass of the Si and the C (on average) in the Si-comprising particles may contribute from about 75 wt. % to about 100 wt. % of the total mass of the Si-comprising particles. Such composite particles are sometimes referred to herein as Si—C composites (or (nano)composites, if Si and/or C are (nano)structures, for example).

In some embodiments, a total atomic fraction of the Si and the C may contribute from about 75 at. % to about 100 at. % of the overall composite particles. Such composite particles are sometimes referred to herein as Si—C composites. In some embodiments, such composite particles comprise nano-sized or (nano)structured elements (e.g., nano-sized or (nano)structured Si, nano-sized or (nano)structured C, or both), which may be referred to as (nano)composite particles. In some implementations, the Si or Si-comprising active material present in such (nano)composites may be in the form of (nano)particles. In some implementations, the mass-average size of Si or Si-comprising active material (nano)particles (or nanocrystals) may range from about 1 nm to about 200 nm (in some designs, from about 1.0 nm to about 10.0 nm; in other designs, from about 10.0 nm to about 30.0 nm; in yet other designs, from about 30.0 nm to about 100.0 nm; in yet other designs, from about 100.0 nm to about 200.0 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques. X-ray diffraction (XRD) may be particularly convenient and easy for identifying the average size of Si (nano)crystals. In some implementations, amorphous Si nanoparticles may be annealed at elevated temperatures (e.g., from about 450 to about 700 C) for a short time (e.g., from about 1 min to about 10 h, depending on the temperature) in order to crystalize and thus become visible by XRD for the measurements. Too small (e.g., smaller than about 1.0 nm in some designs or, e.g., about 2.0 nm in other designs) Si (nano)crystals (or Si nanoparticle sizes) may exhibit too high reactivity during synthesis and become less active or induce too high fist cycle capacity losses, while too large (e.g., larger than about 200 nm in some designs or, e.g., about 100 nm in other designs) Si crystals (or Si nanoparticle sizes) may reduce cycle stability of such Si—C composites ((nano)composites) or, broadly, (nano)composite silicon. As used here, a “nano”-material (e.g., (nano)structure or (nano)particle or (nano)composite, etc.) may refer to any material that exhibits at least one dimension that is less than about 200 nm. Also, as used herein, a “(nano)”particle (e.g., (nano)particle, (nano)fiber, etc.) refers to a material that may be implemented a nanomaterial (or larger). In some embodiments, Si—C nanocomposites may be produced by the vapor-phase infiltration of Si nanoparticles inside the porous C scaffold material (e.g., by chemical vapor deposition, CVD, of a suitable Si precursor, such as SiH₄, in some examples). In some embodiments, a carbon (C) coating on the surface of Si—C composite particles (including Si nanoparticles within such composites) may be introduced to reduce specific surface area of such particles, to protect Si from undesirable oxidation in water or air or side-reactions or for other purposes. In some embodiments, Si—C nanocomposites may comprise a lithium-comprising ceramic coating (e.g., lithium fluoride (LiF)-comprising coating or lithium-aluminum-fluoride-comprising coating or lithium-aluminum-oxide-comprising coating or lithium-aluminum-oxyfluoride-comprising coating).

An aspect is directed to a battery anode composition comprising a population of Si-comprising particles (e.g., (nano)composite particles, among others), in which each of the particles comprises Si and C, and the Si-comprising (e.g., composite) particles exhibit, on average, specific reversible capacity (as measured in half cells using a proper charge-discharge protocol such as, for example, by lithiation of the anode at the constant current density of about 0.1 C to about 0.01 V vs. Li/Li⁺ followed by taper till the current density decreases to about 0.01 C and then followed by delithiation at the constant current density of about 0.1 C to about 1.5 V vs. Li/Li⁺; note that the capacity of the Si-comprising (e.g., composite) particles may be estimated from the anodes comprising known wt. % blends with known graphite that have known specific capacity of its own) in the range of about 1400 mAh/g to about 2800 mAh/g (in some designs, from about 1400 mAh/g to about 1600 mAh/g; in other designs, from about 1600 mAh/g to about 1800 mAh/g; in other designs, from about 1800 mAh/g to about 2000 mAh/g; in other designs, from about 2000 mAh/g to about 2200 mAh/g; in other designs, from about 2200 mAh/g to about 2400 mAh/g; in other designs, from about 2400 mAh/g to about 2600 mAh/g; in other designs, from about 2600 mAh/g to about 2800 mAh/g). Similarly, the irreversible (first cycle) specific capacity of the particles that comprise Si and C may preferably range from about 1500 mAh/g to about 2900 mAh/g (in some designs, from about 1500 mAh/g to about 1700 mAh/g; in other designs, from about 1700 mAh/g to about 1900 mAh/g; in other designs, from about 1900 mAh/g to about 2100 mAh/g; in other designs, from about 2100 mAh/g to about 2300 mAh/g; in other designs, from about 2300 mAh/g to about 2500 mAh/g; in other designs, from about 2500 mAh/g to about 2700 mAh/g; in other designs, from about 2700 mAh/g to about 2900 mAh/g). An aspect is also directed to a Li-ion battery comprising: (i) a suitable battery anode, wherein the suitable anode may comprise one or more of the following, in some designs: (ia) Si-comprising anode comprising Si-comprising anode particles (e.g., (nano)composite Si—C particles, silicon oxide particles, silicon nitride particles, among others), which, in some design may also be a blended battery anode (wherein both the Si-comprising active anode particles (e.g., (nano)composite Si—C particles or silicon oxide particles or silicon nitride particles, among others) and suitable graphite (or, broadly, carbon-based) active anode particles are present in the anode), (ib) intercalation-type carbon (C)—comprising anode comprising natural graphite, synthetic graphite, hard carbon or soft carbon or their various combinations or (ic) metal oxide-comprising anode (e.g., Li, Ti, Nb, Mo, V and/or W-comprising metal oxides, such as, for example, lithium titanium oxide, niobium titanium oxide, niobium molybdenum oxide, niobium molybdenum titanium oxide, niobium tungsten oxide, niobium tungsten molybdenum oxide, niobium tungsten molybdenum titanium oxide, vanadium oxide, their various combinations and mixtures, etc.) or (id) their various combinations and (ii) a suitable battery cathode, wherein the suitable cathode may comprise one or more of the following, in some designs: (iia) intercalation-type cathode active material(s) or (iib) conversion-type cathode (which may include a displacement-type cathode, a chemical transformation type cathode or a true conversion-type cathode) active materials or (iic) a mixed intercalation/conversion type cathode (either a physical mixture of (iia) and (iib) or a cathode that exhibits both intercalation-type or conversion-type Li-ion storage).

In some designs, a suitable cathode may advantageously comprise one, two, or more of the following additives (e.g., in the form of particles, (nano)particles, (nano)fibers, flakes or (nano)flakes): natural graphite, synthetic graphite, graphene, graphene oxide, exfoliated graphite, hard carbon, soft carbon, carbon black, carbon fibers, carbon (nano)fibers, carbon (nano)tubes in the total amount from around 0.01 wt. % to about 15 wt. % relative to the total weight of the cathode layer but not counting the weight of the cathode current collector (in some designs, from about 0.01 wt. % to about 0.5 wt. %; in other designs, from about 0.5 wt. % to about 2.0 wt. %; in other designs, from about 2.0 wt. % to about 5.0 wt. %; in yet other designs, from about 5.0 wt. % to about 15.0 wt. %).

Illustrative examples of suitable intercalation-type cathodes to be used in preferable cells may include: lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM), lithium cobalt oxide (LCO), lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium excess (rocksalt) transition metal oxides and oxy-fluorides such as those comprising Mn, Mo, Cr, Ti, and/or Nb, such as, for example, Li_{1.211}Mo_{0.467}Cr_{0.3}O₂, Li_{1.3}Mn_{0.4}Nb_{0.3}O₂, Li_{1.2}Mn_{0.4}Ti_{0.4}O₂, Li_{1.2}Ni_{0.333}Ti_{0.333}Mo_{0.133}O₂), various high capacity Li-ion based materials with partial substitution of oxygen for fluorine or iodine (e.g., disordered or ordered rocksalt compositions comprising Mn, Mo, Cr, Ti and/or Nb, such as, for example, Li₂Mn_{2/3}Nb_{1/3}O₂F, Li₂Mn_{1/2}Ti_{1/2}O₂F, Li_{1.5}Na_{0.5}MnO_{2.85}I_{0.12}) and many other types of Li-comprising disordered, layered, tavorite, olivine, or spinel type active materials or their mixtures comprising at least oxygen or fluorine or sulfur and at least one transition metal and other lithium transition metal(TM) oxides or phosphates or sulfates (or mixed) cathode active materials that rely on the intercalation of lithium (Li) and changes in the TM oxidation state. In some implementations, the cathode active material comprises at least one transition metal, selected from nickel (Ni), manganese (Mn), cobalt (Co), and iron (Fe).

Illustrative examples of suitable conversion-type cathodes to be used in preferable cells may include: metal fluorides, metal oxy-fluorides, metal chlorides, metal sulfides, metal selenides, their various mixtures, composites and others. Illustrative examples of metal fluorides, in a Li-free state, include FeF₃, FeF₂, MnF₃, CuF₂, NiF₂, BiF₃, BiF₅, SnF₂, SnF₄, SbF₃, SbF₅, CdF₂, ZnF₂, TiF₃, TiF₄, AgF, AgF₂, NbF₅, NbF₄, MoF₅, MoF₄, MoF₃, ZrF₄, BaF₂, SrF₂, YF₃, LaF₃, PbF₂, PbF₄, CeF₃, CeF₄, SmF₃, CaF₂, their various mixtures, alloys and combinations. In some designs, Fe may contribute to the majority (e.g., about 50-100 at. %; in some designs, about 75-100 at. %) of the transition metals in the metal fluoride cathodes. In some designs, Cu may contribute to the majority (e.g., about 50-100 at. %; in some designs, about 75-100 at. %) of the transition metals in the metal fluoride cathodes.

In some of the preferred examples, a surface of cathode active materials (e.g., intercalation-type cathode materials, such as LCO, NCM, NCMA, NCA, LMO, LMNO, LFP, LMP, LMFP, etc. or conversion-type active materials comprising S, Li₂S, metal sulfides, metal fluorides, etc.) may be coated with a layer of ceramic (e.g., oxide) material (e.g., comprising one, two or more of Li, Mg, Al, Ti, Zr, W and/or Nb, among other metals). In some of the preferred examples, a surface of cathode active materials may be coated with a layer of a polymeric material. In some designs, a preferred cathode current collector material is aluminum or aluminum alloy or an aluminum-comprising composite. In some designs, a preferred anode current collector material is copper or copper alloy or a copper-comprising composite. In some designs, a preferred battery cell includes a polymer or polymer-comprising separator membrane or a polymer-comprising separator layer.

An aspect is directed to a Li-ion battery with a Si-comprising anode or with a blended anode (e.g., comprising Si-comprising active material (e.g., Si—C composite particles) and graphite active material particles, etc.) that exhibits a relatively high areal capacity loading and properly matched (by areal capacity) cathode (with slightly smaller areal capacity loadings, selected according to the desired negative (N) to positive (P) ratio, N/P (the N/P ratio corresponds to the ratio of the reversible areal capacities of the anode to cathode) in a range of around 0.95 to around 1.35 (e.g., from around 0.95 to around 1.01; from around 1.01 to around 1.05; from around 1.05 to around 1.10; from around 1.10 to around 1.15; from around 1.15 to around 1.20; from around 1.20 to around 1.25; or from around 1.25 to around 1.35). Note that both the performance characteristics and cycle stability of Li-ion battery cells may become particularly unsatisfactory for applications requiring long calendar life or long cycle life or low first cycle losses, or other properties if the electrode areal capacity loading exceeds around 1-2 mAh/cm², even more, if the electrode areal capacity exceeds around 4-5 mAh/cm², yet even more if the electrode areal capacity exceeds around 6 mAh/cm² and yet even more if the electrode areal capacity exceeds around 8 mAh/cm². Higher loading, however, is advantageous for reducing the cost of energy storage devices and increasing their energy density. One or more embodiments of the present disclosure are directed to fabrication processes, compositions and various physical and chemical properties of anodes and cathodes that enable satisfactory performance for electrode areal loadings in the range from around 2 mAh/cm² to around 16 mAh/cm² (e.g., from around 2 to around 4 mAh/cm², from around 4 to around 8 mAh/cm², or from around 8 to around 16 mAh/cm²).

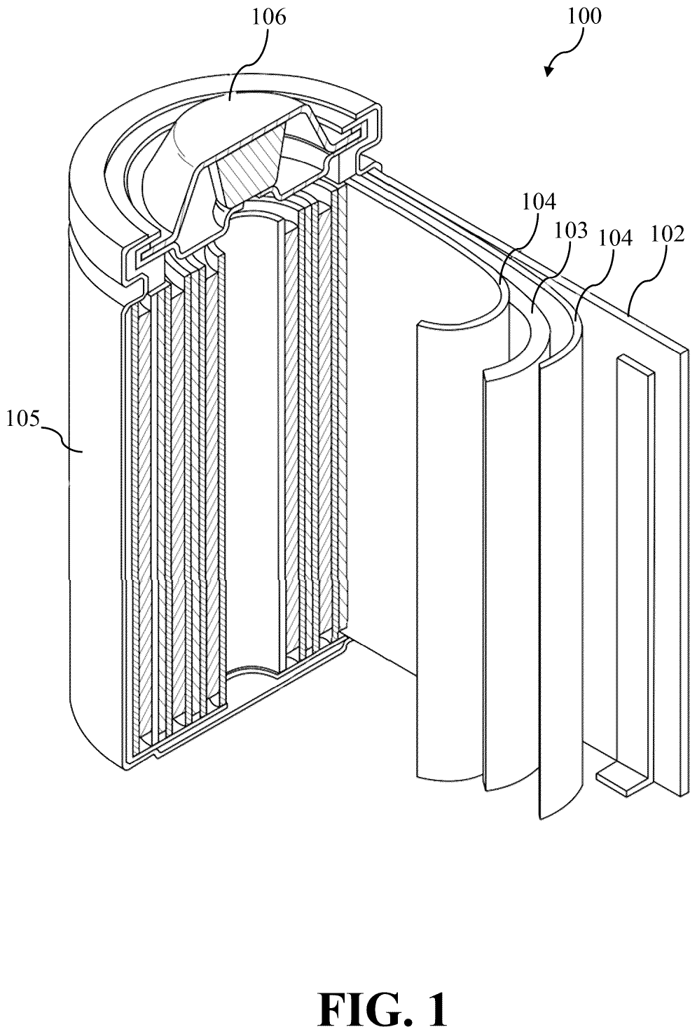

FIG. 1 illustrates an example metal-ion (e.g., Li-ion) battery in which the elongate ceramic (nano)particles, separators, electrodes, integrated electrode-separator components, other components, materials, processes, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on and/or in the anode current collector and the cathode is disposed on and/or in the cathode current collector. Note that a battery anode disposed “on and/or in” a current collector may refer to a battery anode that is deposited on top of the current collector, or a battery anode that is at least partially disposed inside one or more pores of a porous current collector, in some designs (in addition to and/or in place of an anode part that is deposited on top of the current collector).

Conventional electrolytes for Li- or Na-based batteries of this type are generally composed of an about 0.8-1.2 M (about 1 M±about 0.2 M) solution of a single Li or Na salt (such as LiPF₆ for Li-ion batteries and NaPF₆ or NaClO₄ salts for Na-ion batteries) in a mixture of carbonate solvents with about 1-2 wt. % of other organic additives. Common organic additives may include nitriles, esters, sulfones, sulfoxides, phosphorous-based solvents, silicon-based solvents, ethers, ketones, boron-based compounds, and others. Such additive solvents may be modified (e.g., sulfonated or fluorinated). Higher (e.g., about 1.2-4.0 M) or lower (e.g., about 0.1-0.8 M) salt concentration may be used in some electrolyte designs in the context of the present disclosure. Furthermore, two, three or more different salts may be used in some electrolyte designs in the context of the present disclosure. In some designs, the main electrolyte solvents may not be carbonates, but be esters, ethers, sulfones, ketones or others. In some designs, electrolytes may also comprise ionic liquids (ILs).

The conventional salt used in most conventional Li-ion battery electrolytes is LiPF₆. Examples of less common salts (e.g., explored primarily in research publications or, in some cases, never even described in Li-ion battery electrolyte applications, but may still be applicable and useful) include: lithium tetrafluoroborate (LiBF₄), lithium perchlorate (LiClO₄), lithium hexafluoroantimonate (LiSbF₆), lithium hexafluorosilicate (Li₂SiF₆), lithium hexafluoroaluminate (Li₃AlF₆), lithium bis(oxalato)borate (LiB(C₂O₄)₂), lithium difluoro(oxalate)borate (LiBF₂(C₂O₄)), various lithium imides (such as SO₂FN⁻(Li⁺)SO₂F, CF₃SO₂N⁻(Li⁺)SO₂CF₃, CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃, and others), lithium difluorophosphate, and others.

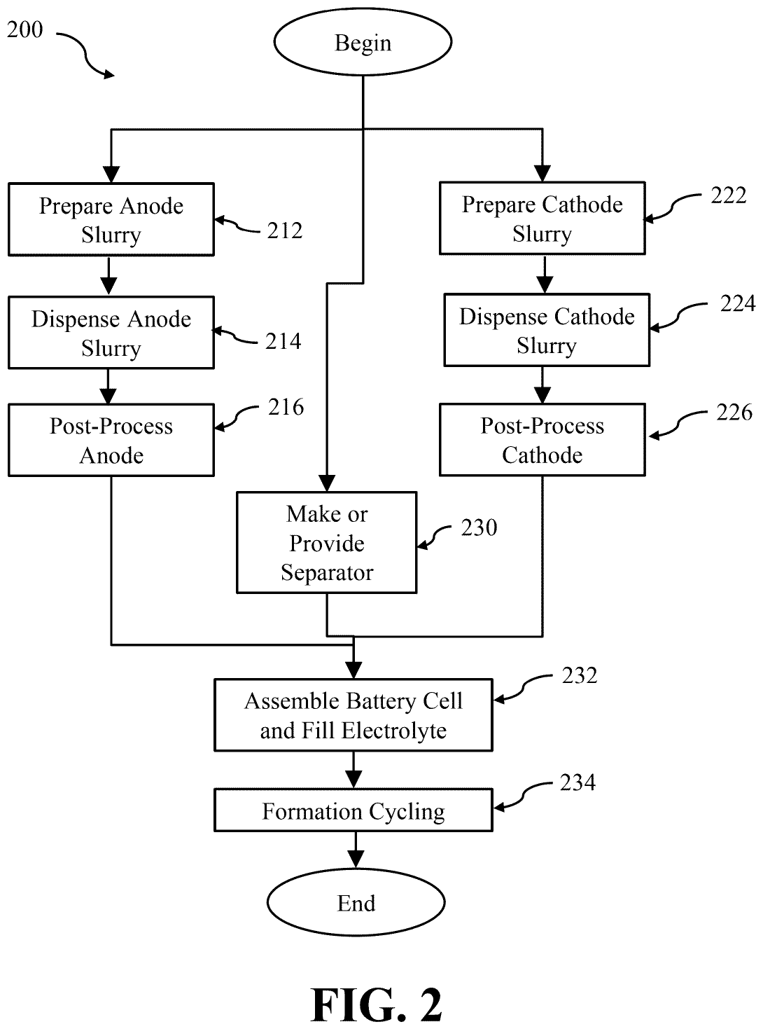

FIG. 2 illustrates an example process 200 of making a Li-ion battery. This example shows the formation of both electrodes (anode and cathode). The flow diagram includes a left branch, a right branch, and a middle branch. The left branch relates to the formation of an anode, and includes stages 212, 214, and 216. The right branch relates to the formation of a cathode, and includes stages 222, 224, and 226. The middle branch relates to making or providing a separator and includes stage 230. For each of the left and right branches, an electrode (an anode or a cathode) may be formed by casting from a slurry onto and/or into a current collector. At stage 230, a separator is made or otherwise provided. In the example shown, the left, the middle, and the right branches may be carried out concurrently or sequentially as desired. In addition, process 200 also includes stages 232 and 234, which are carried out after the left, the middle, and the right branches have been carried out. At stage 230, a separator is made or otherwise provided, as described herein. Stage 232 includes assembling of the battery cell from the battery components (e.g., anode, cathode, separator, battery case, sealing member) and filling the cell with an electrolyte. Stage 234 includes carrying out any formation cycling on the assembled battery, to form a solid-electrolyte interphase (SEI) layer in the anode and/or the cathode.

The battery electrode may comprise a current collector; and an electrode material disposed on and/or in the current collector (e.g., the electrode material may be deposited at least partially “in” the current collector if the current collector is (internally) porous and/or has a rough or porous surface). In still further aspects, the electrode material may be disposed as an electrode coating. In still further aspects, the electrode coating may have an average thickness in a range of about 5 μm to about 200 μm (e.g., from about 5 μm to about 10 μm, or from about 10 μm to about 20 μm, or from about 20 μm to about 40 μm, or from about 40 μm to about 60 μm, or from about 60 μm to about 80 μm, or from about 80 μm to about 100 μm, from about 100 μm to about 200 μm). The electrode material may comprise a battery electrode composition and a binder. In some embodiments, a coating density of the battery anode is in a range of about 0.8 to about 1.7 g/cm³ (in some designs, from about 0.8 to about 0.9 g/cm³; in other designs, from about 0.9 to about 1.0 g/cm³; in other designs, from about 1.0 to about 1.2 g/cm³; in other designs, from about 1.2 to about 1.4 g/cm³, in yet other designs, from about 1.4 to about 1.7 g/cm³). In some embodiments, a coating density of the battery cathode is in a range of about 1.2 to about 4.6 g/cm³ (in some designs, from about 1.2 to about 2.0 g/cm³; in other designs, from about 2.0 to about 2.8 g/cm³; in other designs, from about 2.8 to about 3.5 g/cm³; in other designs, from about 3.5 to about 4.0 g/cm³, in yet other designs, from about 4.0 to about 4.6 g/cm³).

In still further aspects, the battery electrode composition may comprise active materials suitable for a specific battery. The battery electrode composition may comprise, for example, (e.g., particles comprising) graphite or graphitic active materials (e.g., synthetic graphite, natural graphite, hard carbon, and/or soft carbon, etc.), silicon oxide, silicon nitride or, more broadly, silicon-comprising active materials (including composites or (nano)composites, such as Si—C(nano)composites, among others), metal oxide (e.g., lithium titanate, niobium oxide, niobium titanium oxide, lithium niobium titanium oxide, vanadium oxide, lithium vanadium oxide, etc.) and other active anode materials, conductive additives, other functional additives, but may be substantially free of solvents (e.g., after the solvents of the slurry have evaporated to form an electrode coating). In certain aspects, the anode active materials may be provided as particles or as core-shell particles or composite anode particles. In still further aspects, the anode active materials may comprise Si-comprising composite particles whereby Si-comprising active material is deposited within pore(s) of a particle core.

The battery electrode (e.g., anode electrode) composition, as described herein, may comprise composite particles, wherein each of the composite particles may comprise carbon and silicon. It is understood that a ratio of carbon and silicon in the composite particles can be any ratio that provides the desired battery performance. In some embodiments, a mass fraction of the silicon in the Si-comprising composite particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 50 wt. % to about 60 wt. %; in yet other designs, from about 60 to about 70 wt. %; in yet other designs, from about 70 wt. % to about 80 wt. %; in yet other designs, from about 20 wt. % to about 80 wt. %; in yet other designs, from about 35 wt. % to about 60 wt. %).

In certain aspects, each or some of the composite particles may be present in a core-shell configuration. Yet in still further aspects, at least a portion of the composite particles is present in a core-shell configuration.

In still further aspects, the suitable electrode materials may advantageously comprise conductive fillers (conductive additives). It is understood that the terms conductive fillers and conductive additive compositions can be used interchangeably. In such exemplary and unlimiting aspects, the conductive additive compositions may comprise one, two, or more of the following: carbon, carbon black, modified carbon, modified carbon black, dendritic carbon, graphene (incl. single-layered graphene and/or multi-layered graphene with about 2 to about 40 layers, on average (e.g., in some designs, from about 2 to about 10 layers; in other designs, from about 10 to about 20; in other designs, from about 20 to about 30; in yet other designs, from about 30 to about 40 layers, on average), graphene oxide, graphite, exfoliated graphite, carbon (nano)tubes (e.g., single-walled carbon (nano)tubes (SWCNTs), multi-walled carbon (nano)tubes (MWCNTs)), carbon (nano)fibers, carbon fibers, carbon (nano)flakes, graphite ribbons, salts of carboxymethyl cellulose (CMC), salts of polyacrylic acid (PAA) or PAA-comprising co-polymers, or salts of alginic acid (note that CMC, PAA and alginates are not conductive, but may help to disperse conductive additives), or any combination thereof.

In some aspects, the anode electrode material comprises lower-capacity particles (e.g., separate from higher-capacity particles such as Si—C composite particles). In some aspects, the lower-capacity particles have a charge capacity of about 400 mAh/g or less, including exemplary values of about 380 mAh/g or less, about 372 mAh/g or less, or 350 mAh/g or less. In still further aspects, the lower-capacity particles can comprise graphite-based active material particles. In some aspects, such graphite-based active material may comprise natural, artificial or a mixture of natural and artificial graphites. In some aspects, at least some of the graphite-based active material particles exhibit a specific capacity in a range of about 320 mAh/g to about 372 mAh/g. Graphite-based active material that may be useful in various aspects include various soft-type synthetic graphite (or soft carbon, broadly), various hard-type synthetic graphite (or hard carbon, broadly), and various natural graphite (which may, for example, be pitch carbon coated, among others); including those which exhibit discharge capacity from about 320 to about 372 mAh/g (e.g., in some designs, from about 320 to about 350 mAh/g; or in other designs, from about 350 to about 362 mAh/g; or in other designs, from about 362 to about 372 mAh/g).

In some aspects, an anode for a battery cell may comprise a mixture of Si-comprising active material particles (e.g., (nano)composite Si—C particles, (nano)composite Si particles, among others) and graphite active material particles (or, more broadly, carbon active material particles) as the anode active material, a so-called blended anode. In addition to the anode active material particles (e.g., Si—C composite particles and/or graphite particles), an anode may comprise inactive material (in addition to and separate from any inactive material that may be an integral part of the anode active material particles themselves, such as a C part of a Si—C composite particle), such as binder(s) (e.g., polymer binder) and other functional additives (e.g., surfactants, electrically conductive additives, etc.). Note that blended anode active material particles refer to a mixture of distinct active material particles (e.g., Si—C composite particles and graphite particles), and, by way of example, a homogeneous mixture of Si—C composite particles by itself is not considered to be a “blend” (e.g., because the C part of the Si—C composite particles is an integral part of the Si—C composite particles). For example, blended anode active material particles instead refer to a blend of different active material particle types (e.g., Si—C composite particles and graphite particles) that are held together by a binder and would be independent particles without the presence of the binder.

In still further aspects, the composite particles and lower-capacity particles in a blended anode can be present in any ratio that provides for desired battery performance. In some aspects, a mass ratio of the composite particles to the lower-capacity particles is in a range of about 10:90 to about 99:1 (e.g., about 15:85, about 20:80; about 30:70, about 40:60, about 50:50, about 60:40, about 70:30, about 80:20, about 90:10, and about 95:5 (note that each of the foregoing example values may constitute an upper bound or a lower bound to a sub-range that is bounded to any of the other stated values, as explained in a preceding paragraph related to numerical ranges)).

Referring to FIG. 2, the method of forming the electrode first comprises preparing an electrode slurry (stages 212 and 222). At stage 212, the anode slurry may be formed by mixing the anode active material with a binder, a solvent, any conductive additives, and any other functional additives. At stage 222, the cathode slurry may be formed by mixing the cathode active material with a binder, a solvent, any conductive additives, and any other functional additives.

In still further aspects, an electrode slurry (anode slurry or cathode slurry) is dispensed onto and/or into a respective current collector at stages 214 and 224, respectively. The dispensing may be carried out using any suitable coating process, including slot die coating and blade coating. The dispensing may be carried out in a roll-to-roll process, with the current collector being in the form of a roll and being in an unrolled state during the dispensing.

In certain aspects, the current collector can comprise a metal foil, metal wire, metal mesh, or any combination thereof. In certain aspects, the current collector can comprise a metallized foil. Metallized foils may be employed in some applications for which the mass of the current collector is preferably reduced as much as possible, e.g., in applications for which the gravimetric energy density is preferably as high as possible. Metallized foils are formed by forming a thin layer of metal (e.g., Cu or Cu alloy, Al or Al alloy) on a substrate that is lighter than the metal (e.g., a plastic substrate such as poly(ethylene terephthalate) (PET), polyimide (PI), polyamid (PA) such as para-aramid, among others). In certain aspects, the current collector can comprise Cu or Cu-alloy foil for anodes and Al or Al-alloy foil for cathodes, in many instances.

In still further aspects, at stages 216 and 226, the dispensed electrode compositions (either an anode composition or a cathode composition, formed by dispensing the respective slurry) are dried to completely evaporate the solvent, to form an electrode coating. At stages 216 and 226, any other post-dispensing process steps may be carried out on the electrode coating. For example, the dispensed compositions may undergo a calendering process (compaction), which may be carried out after the drying (solvent evaporation) process. Stage 216 and 226 may additionally include depositing a porous layer comprising an adhesive (such as PVDF, PVA, among others). Such a porous adhesive layer deposition may be done using a slot die coating, microgravure coating, blade coating, spray-based coating, blast coating, electrostatic jet coating or other suitable coating technique. Stages 216 and 226 may additionally include other processes, such as cutting the electrode-current collector to suitable dimensions (e.g., cutting a roll of the electrode-current collector into individual pieces for assembly into a battery).

In still further aspects, stage 230 includes making or otherwise providing a separator. In some implementations, stage 230 may include providing a commercially available separator, such as a separator comprising a polymer (e.g., polyolefin) membrane. In some cases, a commercially available separator may comprise a polymer membrane and a coating of ceramic particles formed on either major surface or both major surfaces of the polymer membrane. Stages 230 may additionally include other processes, such as cutting the separator to suitable dimensions (e.g., cutting a roll of the separator into individual pieces for assembly into a battery). In some implementations, the separator may comprise elongate ceramic (nano)particles (e.g., within a surface coating on the separator or within a bulk of the separator). In some implementations, the separator may comprise the elongate ceramic (nano)particles and other particles (e.g., other ceramic particles, polymer particles). In some examples, the elongate ceramic (nano)particles and the other particles may be present in the separator as a mixture. In some implementations, the separator may be a stand-alone. In other implementations, the separator may be integrated into the anode or the cathode or both (e.g., as a porous, electronically insulative separator layer, which may comprise elongate ceramic (nano)particles; the separator layer, in combination with an electrolyte permeating it, may be ionically conductive). In some implementations, the separator may comprise remaining dispersant or other surface-modifying molecules on its inner and/or outer surface in order, for example, to improve wetting of electrolyte, control safety, reduce separator or battery fabrication complexity or to attain other desirable properties or benefits.

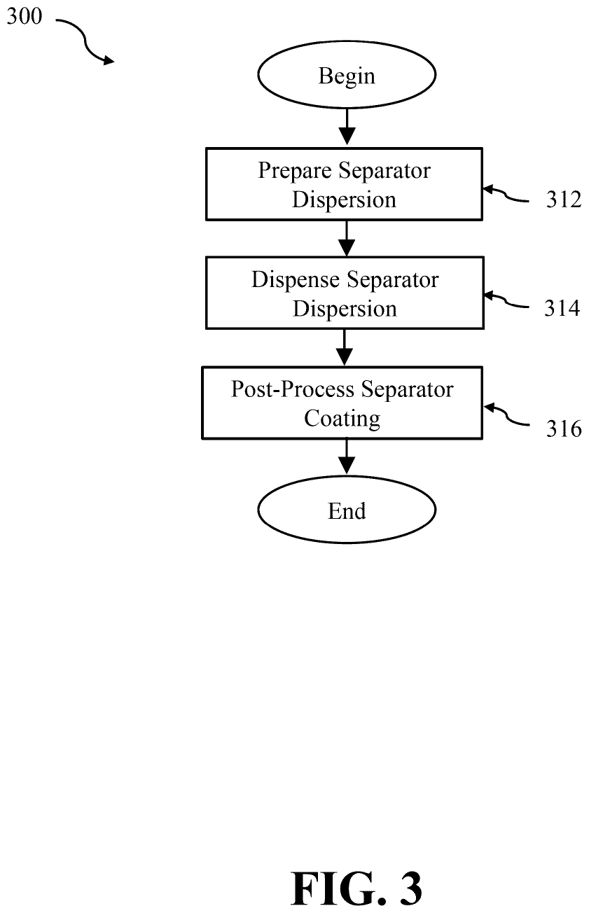

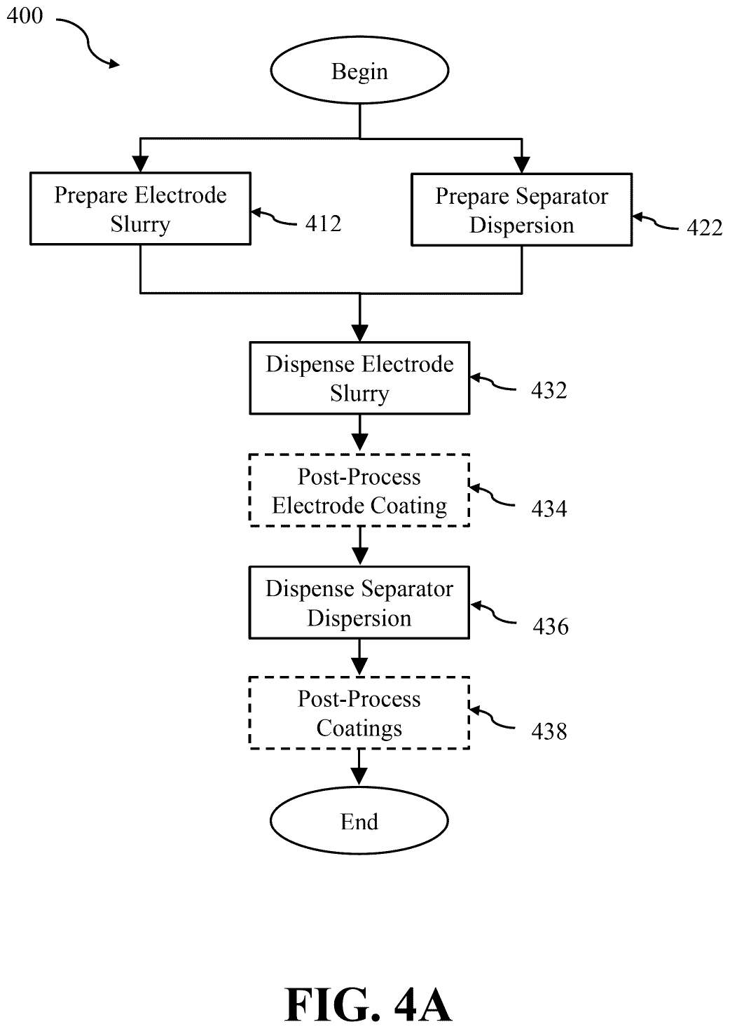

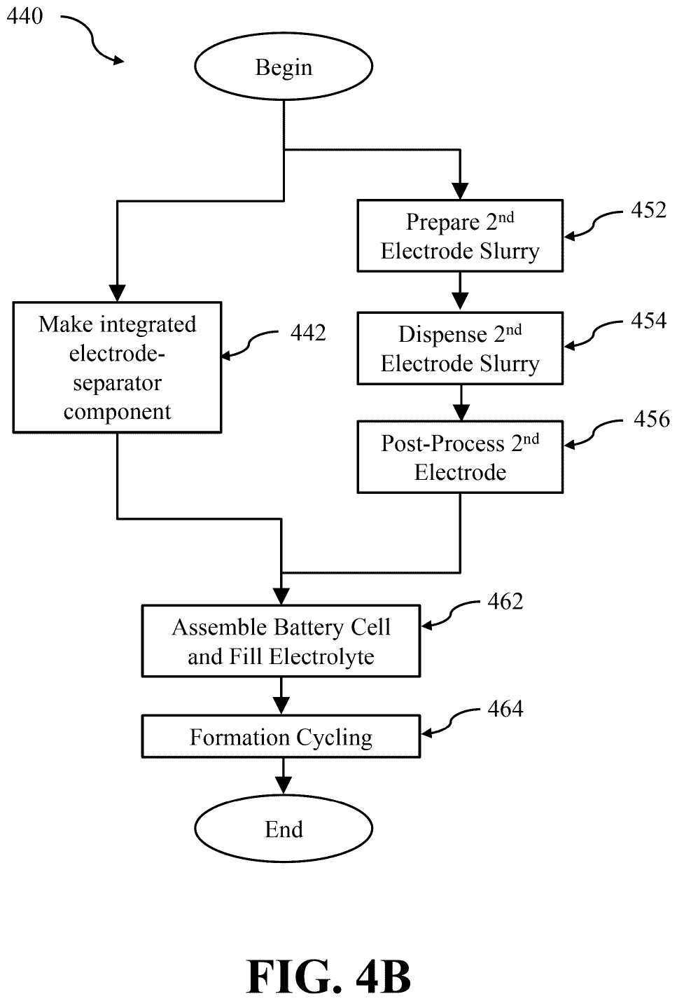

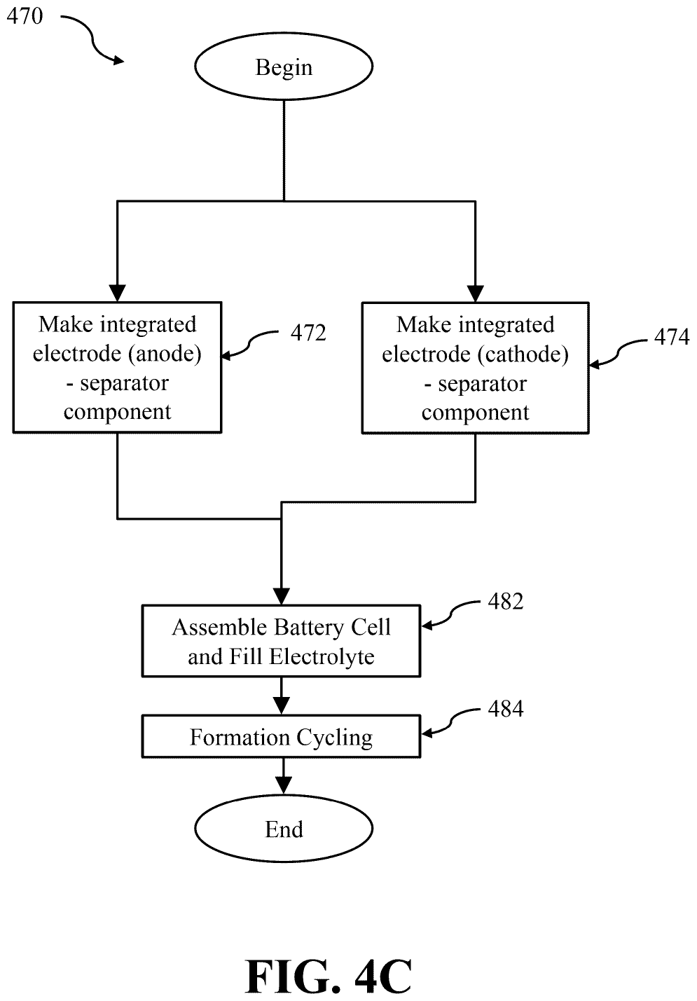

In some implementations, stage 230 may include making a separator. An example process 300 for making a separator is shown in FIG. 3. Process 300 includes stages 312, 314, and 316. Stage 312 includes preparing a separator dispersion. At stage 312, the separator dispersion may be formed by mixing ceramic (nano)particles (e.g., elongate ceramic (nano)particles) with a solvent, any binder, and any other functional additives (e.g., surfactants, dispersants, flame retardants). Herein, examples of solvents include water and organic solvents including alcohols and N-Methyl-2-pyrrolidone (NMP). Herein, a solvent may be a mixture of suitable solvent compounds. At stage 314, the separator dispersion (e.g., obtained from stage 312) is dispensed on a substrate (e.g., a porous polymer membrane or an electrode or a sacrificial substrate, etc.). The dispensing may be carried out using any suitable coating process, including slot die coating, microgravure coating, blade coating, spray-based coating, and electrostatic jet coating. The dispensing may be carried out in a roll-to-roll process, with the substrate being in the form of a roll and being in an unrolled state during the dispensing. At stage 316, the dispensed separator composition is dried to completely evaporate the solvent, to form the separator coating. At stage 316, any other post-dispensing process steps may be carried out on the separator coating. Stage 316 may additionally include depositing a porous layer comprising an adhesive (such as PVDF, PVA, among others). Such a porous adhesive layer deposition may be done using a slot die coating, microgravure coating, blade coating, spray-based coating, blast coating, electrostatic jet coating or other suitable coating technique. Stage 316 may additionally include other processes, such as cutting the separator to suitable dimensions (e.g., cutting a roll of the separator into individual separator pieces for assembly into a battery). Accordingly, a separator is formed from carrying out process 300. In some implementations, the dispensing at stage 312 is carried out on a polymer membrane (e.g., polyolefin membrane) as the substrate. In some implementations, the separator comprises a polymer membrane (e.g., polyolefin membrane) and a separator coating disposed on the polymer membrane. In other implementations, the substrate on which the separator coating is formed may be an electrode coating. In some implementations, the separator coating may be formed roll-to-roll on a dry (e.g., calendered) electrode. Such implementations are described with reference to FIGS. 4A and 4B below.

In some aspects, the substrate on which the separator coating is formed (e.g., at stage 314) may be a porous polymer membrane, such as a polyethylene (PE) membrane or a polypropylene (PP) membrane or a multilayer polymer membrane (e.g., a multilayer structure comprising a PP layer, a PE layer, and another PP layer). These porous polymer membranes may be commercially available and may themselves be employed as separators in batteries but may lack the desired thermal and mechanical properties. In some implementations, the final thickness (e.g., after solvent evaporation) of the (e.g., ceramic particle-comprising) separator coating on such polymer membrane substrates may preferably be as thin as possible, while maintaining the desired properties. In some implementations, the final thickness (e.g., after solvent evaporation) of the separator coating on such polymer membrane substrates (herein, the thickness refers to the thickness of the separator coating only, excluding the thickness of the underlying substrate such as a polymer membrane substrate or an electrode coating) may be in a range of about 1.0 μm to about 20.0 μm (e.g., in a range of about 1.0 to about 2.0 μm; in a range of about 1.0 to about 3.0 μm; in a range of about 2.0 to about 5.0 μm; in a range of about 3.0 to about 5.0 μm; in a range of about 5.0 to about 10.0 μm; in a range of about 10.0 to about 20.0 μm; in a range of about 1.0 to about 1.2 μm; in a range of about 1.2 to about 1.5 μm; in a range of about 1.5 to about 1.8 μm; in a range of about 1.8 to about 2.0 μm; in a range of about 1.2 to about 2.0 μm; or in a range of about 1.2 to about 1.8 μm). In some implementations, the separator coating may exhibit a composition that changes with position (e.g., have less ceramic material near the surface relative to near the substrate or vice versa, have fewer ceramic particles near the surface relative to near the substrate or vice versa, have a lower porosity near the surface relative to near the substrate or vice versa, have smaller ceramic particles near the surface relative to near the substrate or vice versa, have different shape or different morphology of ceramic particles near the surface relative to near the substrate, have a different polymer binder composition near the surface relative to near the substrate or vice versa, etc.). In some implementations, at least one of the separator surfaces may be additionally coated with a porous layer comprising an adhesive (such as PVDF, PVA, among others).

An example process 400 for making an integrated electrode-separator component is shown in FIG. 4A. Process 400 includes stages 412, 422, 432, 434, 436, and 438. Some aspects of stage 434 may be optional, as explained below. Stage 412 includes preparing an electrode slurry. At stage 412, an electrode slurry (anode slurry or cathode slurry) may be formed by mixing the electrode active material (anode active material or cathode active material) with a binder, a solvent, any conductive additives, and any other functional additives. Stage 422 includes preparing a separator dispersion. At stage 422, the separator dispersion may be formed by mixing ceramic (nano)particles with a solvent, any binder, and any other functional additives (e.g., surfactants, dispersants, flame retardants). Stage 432 includes dispensing the electrode slurry (anode slurry or cathode slurry) onto and/or into a current collector. The dispensing of the electrode slurry may be carried out using any suitable coating process, including slot die coating and blade coating. The dispensing of the electrode slurry may be carried out in a roll-to-roll process, with the current collector being in the form of a roll and being in an unrolled state during the dispensing of the electrode slurry. At stage 434, the dispensed electrode composition (either an anode composition or a cathode composition, formed by dispensing the respective slurry) is dried to completely evaporate the solvent, to form an electrode coating. At stage 434, any other post-dispensing process steps may be carried out on the electrode coating. For example, the dispensed compositions may undergo a calendering process (compaction), which may be carried out after the drying (solvent evaporation) process. At stage 436, the separator dispersion (e.g., obtained from stage 422) is dispensed on the substrate, which is the current collector with the electrode coating formed thereon. The dispensing of the separator dispersion is carried out such that the separator coating comes into intimate contact with the electrode coating. The dispensing of the separator dispersion may be carried out using any suitable coating process, including slot die coating, reverse gravure coating (kiss coating), blade coating, spray-based coating, and electrostatic jet coating. The dispensing of the separator dispersion may be carried out in a roll-to-roll process, with the substrate being in the form of a roll and being in an unrolled state during the dispensing of the separator dispersion. At stage 438, the dispensed separator composition is dried to completely evaporate the solvent, to form the separator coating. At stage 438, any other post-dispensing process steps may be carried out on the separator coating. For example, the dispensed compositions may undergo a calendering process (compaction), which may be carried out after the drying (solvent evaporation) process. In another example, the separator surface may be additionally coated with a porous layer comprising an adhesive (such as PVDF, PVA, among others). Stage 438 may additionally include other processes, such as cutting the integrated electrode-separator to suitable dimensions (e.g., cutting a roll of the integrated electrode-separator into individual integrated electrode-separator pieces for assembly into a battery). In some implementations, portions of the post-dispensing processes at stage 434 may be omitted. For example, a calendering process during stage 434 may be omitted since the subsequent stage 438 may include a calendering process which would result in the compaction of both the separator coating and the electrode coating. In some implementations, portions of the post-dispensing processes at stage 438 may be omitted. For example, a calendering process may be carried out at stage 434, which results in a compaction of the electrode coating, but a calendering process may be omitted at stage 438. In this example, the electrode coating undergoes calendering (compaction) but the electrode coating-separator coating combination does not undergo calendering (compaction).

In some aspects, an integrated electrode-separator component comprises an electrode coating disposed on a current collector and a separator coating disposed on the electrode coating. In some implementations, the final thickness (e.g., after solvent evaporation) of the separator coating on such substrates (electrode coating formed on current collector) may be in a range of about 1 μm to about 20 μm (e.g., in a range of about 1 to about 3 μm; in a range of about 3 to about 5 μm; in a range of about 1 to about 5 μm; in a range of about 5 to about 10 μm; in a range of about 1 to about 10 μm; in a range of about 10 to about 15 μm; in a range of about 15 to about 20 μm; or in a range of about 1 to about 15 μm). In some aspects, the term “integrated electrode-separator component” is used to refer to an electrode-separator component in which a slurry of the separator material (separator dispersion) is dispensed on the electrode coating. Such an integrated electrode-separator component is distinguished from other electrode-separator components in which a separator membrane (formed elsewhere) is disposed on (e.g., brought into contact with) the electrode coating.

In some aspects, an integrated electrode-separator component comprises an electrode coating disposed on a current collector and a separator coating disposed on the electrode coating. Such an integrated electrode-separator component may be employed in making a lithium-ion battery, as illustrated in FIG. 4B. FIG. 4B illustrates an example process 440 of making a Li-ion battery. The flow diagram includes a left branch and a right branch. The left branch relates to the making of an integrated electrode-separator component, as detailed in FIG. 4A. The right branch relates to making a second electrode (i.e., polarity of the second electrode is opposite to that of the electrode of the integrated electrode-separator component). The left and right branches may be carried out concurrently or sequentially as desired. The left branch includes stage 442. In some implementations, stage 442 includes process 400 as shown in FIG. 4A. The right branch includes stages 452, 454, and 456. Stage 452 comprises preparing a second electrode slurry. At stage 452, the second electrode slurry may be formed by mixing the second electrode active material with a binder, a solvent, any conductive additives, and any other functional additives. At stage 454, the second electrode slurry is dispensed onto and/or into a suitable current collector. The dispensing may be carried out using any suitable coating process, including slot die coating and blade coating. The dispensing may be carried out in a roll-to-roll process, with the current collector being in the form of a roll and being in an unrolled state during the dispensing. In certain aspects, the current collector can comprise a metal foil, metallized (e.g., metal-coated polymer) film/foil, metal wire, metal mesh, or any combination thereof. In certain aspects, the current collector can comprise Cu or Cu-alloy foil or coating for anodes and Al or Al-alloy foil or coating for cathodes, in many instances. At stage 456, the dispensed electrode is dried to completely evaporate the solvent, to form an electrode coating. At stage 456, any other post-dispensing process steps may be carried out on the electrode coating. For example, the dispensed compositions may undergo a calendering process (compaction), which may be carried out after the drying (solvent evaporation) process. Stage 456 may additionally include other processes, such as cutting the electrode-current collector to suitable dimensions (e.g., cutting a roll of the electrode-current collector into individual pieces for assembly into a battery).

Process 440 (FIG. 4B) additionally includes stages 462 and 464. Stage 462 includes assembling of the battery cell from the battery components (e.g., integrated electrode-separator component from stage 442, second electrode from stage 456, battery case, sealing member) and filling the cell with an electrolyte. Stage 464 includes carrying out any formation cycling on the assembled battery, to form a solid-electrolyte interphase (SEI) layer in the anode and/or the cathode.

FIG. 4C illustrates an example process 470 of making a Li-ion battery. The flow diagram includes a left branch (stage 472) and a right branch (stage 474). The left branch (stage 472) relates to the making of an integrated anode electrode-separator component, and the right branch (stage 474) relates to the making of an integrated cathode electrode-separator component. Each of these stages 472, 474 may be implemented as detailed in FIG. 4A. The left and right branches may be carried out concurrently or sequentially as desired. Accordingly, process 470 differs from process 440 in that each of the electrodes (anode, cathode) is part of a respective integrated electrode-separator component. Process 470 additionally includes stages 482 and 484. Stage 482 includes assembling of the battery cell from the battery components (e.g., integrated anode-separator component from stage 472, integrated cathode-separator component from stage 474, battery case, sealing member) and filling the cell with an electrolyte. Stage 484 includes carrying out any formation cycling on the assembled battery, to form a solid-electrolyte interphase (SEI) layer in the anode and/or the cathode. At stage 482, the integrated electrode-separator components are assembled such that the separator coatings face each other. Since the separator comprises the two separator coatings in a stack, the likelihood of pinhole defects that extend continuously between the anode and the cathode is significantly reduced.

In still further aspects, disclosed herein is a battery. In such exemplary and unlimiting aspects, the battery is a lithium-ion battery (1) made according to process 200 (FIG. 2); (2) made according to process 440 (FIG. 4B); (3) comprising a separator made according to process 300 (FIG. 3); and/or (4) comprising an integrated electrode-separator component made according to process 400 (FIG. 4A). At stage 232 (FIG. 2) or stage 462 (FIG. 4B), the lithium battery cell is assembled with an electrolyte interposed between the anode electrode and the cathode electrode. The electrolyte provides ionic conduction between the anode and the cathode. The electrolyte ionically couples the anode and the cathode. The electrolyte may comprise a liquid electrolyte or a solid electrolyte (or a mixture of liquid and solid electrolyte or a gel electrolyte) at battery operating temperatures (e.g., in some designs, the solid electrolyte may be molten or semi-molten during melt-infiltration and may subsequently solidify). In some implementations, e.g., implementations in which a liquid electrolyte is used, a separator (or the separator portion of an integrated electrode-separator component) may be used to maintain a space between the anode and the cathode electrodes. In such an implementation, the liquid electrolyte may infiltrate the separator (or the separator portion of an integrated electrode-separator component). Stage 232 and stage 462 may also include packaging the battery into a desired configuration (e.g., a cylindrical cell configuration, a prismatic cell configuration, a pouch cell configuration), degassing, sealing and aging processes.

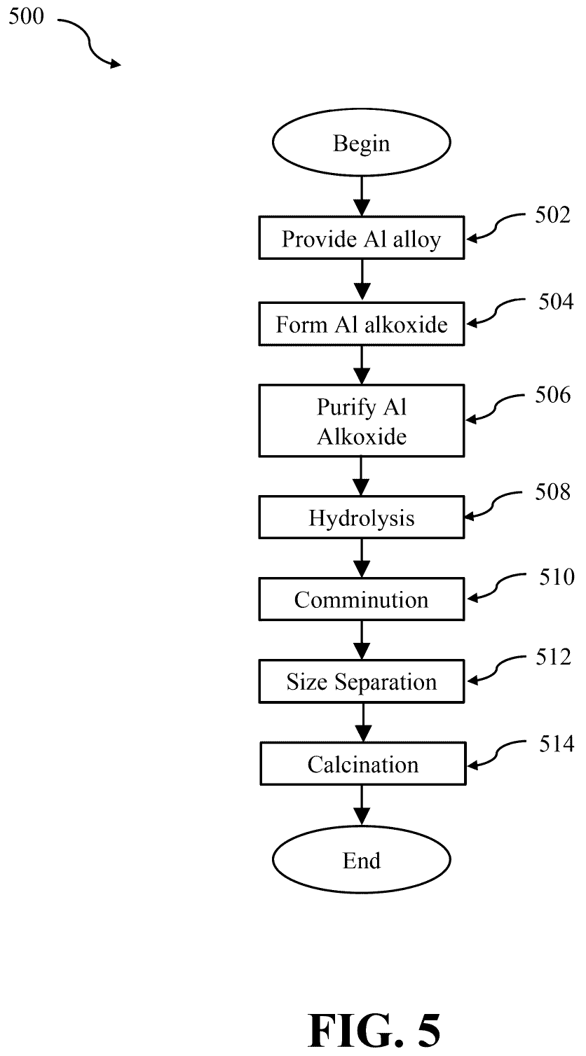

FIG. 5 shows an example process 500 of making elongate ceramic (nano)particles. The elongate ceramic (nano)particles may be employed in making separators (e.g., according to process 300 of FIG. 3 or process 400 of FIG. 4A). FIG. 5 shows a schematic of the elongate ceramic (nano)particle synthesis process. At stage 502, a high-purity (e.g., purity of about 98% or greater, purity of about 99% or greater) aluminum-lithium (AlLi) alloy is provided. In some implementations, the mass fraction of Li in the AlLi alloy is in a range of about 0.1 wt. % to about 20 wt. %. At stage 504, particles of the AlLi alloy are dispersed in a dry alcohol, such as dry ethanol; reaction products formed from the reactions between the AlLi alloy and the dry alcohol include aluminum alkoxide particles (e.g., aluminum alkoxide (nano)fibers, bundles of aluminum alkoxide (nano)fibers, and other aluminum alkoxide particles). In implementations in which the dry alcohol is dry ethanol, the aluminum alkoxide is aluminum ethoxide. Stage 506 includes purification of the reaction product by filtration (e.g., using additional dry alcohol) to obtain aluminum alkoxide particles of greater purity. At stage 508, the purified aluminum alkoxide is hydrolyzed to form aluminum hydroxide. In some implementations, the hydrolysis is carried out via exposure of the solid phase aluminum alkoxide (e.g., aluminum ethoxide) to an H₂O saturated wet gas (e.g., air, Argon and Nitrogen may be used) at a temperature in a range of about 20 to about 140° C. with a water content of about 0.001 to about 20 vol. %. In some implementations, the aluminum hydroxide particles may be (at least partially) converted to aluminum phosphate particles (e.g., by soaking or exposing them to phosphoric acid, among other means) in order, for example, to tune their thermal or chemical or structural or mechanical properties (e.g., in order to further enhance battery performance or safety). At stage 510, the aluminum hydroxide (or aluminum phosphate) particles undergo comminution (e.g., milling). For example, in the case of milling, the aluminum hydroxide (or aluminum phosphate) particles may be milled by exposing to hard plastic or ceramic media in rotational or orbital motion in an orbital mixer or a shaker table. At stage 512, the aluminum hydroxide (or aluminum phosphate) particles (e.g., from stage 510, after comminution) undergoes particle size selection. For example, the particle size selection may be carried out by passing the aluminum hydroxide (or aluminum phosphate) particles through a sieve (e.g., sieve screen with an opening size in a range of about 10 μm to about 5 mm). At stage 514, the aluminum hydroxide particles undergo calcination (heat treatment) to be transformed to alumina (Al₂O₃) particles. The phase (or phase mixture) of the alumina particles has been found to depend on the calcination temperature: in some implementations, calcination at temperatures of about 900° C. and higher yields γ-alumina. while calcination at temperatures of about 950° C. and higher yields α-alumina, with the mass fraction of α-alumina increasing with increasing calcination temperatures. Note that if aluminum phosphate particles are used, the heat treatment may be omitted or done with care in a controlled environment in order to avoid undesirable chemical transformations (e.g., from phosphate to oxide) while attaining desirable properties (e.g., improved thermal stability).

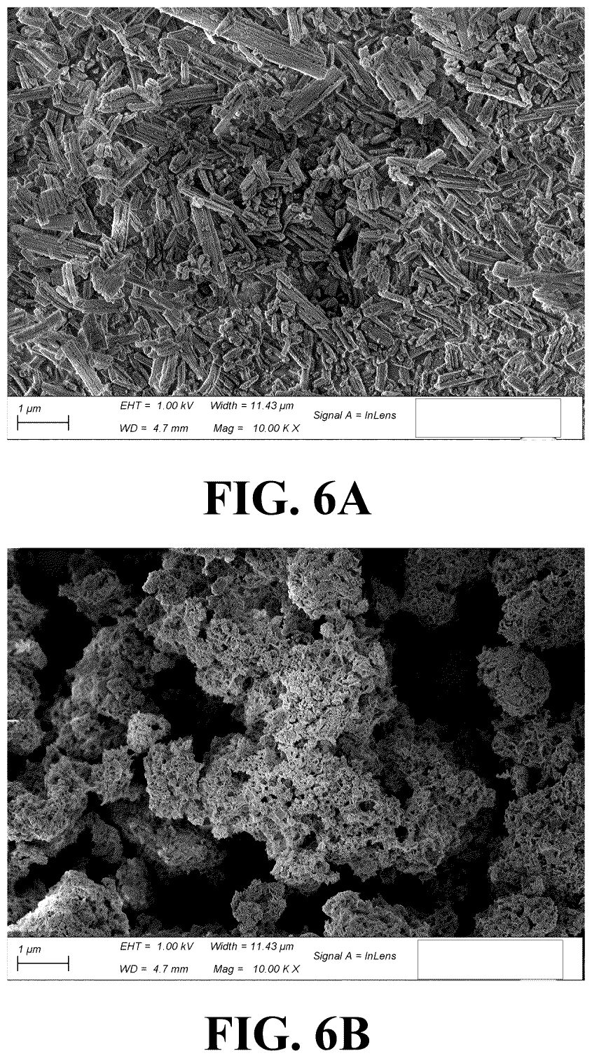

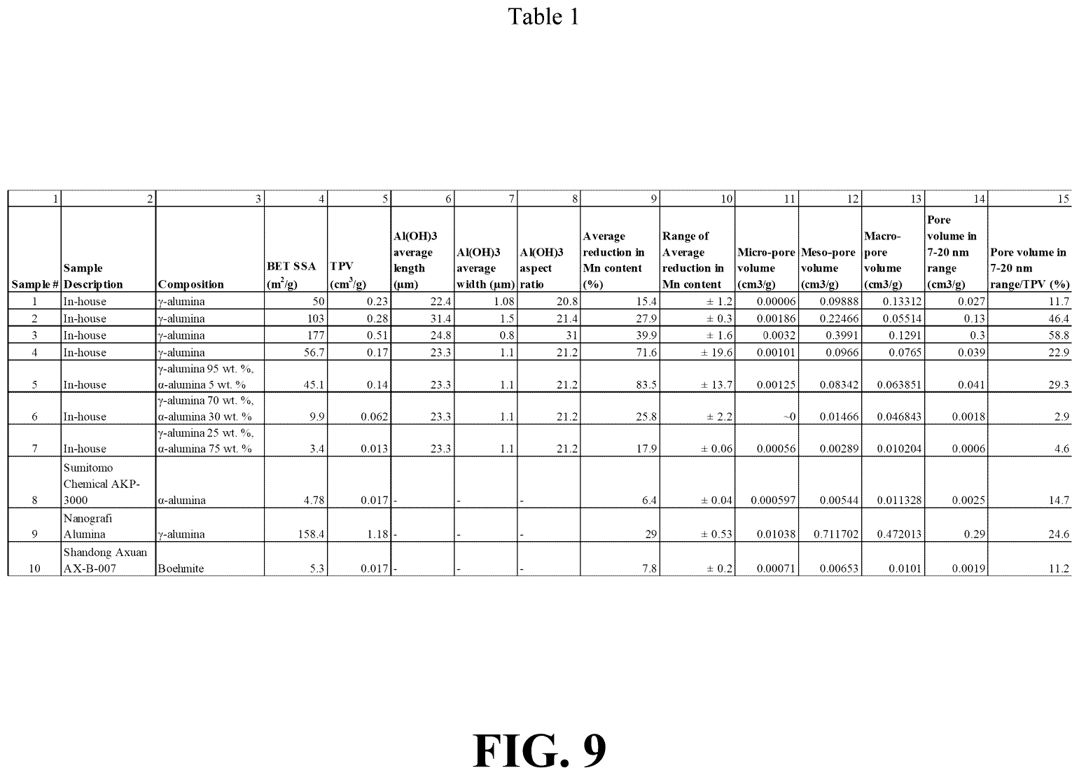

FIG. 6A shows a scanning electron microscope (SEM) image of Sample #3 (1C44) of elongate ceramic (nano)particles. The Sample #3 elongate ceramic (nano)particles (characterized in more detail below with respect to Table 1 of FIG. 9) have been synthesized according to process 500 (FIG. 5). In the example shown, the ceramic (nano)particles are γ-alumina. Elongate ceramic (nano)particles exhibiting aspect ratios of about 1:3 or greater are visible. Elongate ceramic (nano)particles with lengths (i.e., lengths along the elongate direction of each respective elongate ceramic (nano)particle) of about 2 μm or greater (e.g., in a range of about 2 to about 50 μm) are visible. Elongate ceramic (nano)particles with transverse dimensions in directions perpendicular to the elongate direction in a range of about 1 to about 950 nm (e.g., in a range of 1 to about 100 nm) are visible.

FIG. 6B shows an SEM image of Sample #9 of commercially available ceramic (nano)particles (γ-alumina (nano)particles obtained from NANOGRAFI Nano Technology) (characterized in more detail below with respect to Table 1 of FIG. 9).

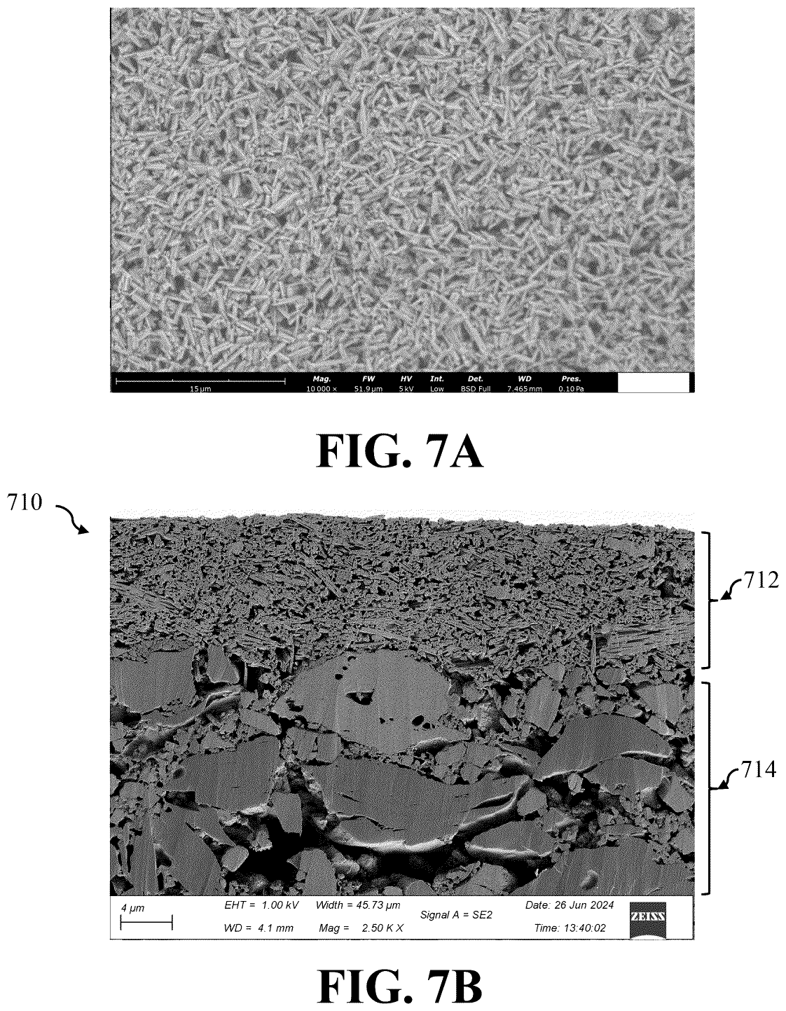

FIGS. 7A and 7B show plan view and cross-sectional view SEM images, respectively, of a coating of a sample of elongate ceramic (nano)particles. The elongate ceramic (nano)particles have been synthesized according to process 500 (FIG. 5). In the example shown, the ceramic (nano)particles are γ-alumina. FIG. 7B shows a cross-sectional view of an integrated electrode-separator component 710. Integrated electrode-separator component 710 comprises a separator coating portion 712, disposed on an electrode coating portion 714. Separator coating portion 712 comprises the elongate ceramic (nano)particles and electrode coating portion 714 comprises silicon-carbon composite particles. In the example shown, the electrode coating portion 714 may be configured as the anode in a lithium-ion battery.

Cathode active materials comprising manganese (Mn) have been employed in lithium-ion batteries. Mn-comprising cathode active materials include, but not limited to: (1) layered transition metal oxides (such as lithium nickel manganese cobalt oxides, NMC or NMC-type oxides (e.g., could be Co-free) with various Ni content (e.g., 30-90 at. % relative to other transition metals), lithium Mn-rich, Ni-comprising transition metal oxides, LMR, among others), (2) spinel-type lithium manganese oxide (LMO) compounds, (3) spinel-type lithium manganese nickel oxide (LMNO) compounds, and (4) olivine-type lithium manganese iron phosphate (LMFP) compounds. Examples of layered transition metal oxides are NMC (lithium nickel cobalt manganese oxide) compounds, i.e., compounds with an approximate composition of Li₁NiₓMn_{y}Co_{z}O₂ in which x, y, and z sum to about 1 and at least one of x, y, and z is greater than 0 (note that Li content may be slightly larger than 1 or slightly smaller than 1 (e.g., 0.9-1.1) in some implementations; note that 0 content may be slightly smaller than 2 or slightly larger than 2 in some implementations). Examples of Mn-comprising spinel-type LMP compounds are compounds with a composition of Li₁₊ₚMn₂₋ₚO₄ in which p is greater than or equal to 0 and p is less than 2. Examples of Mn-comprising spinel-type LMNO compounds are compounds with a composition of LiNi_{q}Mn_{2-q}O₄ in which q is greater than or equal to 0 and q is less than 2. Examples of Mn-comprising olivine-type LMFP compounds are compounds with a composition of LiFe₁₋ᵣMnᵣPO₄ in which r is greater than or equal to 0 and r is less than or equal to 1.

In some cases, the performance of Li-ion batteries employing Mn-comprising cathode materials may be limited by a degradation pathway which includes dissolution of Mn into the electrolyte, the transport of the Mn ions from the cathode to the anode, and the reduction of the Mn ions at the anode. This degradation mechanism is known to limit the lifetime of Li-ion batteries employing Mn-comprising cathode materials, particularly LMO or LMFP compounds. The degradation can be mitigated by decreasing the dissolution of Mn in the cathode and/or decreasing the transport of Mn ions from the cathode to the anode. The inventors have unexpectedly found that a separator comprising certain highly-porous elongate ceramic (nano)particles exhibits a notable uptake (gettering or absorption) of Mn ions. Accordingly, a separator comprising these highly-porous elongate ceramic (nano)particles may be positioned between the anode and the cathode to decrease the transport of Mn ions to the anode.

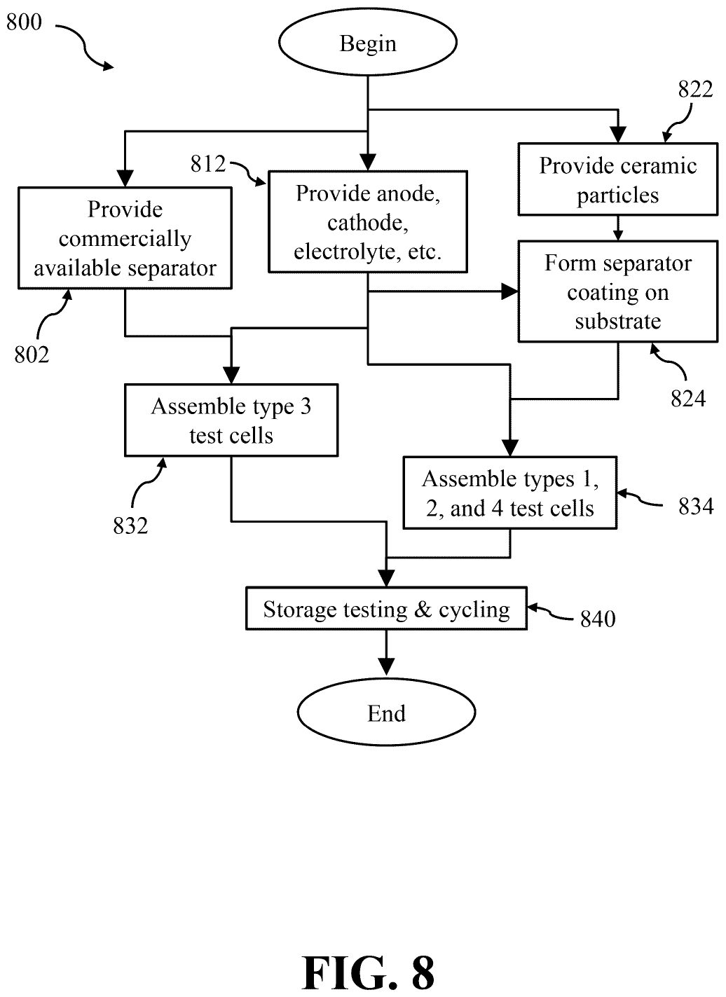

Example process 800 for evaluating (e.g., storage testing, cycling) of test battery test cells is illustrated in FIG. 8. According to process 800, four types of separator samples, incorporated into test cells, may be evaluated: (type 1) examples in which the separator is formed by coating elongate ceramic (nano)particles on a polymer membrane; (type 2) comparative examples in which the separator is formed by coating commercially available ceramic particles on a polymer membrane; (type 3) comparative examples in which the separator is a commercially available separator; and (type 4) examples in which the test cell includes an integrated electrode-separator component, wherein the integrated electrode-separator component is formed by coating elongate ceramic (nano)particles on an electrode coating on a current collector. Process 800 includes stages 802, 812, 822, 824, 832, 834, and 840. Stages 802, 812, and 832 relate to the fabrication of type 3 test cells. Stages 812, 822, 824, and 834 relate to the fabrication of type 1, type 2, and type 4 test cells. Stage 840 relates to the testing of test cells regardless of test cell type.

At stage 802, a commercially available separator is provided. At stage 812, battery components other than the separator (e.g., anode, cathode, battery case, sealing member, electrolyte) are provided. Stage 802 may include the formation of an electrode coating (e.g., anode coating or cathode coating) on a current collector to use as a substrate for forming a separator coating. In such a case, an integrated electrode-separator component may be formed. Type 3 test cells are assembled at stage 832. Type 1, type 2, and type 4 test cells are assembled at stage 834. As needed, formation cycling may be carried out before the test cells under storage testing and/or cycling (stage 840).

At stage 822, ceramic particles are provided. For fabrication of type 1 and type 4 test cells, certain elongate ceramic (nano)particles as described herein are provided (e.g., synthesized according to process 500) at stage 822. For fabrication of type 2 test cells, commercially available ceramic particles are provided at stage 822. At stage 824, a separator coating is formed on a substrate (e.g., a polymer membrane, or an electrode coating from stage 812). In some implementations, stage 824 may be accomplished by carrying out process 300 (FIG. 3, for type 1 or type 2 test cells) or process 400 (FIG. 4A, for type 4 test cells). Type 1, type 2, and type 4 test cells are assembled at stage 834. As needed, formation cycling may be carried out before the test cells under storage testing and/or cycling (stage 840).

Stage 812 may comprise the formation of the anode, formation of the cathode, and preparation of the electrolyte. Example procedures for forming the cathode are as follows: The cathode slurry is prepared by mixing a cathode active material with a PVDF-based binder and a carbon black conductive additives in an organic solvent such as n-methyl-2-pyrrolidone (NMP). The cathode active material may be LiNiₓMn_{y}Co_{z}O₂ (the sum of x, y, and z is about 1 and at least one of x, y, and z is greater than 0), Li₁₊ₚMn₂₋ₚO₄ (p is greater than or equal to 0 and p is less than 2), LiNi_{q}Mn_{2-q}O₄ (q is greater than or equal to 0 and q is less than 2), and/or LiFe₁₋ᵣMnᵣPO₄, (r is greater than or equal to 0 and r is less than or equal to 1). The cathode slurry is cast on an aluminum foil current collector, which is dried and cut into the desired electrode dimensions. Example procedures for forming the anode are as follows: The anode active materials comprising graphite particles and/or carbon- and silicon-containing composite particles are mixed with carboxymethyl cellulose (CMC) and styrene butadiene rubber (SBR) binders, a carbon black conductive additive, and water to form the anode slurry. Alternatively, the anode slurry may include polyacrylic acid (PAA)-based binders (including its Li-, Na-, or other salt forms) (e.g., with or without CMC; with or without SBR). The anode slurry is cast on a copper foil current collector, which is dried and cut into the desired electrode dimensions. Example procedures for forming the separator coating are as follows: A slurry comprising ceramic particles, one or more binder(s), and an organic solvent is prepared and cast on (1) a polymer membrane or (2) directly on the anode or cathode to prepare type 1 or type 2 test cells. The separator slurry may use water as the solvent. The binders for the separator slurry may include one or more of the following: carboxymethyl cellulose or other cellulose-based binders, styrene butadiene rubber, polyacrylic acid or its derivatives, polyvinyl butyral, polyacrylonitrile, poly(vinyl acetate), or polyimide-based binders. Type 1 and type 2 cells comprise an anode, a cathode, and a ceramic separator coating on a polymer membrane, in which the ceramic separator coating comprises elongate ceramic (nano)particles (type 1) or commercially available ceramic particles (type 2). A ceramic separator coating may be further coated with a porous adhesive surface layer, in some alternative implementations. Commercially available separator membranes are used to construct the type 3 test cell comprising anode, cathode, separator and electrolyte. In the examples shown, the electrolyte comprises a mixture of 13.92 wt. % of LiPF₆ (as a primary lithium salt), 13.33 wt. % of fluoroethylene carbonate (FEC), 5.04 wt. % of ethylene carbonate (EC), 3.85 wt. % of ethyl methyl carbonate (EMC), 62.49 wt. % of dimethyl carbonate (DMC), 0.52 wt. % of vinylene carbonate (VC), and 0.85 wt. % of lithium difluorophosphate (LFO).

In some implementations, the fully assembled cells undergo galvanostatic cycling and calendar aging (storage aging) using a testing system (e.g., Arbin LBT Series Tester). In some examples, a standard formation cycling protocol consists of two charge/discharge cycles with a 10-hour charge (constant current, C/10) and 10-hour discharge (constant current, C/10) times. The charge portion of each charge/discharge cycle starts at the bottom of charge (e.g., 2.5 V) and ends at top of charge (e.g., 4.20 V). In some examples, a charge/discharge cycle according to a standard (long-term) cycling protocol consists of a 1-hour charge step (constant current, 1 C) followed by a constant voltage (CV) step with a taper to a current density of C/20, and 1-hour discharge step (constant current, 1 C), wherein the charge portion of each cycle starts at the bottom of charge (e.g., 2.5 V) and ends at top of charge (e.g., 4.20 V). The cycling continues until the cell capacity reaches 80% of the cycling start capacity. In some examples, a standard calendar (storage) aging protocol consists of storing the cell, at top of charge in open-circuit voltage condition, in a high-temperature chamber (e.g., 60° C.) for 1 month, followed by (1) a 3-hour discharge step (constant current, C/3) to the bottom of charge, (2) a 2-hour charge step (constant current, C/2) followed by a CV step with a taper to a current density of C/20, and (3) a 2-hour discharge step (constant current, C/2).

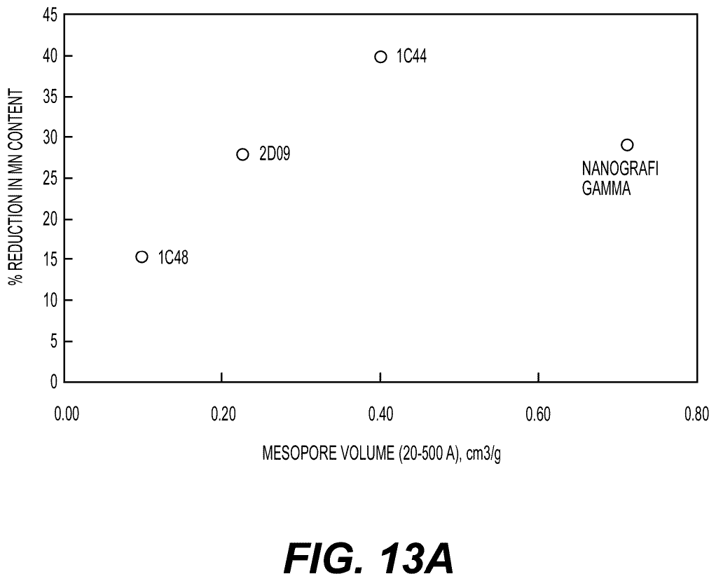

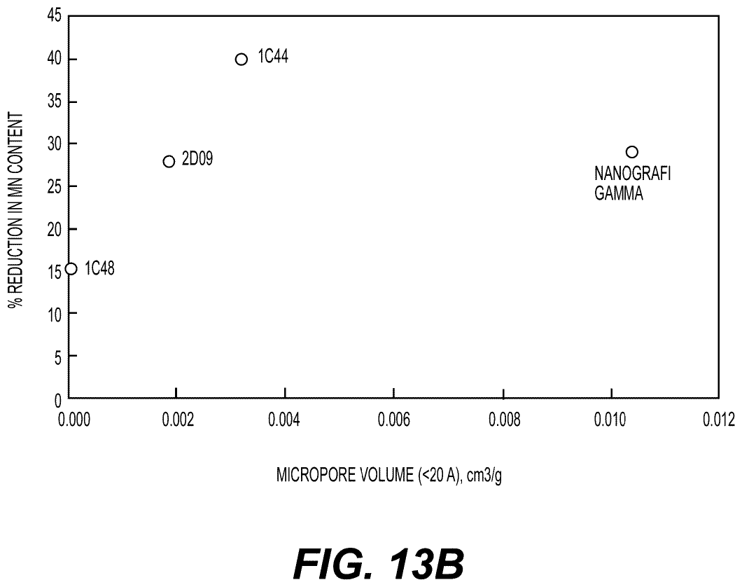

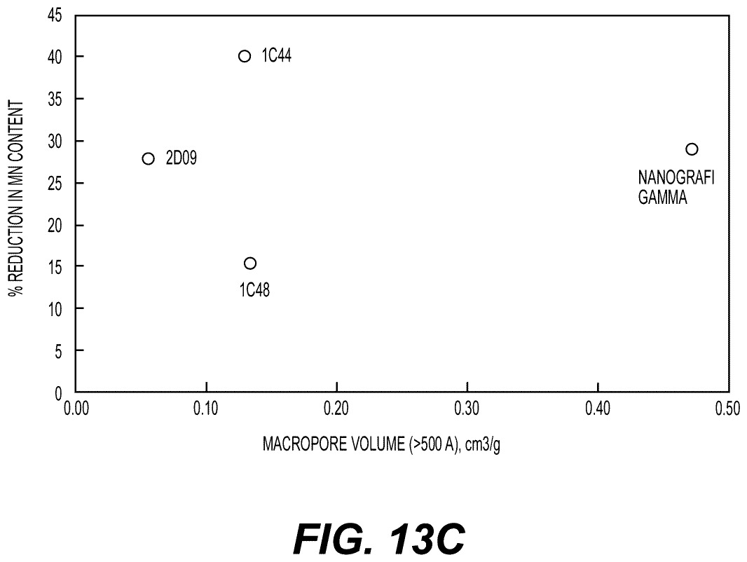

In some implementations, the Mn gettering performance may be evaluated using samples of ceramic particles immersed in an electrolyte solution comprising Mn ions. The effectiveness of reduction of Mn ion concentration in solution was evaluated for elongate ceramic (nano)particles prepared in-house and comparative examples sourced from commercial suppliers. The measurement results are reported in Table 1 (FIG. 9) (columns 9, 10) of FIG. 9 and FIGS. 13A, 13B, and 13C. First, an organic solution was prepared by mixing dimethyl carbonate and ethylene carbonate in a 1:1 weight ratio. Second, 50 mM of manganese(II) bis(trifluoromethanesulfonyl)imide was added to the organic solution. Third, 1.5 mL of the Mn-comprising solution was added to a Nalgene™ HDPE bottle and mixed with 200 mg of elongate ceramic (nano)particles prepared in-house (or comparative example particles sourced from commercial suppliers) and stored for 24 hours. The Mn content of the solution was measured using an ion chromatography instrument coupled with conductivity detector and mass spectrometer (IC-CD/MS) before and after a 24-hour exposure to elongate ceramic (nano)particles or commercially-sourced ceramic particles. The IC-CD/MS tool used herein was a DIONEX ICS-6000 HPIC System with DIONEX IONPAC CS12A IC Analytical Column 8 μm, 2×250 mm and DIONEX IONPAC CG12 IC Guard Column A-8 μm, 2×50 mm. Chromatographic data were processed and analyzed using THERMO SCIENTIFIC CHROMELEON Chromatography Data System (CDS) software. Samples were filtered through a 0.45 μm Nylon filter to remove particulates. Samples were diluted 200 times with deionized water to bring the concentrations within the linear range of the ion chromatography system. A series of Mn standard solutions with known concentrations of the target cations (Mn²⁺ ions) were used to construct calibration curves with the following concentrations: 0.625, 1.25, 2.5, 5, 10, and 20 g/L. The peak areas were plotted against the concentrations to create the calibration curves, which were then employed to quantify the Mn²⁺ ions in the samples. The correlation coefficient (R²) for cation calibration curve exceeded 0.999, indicating excellent linearity. Methanesulfonic acid (MSA) eluent was generated using the THERMO SCIENTIFIC DIONEX EGC 500 MSA Eluent Generator Cartridge. The eluent concentration was precisely controlled to ensure optimal separation and peak shape for the cations.

FIG. 9 (Table 1) shows selected data relating to composition and properties of elongate ceramic (nano)particle examples (Sample #1 through #7) and comparative examples (Sample #8, 9, and 10). Table 1 reports a sample number (column 1), a sample description (column 2), an approximate composition, as determined by x-ray diffraction (column 3), a BET-SSA (in units of m²/g) of the samples in powder form, as measured by physisorption of nitrogen gas around 77 K (column 4), a total pore volume (TPV) of the samples in powder form, as measured by physisorption of nitrogen gas around 77 K (column 5), an average length (in units of μm) of intermediate Al(OH)₃ particles, as determined by image analysis (column 6), an average width (in units of μm) of the intermediate Al(OH)₃ particles, as determined by image analysis (column 7), an average aspect ratio of the intermediate Al(OH)₃ particles obtained by dividing the average length by the average width (divide column 6 by column 7) (column 8), an average reduction (in units %) of the Mn content of the electrolyte, and its range, as described in detail herein (columns 9 and 10), a cumulative pore volume (in units of cm³/g) of micropores (pore sizes of up to 2 nm) of the samples in powder form (column 11), a cumulative pore volume (in units of cm³/g) of mesopores (pore sizes in a range of 2 to 50 nm) of the samples in powder form (column 12), a cumulative pore volume (in units of cm³/g) of macropores (pore sizes in a range of at least 50 nm) of the samples in powder form (column 13), a cumulative pore volume (in units of cm³/g) of pores (of pore sizes in a range of 7 to 20 nm) of the samples in powder form (column 14), and a volume fraction obtained by dividing the 7-20 nm pore volume by the total pore volume (divide column 14 by column 5) (column 15).

Specific surface area (SSA), pore size distribution (PSD), and single-point adsorption total pore volume (TPV) were calculated from N₂ physisorption isotherms measured using a MICROMERITICS TRISTAR II 3020 (software version 3.02). During measurement, N₂ is introduced into the sample cell at 77K and adsorbed to the sample by primarily van der Waals forces, and the adsorbed amount of N₂ is measured as a function of relative pressure p/po (where po is the saturation pressure of N₂). Both adsorption and desorption isotherms are measured, with the resulting hysteresis giving information on the pore network structure. Porosity regimes are defined by the IUPAC as follows: micropores: pore widths of <2 nm, mesopores: pore widths in a range of 2 to 50 nm, and macropores: pore widths>50 nm. Accurate micropore measurements typically require lower pressures (p/p₀<10⁻⁴) and/or the use of other adsorbate gasses (Ar, CO₂) for analysis. Thus, micropore volumes are estimated by these N₂ isotherms. Further, since pores of pore sizes>400 nm cannot be probed using N₂ physisorption, accurate characterization of macropores of pore sizes greater than 400 nm requires other techniques, such as mercury porosimetry, which has not been considered here. Accordingly, the pore volume fractions discussed herein are estimates based on N₂ physisorption. The Brunauer-Emmet-Teller (BET) method was used to extract the SSA of the materials from the linear regime of a 1/[n((p₀/p)−1)] vs. p/p₀ plot (typically in the relative pressure range 0.05-0.3) using the BET equation (Equation 1):

$$\frac{\frac{p}{{p}_{0}}}{n ( 1 - \frac{p}{{p}_{0}} )} = \frac{1}{{n}_{m} C} + \frac{C - 1}{{n}_{m} C} ( \frac{p}{{p}_{0}} ) \qquad ( Equation 1 )$$

where p/p₀ is the relative pressure, n is the ₐₘₒᵤₙₜ of adsorbed N₂ [mol/g], C is a constant (calculated from this linear fit), and nₘ is the BET monolayer capacity [mol/g](also calculated from this linear fit). The SSA is then calculated from the following Equation 2:

$$S = {n}_{m} \cdot {N}_{a} \cdot σ \qquad ( Equation 2 )$$

where Nₐ=Avogadro's number and G is the cross-sectional area of N₂. A combination of attractive fluid-solid and fluid-fluid interactions of N₂ within the pore network leads to a shift of vapor-liquid equilibrium, with condensation within pores typically shifted to lower relative pressures with decreased pore size. Nonlocal density functional theory (NLDFT, or often simply DFT), can account for these effects. A kernel, or a series of theoretical isotherms describing gas adsorption vs. pore size and relative pressure (at a fixed temperature and pore geometry), is generated using NLDFT modeling. Regression analysis is then used to compare an experimental isotherm with this kernel and calculate a distribution of pore sizes within the sample that fits this experimental isotherm. Finally, a single-point adsorption TPV is calculated based on Gurvich's rule, which states that the amount adsorbed at the limiting plateau of an isotherm is a measure of the total adsorption capacity. Herein, this was calculated at a relative pressure p/p₀ of 0.995, close to saturation.

Image analysis on scanning electron microscope (SEM) images was used to measure length and width of elongate ceramic (nano)particles. The samples were prepared by dispersing ˜1 g of elongate ceramic (nano)particles in ethanol, which was cast on a Si wafer and allowed to dry. For length measurements, THERMO FISHER PHENOM XL SEM (Model PW-100-018) was used with a 5 kV accelerating voltage and a backscatter electron detector (BSD) at 1,000× magnification. For width measurements, THERMO FISHER PHENOM XL SEM (Model PW-100-018) was used with a 5 kV accelerating voltage and a backscatter electron detector (BSD) at 10,000× magnification. Images were recorded for five random locations per sample for length and width measurements, and elongate ceramic (nano)particles were manually annotated to extract length and width. The aspect ratio was taken as the ratio of the average particle length to the average particle width.

Table 1 (FIG. 9) reports selected results from ten samples. For Sample Nos. 1-7, the elongate ceramic (nano)particles were prepared in-house, according to processes described herein. For Sample Nos. 8-10, commercially available ceramic particles were obtained from the respective manufacturers. In-house produced ceramic (nano)particles were calcined at or above about 900° C. However, lower calcination temperatures (e.g., about 300-900° C.; such as about 300-400° C. or about 400-500° C. or about 500-600° C. or about 600-700° C. or about 700-800° C. or about 800-900° C.) may be used in some implementations.

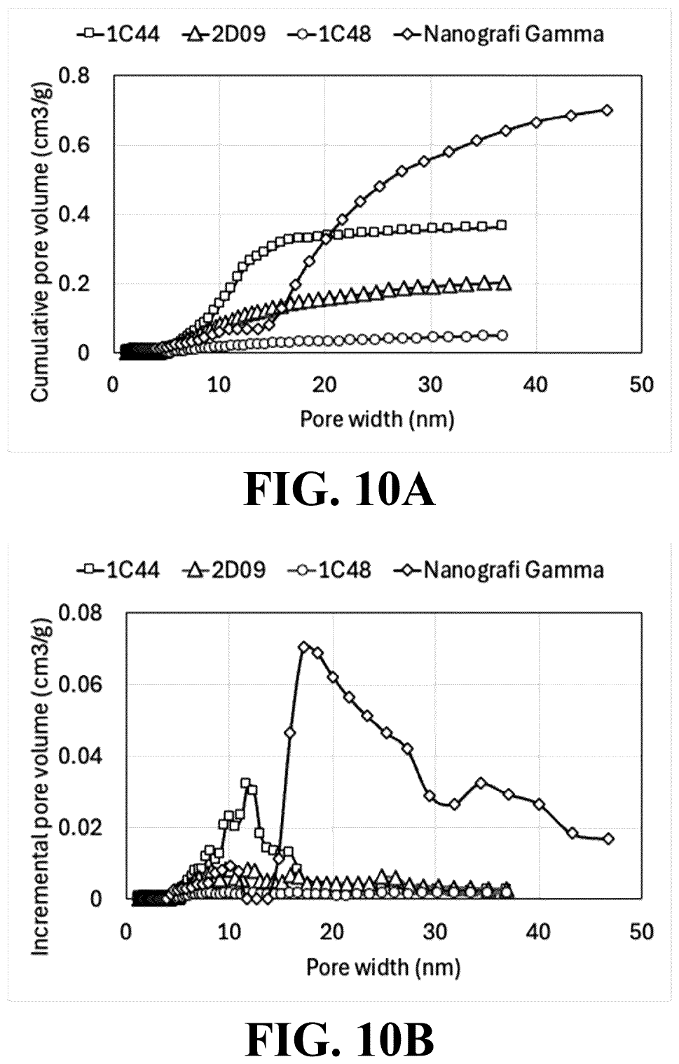

FIGS. 10A and 10B show cumulative pore volume and incremental pore volume data, respectively, of elongate ceramic (nano)particle examples and a comparative example. FIGS. 10A and 10B show the cumulative pore volume and the incremental pore volume, respectively, measured on powders of Sample #3 (1C44), Sample #2 (2D09), Sample #1 (1C48), and Sample #9 (NANOGRAFI alumina). Among these four samples, Sample #9 (NANOGPAFI alumina) exhibits the greatest cumulative pore volume (˜0.8 cm³/g) and the greatest total pore volume (TPV) (˜1.18 cm³/g). Among these four samples, Sample #3 (1C44) exhibits the second greatest cumulative pore volume (˜0.36 cm³/g) and the second greatest TPV (˜0.51 cm³/g). Nevertheless, the average reduction in Mn content is greater for Sample #3 (1C44) (˜39.9%) than for Sample #9 (NANOGRAFI alumina) (˜29%). The Mn gettering performance of Sample #9 (NANOGRAFI alumina) (˜29%) is quite close to that of Sample #2 (2D09) (˜27.9%), which exhibits a substantially lower cumulative pore volume (˜0.2 cm³/g) and TPV (˜0.28 cm³/g) than Sample #9. Accordingly, in some implementations, the Mn gettering performance would not be improved simply by increasing the TPV.

FIGS. 10A and 10B and Table 1 (FIG. 9) illustrate the differences in the pore size distributions of Sample #3 (1C44) and Sample #9 (NANOGRAFI). According to FIG. 10A, Sample #9 (NANOGRAFI) exhibits an onset of a more rapid increase in cumulative pore volume at pore widths of about 13 to about 15 nm. Sample #3 (1C44) exhibits an onset of a more rapid increase in cumulative pore volume at a pore width in a range of about 4 to about 6 nm. The cumulative pore volume of Sample #3 approaches a plateau at a pore width in a range of about 15 to about 17 nm. According to FIG. 10B, most of the pore volume of Sample #9 (NANOGRAFI) is in pores with pore widths of more than about 15 nm. On the other hand, most of the pore volume of Sample #3 (1C44) is in pores with pore widths in a range of 7 to 20 nm. Sample #3 (1C44) has a cumulative pore volume in a pore width range of 7 to 20 nm of about 0.3 cm³/g, which is about 59% of the TPV (˜0.51 cm³/g) (see Table 1 of FIG. 9). Sample #9 (NANOGRAFI) has a cumulative pore volume in a pore width range of 7 to 20 nm of about 0.29 cm³/g, which is about 25% of the TPV (˜1.18 cm³/g) (see Table 1 of FIG. 9).

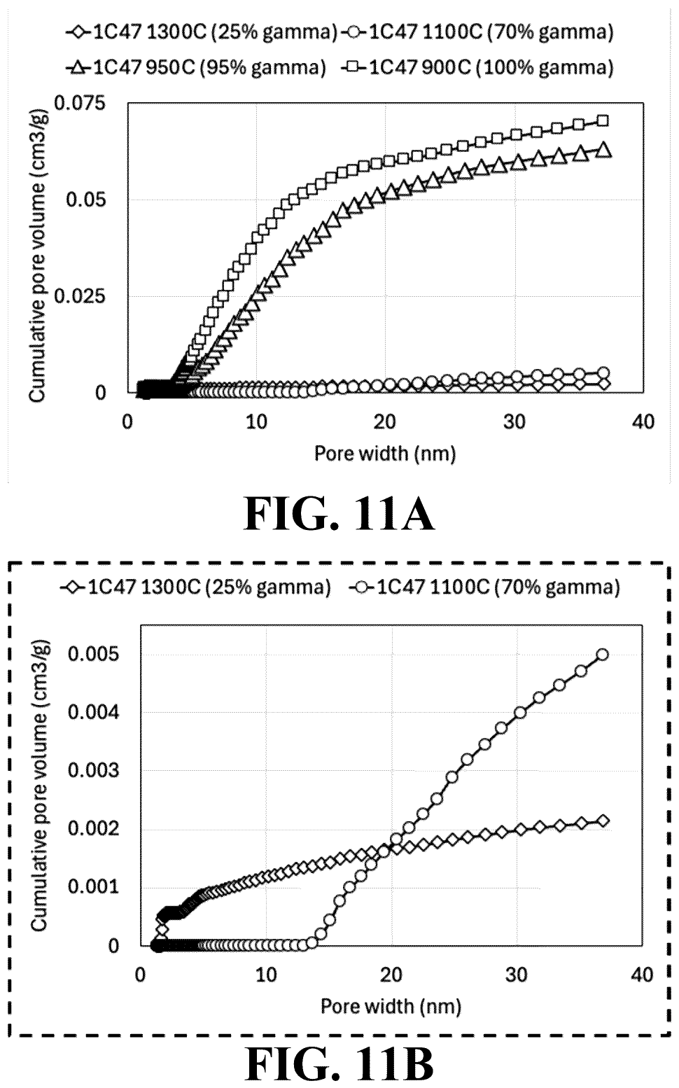

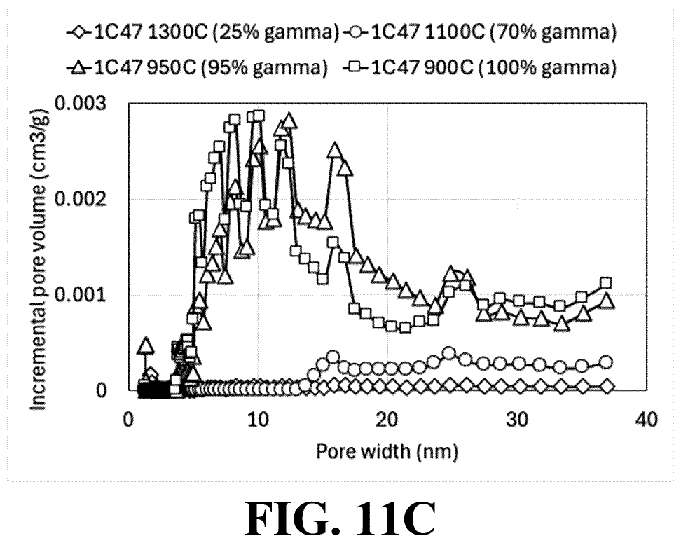

FIGS. 11A and 11C show cumulative pore volume and incremental pore volume data, respectively, of elongate ceramic (nano)particle examples of respective mass fractions of γ-alumina and α-alumina phases. The elongate ceramic (nano)particle examples considered are Sample #4 (1C47—900° C.), Sample #5 (1C47—950° C.), Sample #6 (1C47—1100° C.), and Sample #7(1C47—1300° C.) Each of these samples is obtained from the same synthesis batch (i.e., synthesis outlined in Process 500) except for the respective calcination temperatures (i.e., respective calcination temperatures at stage 514) being different. For Sample #4, the calcination temperature was about 900° C. and only γ-alumina was detected by x-ray diffraction (XRD), For Sample #5, the calcination temperature was about 950° C. and the composition detected by XRD was γ-alumina 95 wt. %, α-alumina 5 wt. %. For Sample #6, the calcination temperature was about 1100° C. and the composition detected by XRD was γ-alumina 70 wt. %, α-alumina 30 wt. %. For Sample #7, the calcination temperature was about 1300° C. and the composition detected by XRD was γ-alumina 25 wt. %, α-alumina 75 wt %. As the calcination temperature increases from about 900° C. to about 1300° C., the mass fraction of the α-alumina phase increases from about 0 to about 75 wt. % and the mass fraction of the γ-alumina phase decreases from about 100 to about 25 wt. % In the examples shown, as the mass fraction of the α-alumina phase increases from about 0 to about 75 wt. % (and the mass fraction of the γ-alumina phase decreases from about 100 to about 25 wt. %), the BET specific surface areas decrease from about 56.7 m²/g to about 3.4 m²/g, and the TPV decreases from about 0.17 cm³/g to about 0.017 cm³/g (shown in Table 1 of FIG. 9). The decrease in pore volumes with increasing calcination temperature is visible in FIG. 11A: the cumulative pore volumes for pore widths of up to about 38 nm are more than about 5×10⁻² cm³/g for Sample #4 (1C47—900° C.) and Sample #5 (1C47—950° C.) but about 5×10⁻³ cm³/or less for Sample #6 (1C47—1100° C.) and Sample #7 (1C47—1300° C.). Each of Sample #4 (1C47—900° C.) and Sample #5 (1C47—950° C.) exhibits an onset of a more rapid increase in a cumulative pore volume at pore widths of about 3 to about 6 nm.

FIG. 11B shows cumulative pore volume data of two of the elongate ceramic (nano)particle examples of FIG. 11A (the two lower-pore volume samples, Sample #6 and Sample #7) in greater detail. Sample #6 (1C47—1100° C.) exhibits an onset of a more rapid increase in a cumulative pore volume at pore widths in a range of about 12 to about 14 nm. On the other hand, the cumulative pore volume of Sample #7(1C47—1300° C.) remains quite low (less than about 2.2×10⁻³ cm³/g) over pore widths of up to 38 nm.

FIG. 11C shows incremental pore volume data, respectively, of elongate ceramic (nano)particle examples: Sample #4 (1C47—900° C., γ-alumina only), Sample #5 (1C47—950° C., γ-alumina 95 wt. %), Sample #6 (1C47—1100° C., γ-alumina 70 wt. %), and Sample #7 (1C47—1300° C., γ-alumina 25 wt. %) Sample #4 and Sample #5 exhibit relatively large pore volumes in a pore width range of 7 to 20 nm Sample #4 (1C47—900° C., γ-alumina only) has a cumulative pore volume in a pore width range of 7 to 20 nm of 0.039 cm³/g, which is about 23% of the TPV (0.17 cm³/g) (see Table 1 of FIG. 9). Sample #5 (1C47—950° C., alumina 95 wt %) has a cumulative pore volume in a pore width range of 7 to 20 nm of 0.041 cm³/g, which is about 29% of the TPV (0.14 cm³/g) (see Table 1 of FIG. 9). On the other hand, Sample #6 (1C47—1100° C., γ-alumina 70 m. %) has a cumulative pore volume in a pore width range of 7 to 20 nm of 0.0018 cm³/g, which is about 2.9% of the TPV (0.062 cm³/g) (see Table 1 of FIG. 9). Sample #7 (1C47—1300° C., γ-alumina 25 wt. %) has a cumulative pore volume in a pore width range of 7 to 20 nm of 0.0006 cm³/g, which is about 4.6% of the TPV (0.013 cm³/g) (see Table 1 of FIG. 9).

Among the elongate ceramic (nano)particle examples of respective mass fractions of γ-alumina and α-alumina phases (Samples #4, #5, #6, and #7), Sample #5 (1C47—950° C., t-alumina 95 wt. %) exhibited the most effective Mn gettering performance (average reduction of Mn content of 83.5%), followed by Sample #4 (1C47—900° C., only γ-alumina detected, no α-alumina detected) (average reduction of Mn content of 71.6%). Sample #6 (1C47—1100° C., γ-alumina 70 wt. %, α-alumina 30 wt. %) and Sample #7 (1C47—1300° C., γ-alumina 25 wt. %, α-alumina 75 wt. %) exhibited less effective Mn gettering performance (average reduction of Mn content of 25.8%! and 17.9%, respectively). Accordingly, in some implementations, it may be preferable for a mass fraction of the γ-alumina in the elongate ceramic (nano)particles to be in a range of about 70 to about 100 wt. % (e.g., in a range of about 70 to about 95 wt. %, in a range of about 75 to about 95 wt. %, in a range of about 80 to about 95 wt. %, in a range of about 85 to about 95 wt. %, in a range of about 90 to about 95 wt. %, in a range of about 75 to about 100 wt. %, in a range of about 80 to about 100 wt. %, in a range of about 85 to about 100 wt. %, in a range of about 90 to about 100 wt. %, or in a range of about 95 to about 100 wt. %). In some implementations, it may be preferable for a mass fraction of the α-alumina in the elongate ceramic (nano)particles to be in a range of about 0 to about 30 wt. % (e.g., in a range of about 5 to about 30 wt. %, in a range of about 5 to about 25 wt. %. in a range of about 5 to about 20 wt. %. in a range of about 5 to about 15 wt. %, in a range of about 5 to about 10 wt. %, in a range of about 0 to about 25 wt. %, in a range of about 0 to about 20 wt. %, in a range of about 0 to about 15 wt. %, in a range of about 0 to about 10 wt. %, or in a range of about 0 to about 5 wt. %).

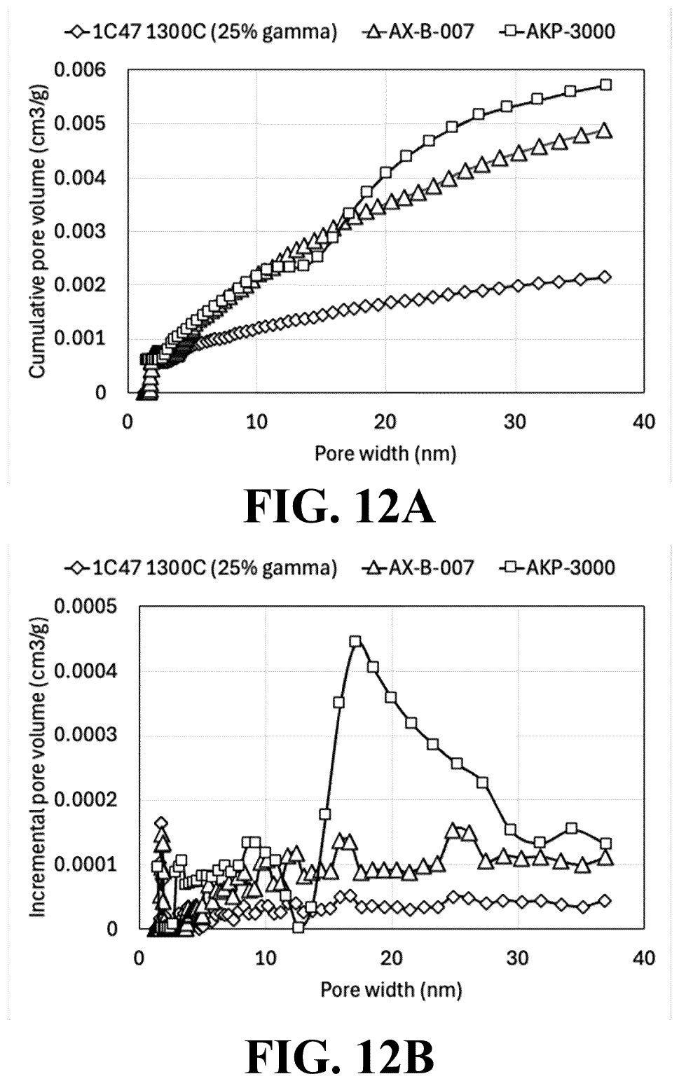

FIGS. 12A and 12B show cumulative pore volume and incremental pore volume data, respectively, of an elongate ceramic (nano)particle example (Sample #7 (1C47-1300° C., γ-alumina 25 wt. %, α-alumina 75 wt. %) and comparative examples (Sample #8 (SUMITOMO CHEMICAL AKP-3000, α-alumina only) and Sample #10 (SHANDONG AXUAN AX-B-007), boehmite). Boehmite is sometimes also referred to as aluminum oxide hydroxide (AlO(OH)). These samples were selected for comparison in FIGS. 12A and 12B because of their relatively low total pore volumes (e.g., 0.013 cm³/g for Sample #7, 0.017 cm³/g for Sample #8 and Sample #10). For each of the samples shown in FIGS. 12A and 12B, the cumulative pore volumes in pore widths of up to about 38 nm are less than 6×10⁻³ cm³/g. Samples #7, #8, and #10 exhibited less effective Mn gettering performance (average reduction of Mn content of 17.9%, 6.4%, and 7.8%, respectively). Accordingly, in some implementations, it may be preferable for a total pore volume (TPV) of the elongate ceramic (nano)particles to be in a range of about 2.0×10⁻² to about 2.5 cm³/g (e.g., in a range of about 2.0×10⁻² to 0.1 cm³/g, in a range of about 0.1 to about 0.3 cm³/g, in a range of about 0.3 to about 0.6 cm³/g, in a range of about 0.6 to about 1.0 cm³/g, in a range of about 1.0 to about 1.5 cm³/g, in a range of about 1.5 to about 2.0 cm³/g, in a range of about 2.0 to about 2.5 cm³/g, in a range of about 2.0×10⁻² to about 2.0 cm³/g, in a range of 2.0×10⁻² to about 1.0 cm³/g, in a range of 2×10⁻² to about 0.6 cm³/g, or in a range of 2.0×10⁻² to about 0.3 cm³/g). Furthermore, in some implementations, it may be preferable for a mass fraction of a boehmite phase in the elongate ceramic (nano)particles to be quite low or negligible, such as in a range of about 0 to about 10 wt. % (e.g., in a range of about 0 to 5 wt. %, in a range of about 0 to 3 wt. %, or in a range of about 0 to 1 wt. %).

FIG. 13A shows the dependence of the reduction of Mn ion concentration on a total mesopore pore volume for elongate ceramic (nano)particle examples (Sample #1 (1C48), Sample #2 (2D09), Sample #3 (1C44)) and a comparative example (Sample #9 (NANOGRAFI)). Analogous data for all samples (Samples #1 through #10) are shown in Table 1 of FIG. 9. FIG. 13A suggests that there is a positive correlation between Mn ion concentration reduction and total mesopore pore volume for the elongate ceramic (nano)particle examples. Accordingly, in some implementations, it may be preferable for a cumulative pore volume of mesopores in the elongate ceramic (nano)particles to be in a range of about 5.0×10⁻² to about 1.0 cm³/g (e.g., in a range of about 5.0×10⁻² to about 0.1 cm³/g, in a range of about 0.1 to about 0.3 cm³/g, in a range of about 0.3 to about 0.5 cm³/g, in a range of about 5.0×10⁻² to about 0.3 cm³/g, in a range of about 5.0×10⁻² to about 0.5 cm³/g, or in a range of about 0.5 to about 1.0 cm³/g).

FIG. 13B shows the dependence of the reduction of Mn ion concentration on total micropore pore volume for elongate ceramic (nano)particle examples (Sample #1 (1C48), Sample #2 (2D09), Sample #3 (1C44)) and a comparative example (Sample #9 (NTANOGRAFI)). Analogous data for all samples (Samples #1 through #10) are shown in Table 1 of FIG. 9. FIG. 13B suggests that there is a positive correlation between Mn ion concentration reduction and total micropore pore volume for the elongate ceramic (nano)particle examples. Accordingly, in some implementations, it may be preferable for a cumulative pore volume of micropores in the elongate ceramic (nano)particles to be in a range of about 1×10⁻³ to about 2×10⁻² cm³/g (e.g., in a range of about 1×10⁻³ to about 2×10⁻³ cm³/g, in a range of about 2×10⁻³ to about 1×10⁻² cm³/g, or in a range of about 1×10⁻² to about 2×10⁻² cm³/g).

FIG. 13C shows the dependence of the reduction of Mn ion concentration on total macropore pore volume, for elongate ceramic (nano)particle examples (Sample #1 (1C48), Sample #2 (2D09), Sample #3 (1C44)) and a comparative example (Sample #9 (NANOGRAFI)). Analogous data for all samples (Samples #1 through #10) are shown in Table 1 of FIG. 9. In some implementations, it may be preferable for a cumulative pore volume of macropores in the elongate ceramic (nano)particles to be in a range of about 2.0×10⁻² to about 0.5 cm³/g (e.g., in a range of about 2.0×10⁻² to about 0.4 cm³/g, in a range of about 2.0×10⁻² to about 0.3 cm³/g, in a range of about 2.0×10⁻² to about 0.2 cm³/g, in a range of about 0.2 to about 0.3 cm³/g, in a range of about 0.3 to about 0.4 cm³/g, or in a range of about 0.4 to about 0.5 cm³/g).

The BET-SSA values of all samples (Samples #1 through #10) are shown in Table 1 (column 4) of FIG. 9. The samples that exhibited more effective Mn gettering performance (e.g., average reduction of Mn content of at least 26%) also exhibited relatively high BET-SSA values: Sample #2 (2D09) exhibited a BET-SSA of 103 m²/g and an average Mn reduction of 27.9%; Sample #3 (1C44) exhibited a BET-SSA of 177 m²/g and an average Mn reduction of 39.9%; Sample #4 (1C47—900° C.) exhibited a BET-SSA of 56.7 m²/g and an average Mn reduction of 71.6%; Sample #5(1C47—950° C.) exhibited a BET-SSA of 45.1 m²/g and an average Mn reduction of 83.5%; and Sample #9 (NANOGRAFI) exhibited a BET-SSA of 158.4 m²/g and an average Mn reduction of 29%. Accordingly, in some implementations, it may be preferable for the BET-SSA values of the elongate ceramic (nano)particles to be in a range of about 30 to about 600 m²/g (e.g., in a range of about 30 to about 60 m²/g, in a range of about 60 to about 100 m²/g, in a range of about 100 to about 150 m²/g, in a range of about 150 to about 200 m²/g, in a range of about 200 to about 300 m²/g, in a range of about 300 to about 400 m²/g, in a range of about 400 to about 500 m²/g, in a range of about 500 to about 600 m²/g, in a range of about 30 to about 200 m²/g, in a range of about 30 to about 150 m²/g, or in a range of about 30 to about 100 m²/g).

The cumulative pore volumes in a pore width range of 7 to 20 nm of all samples (Samples #1 through #10) are shown in Table 1 (column 14) of FIG. 9. The samples that exhibited more effective Mn gettering performance (e.g., average reduction of Mn content of at least 26%) also exhibited relatively high cumulative pore volumes in a pore width range of 7 to 20 nm: Sample #2 (2D09) exhibited a cumulative pore volume in a pore width range of 7 to 20 nm of 0.13 cm³/g and an average Mn reduction of 27.9%; Sample #3 (1C44) exhibited a cumulative pore volume in a pore width range of 7 to 20 nm of 0.3 cm³/g and an average Mn reduction of 39.9%; Sample #4 (1C47—900° C.) exhibited a cumulative pore volume in a pore width range of 7 to 20 nm of 0.039 cm³/g and an average Mn reduction of 71.6%; Sample #5 (1C47—950° exhibited a cumulative pore volume in a pore width range of 7 to 20 nm of 0.041 cm³/g and an average Mn reduction of 83.5%; and Sample #9 (NANOGRAFI) exhibited a cumulative pore volume in a pore width range of 7 to 20 nm of 0.29 cm³/g and an average Mn reduction of 29%. Accordingly, in some implementations, it may be preferable for the cumulative pore volume in a pore width range of 7 to 20 nm of the elongate ceramic (nano)particles to be in a range of about 1.0×10⁻² to about 1.0 cm³/g (e.g., in a range of about 1.0×10⁻² to about 3.0×10⁻² cm³/g, in a range of about 3.0×10⁻² to about 0.5 cm³/g, in a range of about 3.0×10⁻² to about 0.4 cm³/g, in a range of about 3×10⁻² to about 0.3 cm³/g, in a range of about 3.0×10⁻² to about 0.2 cm³/g, in a range of about 0.5 to about 1.0 cm³/g, in a range of about 0.4 to about 1.0 cm³/g, in a range of about 0.3 to about 1.0 cm³, in a range of about 0.2 to about 1.0 cm³/g, in a range of about 1.0×10⁻² to about 0.5 cm³/g, in a range of about 1.0×10⁻² to about 0.4 cm³/g, in a range of about 1.0×10⁻² to about 0.3 cm³/g, or in a range of about 1.0×10⁻² to about 0.2 cm³/g).

A specific volume fraction may be calculated by dividing a cumulative pore volume of the elongate ceramic (nano)particles in a pore width range of 7 to 20 nm, by a total pore volume (TPV) of the elongate ceramic (nano)particles. The specific volume fractions of all samples (Samples #1 through #10) are shown in Table 1 (column 15) of FIG. 9. The samples that exhibited more effective Mn gettering performance (e.g., average reduction of Mn content of at least 26%) also exhibited relatively high specific volume fractions: Sample #2 (2D09) exhibited a specific volume fraction of 46.4% and an average Mn reduction of 27.9) %; Sample #3 (1C44) exhibited a specific volume fraction of 58.8% and an average Mn reduction of 39.9%; Sample #4 (1C47-900° C.) exhibited a specific volume fraction of 22.9% and an average Mn reduction of 71.6%; Sample #5 (1C47—950° C.) exhibited a specific volume fraction of 29.3% and an average Mn reduction of 83.5%; and Sample #9 (NANOGRAFI) exhibited a specific volume fraction of 24.6% and an average Mn reduction of 29%. Accordingly, in some implementations, it may be preferable for the specific volume fraction (cumulative pore volume of the elongate ceramic (nano)particles in a pore width range of 7 to 20 nm, divided by a total pore volume (TPV) of the elongate ceramic (nano)particles) to be in a range of about 15 to about 65% (e.g., in a range of about 15 to about 20%, in a range of about 20 to about 30%, in a range of about 30 to about 40%, in a range of about 40 to about 60%, in a range of about 60 to about 65%, in a range of about 20 to about 40%, or in a range of about 20 to about 60%).

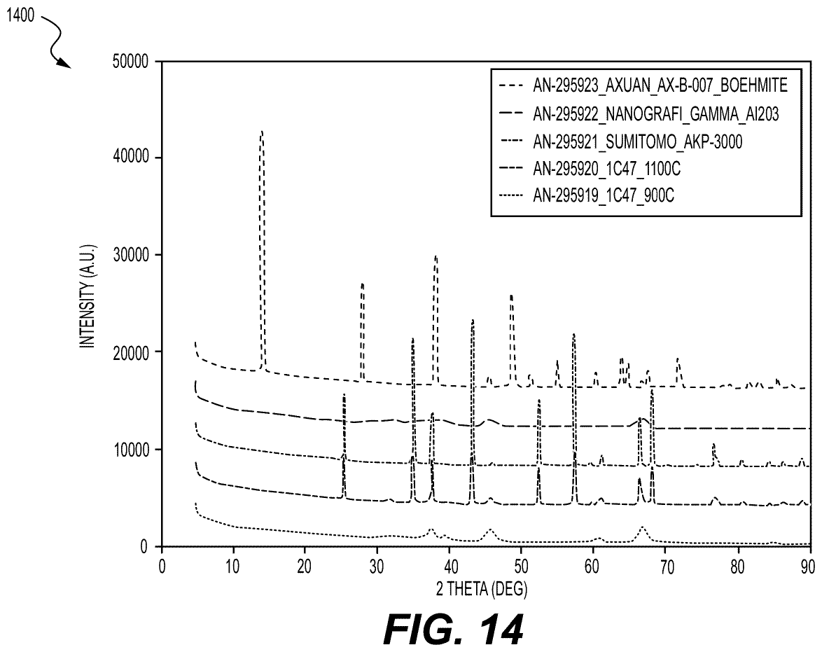

FIG. 14 shows x-ray diffraction data of elongate ceramic (nano)particle examples and comparative examples (from top to bottom: Sample #10 (SHANDONG AXUAN AX-B-007), Sample #9 (NANOGRAFI Alumina), Sample #8 (SUMITOMO CHEMICAL AKP-3000), Sample #6 (1C47—1100° C.), and Sample #4 (1C47—900° C.). X-ray diffraction (XRD) was used to quantify the weight (mass) fraction of α-Al₂O₃ and γ-Al₂O₃ in mixed-phase samples. XRD data was collected with a Rigaku SmartLab diffractometer equipped with a Cu source using Bragg-Brentano geometry illumination and a Ni foil Kp filter. Out-of-plane divergence was limited by two (incident and receiving) 5-degree Soller slits and a 10 mm height-limiting slit. Collimation within the diffraction plane was achieved using incident slits set to ⅔ degrees and both sets of receiving slits set to 20 mm. XRD patterns were collected in the 20 range of 40-50° at intervals of 0.02° and at a scan speed of 3.0°/min (0.4 s dwell per interval). The α:γ phase ratio was determined for each sample by comparison to a calibration curve developed from samples of known α-Al₂O₃ and γ-Al₂O₃ weight fractions achieved by physically mixing pure ca-Al₂O₃ and γ-Al₂O₃ samples produced from our synthesis method. The area of the (113) α-Al₂O₃ reflection at 2θ ≈43.4 degrees (calculated by integrating a two Gaussian-Lorentzian function fit to the combined K_{α1} and K_{α2} signals) was selected as the calibration signal, as it was not convoluted with any γ-Al₂O₃ signals. In contrast, there were no suitable γ-Al₂O₃ peaks (for use as an internal standard for ratio determination) that did not significantly overlap with an α-Al₂O₃ signal. To account for any source intensity drift that may have occurred over time, all measurements were normalized by the peak intensity of the (113) reflection of a known pure α-Al₂O₃ sample at the beginning of each measurement session.

Lithium-ion batteries may be made using a separator that comprises elongate ceramic (nano)particles that are effective in gettering transition metal ions (e.g., Ni ions, Mn ions, Co ions, Fe ions). In some examples, elongate ceramic (nano)particles that are effective in gettering Mn ions may be employed. In some examples, elongate ceramic (nano)particles that exhibit a reduction in Mn ion concentration of about 26% or greater (according to the measurement protocols as described herein, see Table 1 of FIG. 9 for measurement results) may be employed (e.g., about 26% or greater; about 28% or greater; about 30% or greater; about 35% or greater; about 40% or greater; about 50% or greater; about 60% or greater; about 70% or greater; about 80% or greater; about 90% or greater; about 95% or greater; about 97% or greater; about 98% or greater; about 99% or greater; or about 99.9% or greater). The separator may be implemented as a standalone separator (e.g., a separator coating on a polymer membrane or type 1 cells) or as a separator coating in an integrated electrode-separator component (e.g., type 4 cells). Example cathode active materials include those materials that comprise certain transition metals (e.g., Ni, Mn, Co, Fe). Example cathode active materials include: (1) LiNiₓMn_{y}Co_{z}O₂, a sum of x, y, and z being about 1 and at least one of x, y, and z being greater than 0; (2) Li₁₊ₚMn₂₋ₚO₄, p being greater than or equal to 0 and p being less than 2; (3) LiNi_{q}Mn_{2-q}O₄, q being greater than or equal to 0 and q being less than 2; and (4) LiFe₁₋ᵣMnᵣPO₄, r being greater than or equal to 0 and r being less than or equal to 1. In such a lithium-ion battery, there may be dissolution of at least transition metal (e.g., Ni, Mn, Co, Fe) and formation of transition metal ions (e.g., Ni ions, Mn ions, Co ions, Fe) in the electrolyte. The dissolution of transition metals and formation of transition metal ions may be observed at any time after the electrolyte contacts cathode, including during and/or after formation cycling, during and/or after (long-term) cycling, and during and/or after calendar aging. Because of the effectiveness of the example separators in gettering transition metal ions, it is expected that there would be a gradient in a concentration of transition metal ions, with the concentration being higher near the cathode (e.g., cathode side of the separator) and lower near the anode (e.g., anode side of the separator). After undergoing formation cycling, (long-term) cycling, or calendar (storage) aging, lithium-ion battery test cells may exhibit a gradient in a concentration of at least one transition metal across the cell stack (e.g., from the cathode, across the separator, to the anode). In some examples, the concentration may be measured by cross-sectional scanning electron microscopy (SEM) with energy dispersive X-ray (EDX) analysis. The transition metal concentration is highest in the cathode, the concentration being governed primarily by the mass fraction of the transition metal in the cathode active material. The transition metal concentration is lowest in the anode (e.g., less than 1 at. % of the anode composition). In addition, the region at an interface between the cathode and the separator (cathode-separator interface) may exhibit a higher transition metal concentration than the region at an interface between the anode and the separator (anode-separator interface). The gradient of the transition metal concentration may be such that the concentration at the cathode-separator interface is lower than the concentration in the cathode; the concentration in the anode-separator interface is lower than the concentration in the cathode-separator interface; and the concentration in the anode is lower than in the anode-separator interface. The atomic fraction of transition metals in the cathode-separator interface may be about 5 at. % or less, and the atomic fraction of transition metals in the anode-separator interface may be about 1 at. % or less.). In some implementations, this gradient may be observed at any time after formation cycling, after any number of charge-discharge cycles according to a standard (long-term) cycling protocol. The gradient may become more pronounced as the lithium-ion battery test cell undergoes more charge-discharge cycles. In some implementations, this gradient may be observed after at least 300 full charge-discharge cycles (full charge-discharge cycles are carried out between a bottom of charge (e.g., 2.5 V) and a top of charge (e.g., 4.2 V)). In some implementations, this gradient may be observed after storage at a temperature that is high enough to accelerate dissolution of transition metal ions from the cathode active material. For example, this gradient may be observed after storage, in a fully charged state (also referred to as 100% state-of-charge (SOC) or at top of charge) at a temperature of about 60° C. for at least 30 days. In lithium-ion batteries comprising a separator that is not effective in gettering the transition metal(s), there may be a relatively high concentration of the transition metal ions in the cathode, a relatively high concentration of the transition metal(s) that have deposited on the anode, and a lower concentration of the transition metal(s) that bind to the separator. Accordingly, a lithium-ion battery comprising a separator that is not effective in gettering the transition metal(s) may not exhibit a gradient concentration; instead, it may exhibit a bimodal concentration of the transition metal(s).

In yet other aspects, the capacity of an alumina-comprising separator to getter the transition metal ions may be governed, in part, by the relative amounts (e.g., relative number of atoms) of Al and the at least one transition metal (e.g., Ni, Mn, Co, Fe). In some examples, the relative amounts of Al and the at least one transition metal may be estimated using SEM-EDX. After undergoing formation cycling, (long-term) cycling, or calendar (storage) aging, the atomic ratio of Al to the at least one transition metal (e.g., Ni, Mn, Co, Fe) in the separator may be in a range of about 1:1 to about 1:10 (e.g., about 1:1 to about 2:1; about 2:1 to about 4:1; about 4:1 to about 10:1; or about 1:1 to about 4:1). Such a measurement may be carried out by taking the separator out of the test cell and washing away the electrolyte from the separator. After undergoing standard (long-term) cycling or standard calendar (storage) aging, the atomic ratio of Al to the at least one transition metal (e.g., Ni, Mn, Co, Fe) in the separator may be in a range of about 1:1 to about 1:10 (e.g., about 1:1 to about 2:1; about 2:1 to about 4:1; about 4:1 to about 10:1; or about 1:1 to about 4:1). For example, an atomic ratio of 4:1 means that there are 4 atoms of the Al to 1 atom of the at least one transition metal. In some implementations, these atomic ratio ranges may be observed at any time after formation cycling, after any number of charge-discharge cycles according to a standard (long-term) cycling protocol. In some implementations, these atomic ratio ranges may be observed after at least 300 or more full charge-discharge cycles (full charge-discharge cycles are carried out between a bottom of charge (e.g., 2.5 V) and a top of charge (e.g., 4.2 V)). In some implementations, these atomic ratio ranges may be observed after storage at a temperature that is high enough to accelerate dissolution of transition metal ions from the cathode active material. For example, these atomic ratio ranges may be observed after storage, in a fully charged state (also referred to as 100% state-of-charge (SOC) or at top of charge) at a temperature of about 60° C. for at least 30 days. In lithium-ion batteries comprising a separator that is not effective in gettering transition metals, there may be a relatively low concentration of the transition metals in the separator (e.g., low relative to the concentration of Al in the separator).

In some designs, the surface of the ceramic particles (e.g., elongate ceramic particles, such as porous elongate ceramic particles or porous elongate ceramic (nano)particles) may be functionalized in order to enhance their ability to trap (getter) transition metals (e.g., transition metal ions). In some implementations, nitrogen-comprising functional groups may be incorporated onto the surfaces of such particles. In some implementations, amines (e.g., amine-comprising functional groups) may be attached (e.g., decorated) onto the surfaces of such ceramic particles. The elongate ceramic particles may comprise amine-comprising functional groups on their surfaces. A separator coating may comprise amine-comprising functional groups. In some implementations, polymer binders in a separator coating (ceramic layer) may comprise an amine or amine-comprising functional groups. In some implementations, polymer fibers in the separator (layer) (e.g., (1) within the ceramic layer, and/or (2) outside of the ceramic layer, in a polymer membrane that supports the ceramic layer)) may comprise an amine or amine-comprising functional groups. In some implementations, the separator coating may contain SiOₓ, MgO, BaSO₄, TiO₂, ZrO₂, and/or SnO₂ particles (which may in some designs comprise (nano)particles of various shapes and sizes) dispersed among the elongate ceramic particles or infiltrated into the elongate ceramic particles or coated on the surface of the elongate ceramic particles. In some designs, such material(s) may be incorporated in the form of the coating(s) rather than individual particles of various shapes and sizes.

Battery cell modules or battery cell packs may advantageously comprise cells with anode electrodes, cathode electrodes, separators and/or electrolyte compositions provided in this disclosure. Such cell modules or packs may offer improved performance characteristics, simplified designs, better safety features, and/or lower cost.

By way of example, the disclosed herein batteries can be advantageously used in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, air taxi, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500 batteries of the present disclosure. Batteries in multi-cell batteries may be arranged in parallel or in series.

In the detailed description above, it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause is not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. Elongate ceramic particles, comprising: γ-alumina, wherein: a mass fraction of the γ-alumina in the elongate ceramic particles is in a range of about 70 to about 100 wt. %; a Brunauer-Emmett-Teller specific surface area (BET-SSA) of the elongate ceramic particles is in a range of about 30 to about 400 m²/g; an average aspect ratio of the elongate ceramic particles is at least about 3; and a cumulative pore volume of the elongate ceramic particles in a pore width range of 7 to 20 nm is in a range of about 1.0×10⁻² to about 1.0 cm³/g.

Clause 2. The elongate ceramic particles of clause 1, wherein: the mass fraction is in a range of about 80 to about 100 wt. %.

Clause 3. The elongate ceramic particles of clause 2, wherein: the mass fraction is in a range of about 90 to about 100 wt. %.

Clause 4. The elongate ceramic particles of any of clauses 1 to 3, wherein: the cumulative pore volume of the elongate ceramic particles in the pore width range of 7 to 20 nm is in a range of about 3.0×10⁻² to about 0.5 cm³/g.

Clause 5. The elongate ceramic particles of any of clauses 1 to 4, wherein: a cumulative pore volume of micropores in the elongate ceramic particles is in a range of about 1.0×10⁻³ to about 2.0×10⁻² cm³/g.

Clause 6. The elongate ceramic particles of any of clauses 1 to 5, wherein: a cumulative pore volume of mesopores in the elongate ceramic particles is in a range of about 5.0×10⁻² to about 1.0 cm³/g.

Clause 7. The elongate ceramic particles of any of clauses 1 to 6, wherein: a cumulative pore volume of macropores in the elongate ceramic particles is in a range of about 2.0×10⁻² to about 0.5 cm³/g.

Clause 8. The elongate ceramic particles of any of clauses 1 to 7, wherein: an average length of the elongate ceramic particles is in a range of about 2 to about 50 μm.

Clause 9. The elongate ceramic particles of any of clauses 1 to 8, wherein: a total pore volume (TPV) of the elongate ceramic particles is in a range of about 2.0×10⁻² to about 2.0 cm³/g.

Clause 10. The elongate ceramic particles of any of clauses 1 to 9, wherein: the cumulative pore volume of the elongate ceramic particles in the pore width range of 7 to 20 nm, divided by a total pore volume (TPV) of the elongate ceramic particles, is in a range of about 15 to about 65%.

Clause 11. The elongate ceramic particles of any of clauses 1 to 10, wherein: the elongate ceramic particles comprise one or more amine-comprising functional groups at one or more respective surfaces.

Clause 12. A separator, comprising: a polymer membrane; and a separator coating disposed on the polymer membrane comprising the elongate ceramic particles of any of clauses 1 to 11, wherein: a thickness of the separator coating is in a range of about 1.0 to about 20.0 μm.

Clause 13. The separator of clause 12, wherein: the thickness is in a range of about 1.0 to about 3.0 μm.

Clause 14. The separator of clause 13, wherein: the thickness is in a range of about 1.2 to about 1.8 μm.

Clause 15. The separator of any of clauses 12 to 14, wherein: the separator coating comprises one or more amine-comprising functional groups.

Clause 16. A lithium-ion battery, comprising: an anode comprising an anode active material; a cathode comprising a cathode active material comprising at least one transition metal selected from the group consisting of Ni, Mn, Co, and Fe; an electrolyte ionically coupling the anode and the cathode; and the separator of any of clauses 12 to 15 disposed in a space between the anode and the cathode.

Clause 17. The lithium-ion battery of clause 16, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Clause 18. The lithium-ion battery of any of clauses 16 to 17, wherein: the anode active material comprises graphite particles.

Clause 19. The lithium-ion battery of any of clauses 16 to 18, wherein: the anode active material comprises composite particles, each of the composite particles comprising carbon and silicon.

Clause 20. The lithium-ion battery of any of clauses 16 to 19, wherein: the anode active material comprises a mixture of graphite particles and composite particles that are separate from the graphite particles, each of the composite particles comprising carbon and silicon.

Clause 21. The lithium-ion battery of any of clauses 16 to 20, wherein: the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator to the anode, the concentration being highest in the cathode.

Clause 22. The lithium-ion battery of any of clauses 16 to 21, wherein: the separator exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

Clause 23. An integrated electrode-separator component, comprising: an electrode coating disposed on and/or in a current collector and comprising electrode active material; and a separator coating disposed on the electrode coating comprising the elongate ceramic particles of any of clauses 1 to 11, wherein: a thickness of the separator coating is in a range of about 1.0 to about 20.0 μm.

Clause 24. The integrated electrode-separator component of clause 23, wherein: the thickness is in a range of about 1.0 to about 10.0 μm.

Clause 25. The integrated electrode-separator component of clause 24, wherein: the thickness is in a range of about 1.0 to about 5.0 μm.

Clause 26. The integrated electrode-separator component of clause 25, wherein: the thickness is in a range of about 1.0 to about 3.0 μm.

Clause 27. The integrated electrode-separator component of any of clauses 23 to 26, wherein: the separator coating comprises one or more amine-comprising functional groups.

Clause 28. The integrated electrode-separator component of any of clauses 23 to 27, wherein: the electrode coating comprises a cathode active material comprising at least one transition metal selected from the group consisting of Ni, Mn, Co, and Fe.

Clause 29. The integrated electrode-separator component of clause 28, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Clause 30. A lithium-ion battery, comprising: the integrated electrode-separator component of any of clauses 28 to 29, the electrode coating thereof being configured as a cathode of the lithium-ion battery; an anode in contact with and facing toward the separator coating of the integrated electrode-separator component, the anode comprising an anode active material; and an electrolyte ionically coupling the cathode and the anode.

Clause 31. The lithium-ion battery of clause 30, wherein: the anode active material comprises graphite particles.

Clause 32. The lithium-ion battery of any of clauses 30 to 31, wherein: the anode active material comprises composite particles, each of the composite particles comprising carbon and silicon.

Clause 33. The lithium-ion battery of any of clauses 30 to 32, wherein: the anode active material comprises a mixture of graphite particles and composite particles that are separate from the graphite particles, each of the composite particles comprising carbon and silicon.

Clause 34. The lithium-ion battery of any of clauses 30 to 33, wherein: the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator coating to the anode, the concentration being highest in the cathode.

Clause 35. The lithium-ion battery of any of clauses 30 to 34, wherein: the separator coating exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

Clause 36. The integrated electrode-separator component of any of clauses 23 to 35, wherein: the electrode coating comprises an anode active material.

Clause 37. The integrated electrode-separator component of clause 36, wherein: the anode active material comprises graphite particles.

Clause 38. The integrated electrode-separator component of any of clauses 36 to 37, wherein: the anode active material comprises composite particles, each of the composite particles comprising carbon and silicon.

Clause 39. The integrated electrode-separator component of any of clauses 36 to 38, wherein: the anode active material comprises a mixture of graphite particles and composite particles that are separate from the graphite particles, each of the composite particles comprising carbon and silicon.

Clause 40. A lithium-ion battery, comprising: the integrated electrode-separator component of any of clauses 36 to 39, the electrode coating thereof being configured as an anode of the lithium-ion battery; a cathode in contact with and facing toward the separator coating of the integrated electrode-separator component; and an electrolyte ionically coupling the cathode and the anode, wherein: the cathode comprises a cathode active material comprising at least one transition metal selected from the group consisting of Ni, Mn, Co, and Fe.

Clause 41. The lithium-ion battery of clause 40, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Clause 42. The lithium-ion battery of any of clauses 40 to 41, wherein: the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator coating to the anode, the concentration being highest in the cathode.

Clause 43. The lithium-ion battery of any of clauses 40 to 42, wherein: the separator coating exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

Clause 44. A lithium-ion battery, comprising: a first instantiation and a second instantiation of the integrated electrode-separator component of any of clauses 23 to 29, the electrode coating of the first instantiation being configured as an anode of the lithium-ion battery, the electrode coating of the second instantiation being configured as a cathode of the lithium-ion battery; the separator coating of the first instantiation and the separator coating of the second instantiation being in contact with each other and facing toward each other, constituting at least part of a separator; and an electrolyte ionically coupling the cathode and the anode, wherein: the anode comprises an anode active material; and the cathode comprises a cathode active material comprising at least one transition metal selected from the group consisting of Ni, Mn, Co, and Fe.

Clause 45. The lithium-ion battery of clause 44, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Clause 46. The lithium-ion battery of any of clauses 44 to 45, wherein: the anode active material comprises graphite particles.

Clause 47. The lithium-ion battery of any of clauses 44 to 46, wherein: the anode active material comprises composite particles, each of the composite particles comprising carbon and silicon.

Clause 48. The lithium-ion battery of any of clauses 44 to 47, wherein: the anode active material comprises a mixture of graphite particles and composite particles that are separate from the graphite particles, each of the composite particles comprising carbon and silicon.

Clause 49. The lithium-ion battery of any of clauses 44 to 48, wherein: the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator to the anode, the concentration being highest in the cathode.

Clause 50. The lithium-ion battery of any of clauses 44 to 49, wherein: the separator exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

Clause 51. A method comprising: providing a polymer membrane; coating a dispersion comprising elongate ceramic particles comprising γ-alumina on the polymer membrane to form a separator coating on the polymer membrane, a separator comprising the polymer membrane and the separator coating disposed on the polymer membrane, wherein: a mass fraction of the γ-alumina in the elongate ceramic particles is in a range of about 70 to about 100 wt. %; a Brunauer-Emmett-Teller specific surface area (BET-SSA) of the elongate ceramic particles is in a range of about 30 to about 400 m²/g; an average aspect ratio of the elongate ceramic particles is at least about 3; and a cumulative pore volume of the elongate ceramic particles in a pore width range of 7 to 20 nm is in a range of about 1.0×10⁻² to about 1.0 cm³/g.

Clause 52. The method of clause 51, wherein: the mass fraction is in a range of about 80 to about 100 wt. %.

Clause 53. The method of clause 52, wherein: the mass fraction is in a range of about 90 to about 100 wt. %.

Clause 54. The method of any of clauses 51 to 53, wherein: the cumulative pore volume of the elongate ceramic particles in the pore width range of 7 to 20 nm is in a range of about 3.0×10⁻² to 0.5 cm³/g.

Clause 55. The method of any of clauses 51 to 54, wherein: a cumulative pore volume of micropores in the elongate ceramic particles is in a range of about 1.0×10⁻³ to about 2.0×10⁻² cm³/g.

Clause 56. The method of any of clauses 51 to 55, wherein: a cumulative pore volume of mesopores in the elongate ceramic particles is in a range of about 5.0×10⁻² to about 1.0 cm³/g.

Clause 57. The method of any of clauses 51 to 56, wherein: a cumulative pore volume of macropores in the elongate ceramic particles is in a range of about 2.0×10⁻² to about 0.5 cm³/g.

Clause 58. The method of any of clauses 51 to 57, wherein: an average length of the elongate ceramic particles is in a range of about 2 to about 50 μm.

Clause 59. The method of any of clauses 51 to 58, wherein: a total pore volume (TPV) of the elongate ceramic particles is in a range of about 2.0×10⁻² to about 2.0 cm³/g.

Clause 60. The method of any of clauses 51 to 59, wherein: the cumulative pore volume of the elongate ceramic particles in the pore width range of 7 to 20 nm, divided by a total pore volume (TPV) of the elongate ceramic particles, is in a range of about 15 to about 65%.

Clause 61. The method of any of clauses 51 to 60, wherein: the elongate ceramic particles comprise one or more amine-comprising functional groups at one or more respective surfaces.

Clause 62. The method of any of clauses 51 to 61, wherein: a thickness of the separator coating is in a range of about 1.0 to about 20.0 μm.

Clause 63. The method of clause 62, wherein: the thickness is in a range of about 1.0 to about 3.0 μm.

Clause 64. The method of clause 63, wherein: the thickness is in a range of about 1.2 to about 1.8 μm.

Clause 65. The method of any of clauses 51 to 64, wherein: the separator coating comprises one or more amine-comprising functional groups.

Clause 66. The method of any of clauses 51 to 65, further comprising: assembling a lithium-ion battery from at least an anode, a cathode comprising a cathode active material comprising at least one transition metal selected from the group consisting of Ni, Mn, Co, and Fe, an electrolyte ionically coupling the anode and the cathode, and the separator disposed in a space between the anode and the cathode.

Clause 67. The method of clause 66, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Clause 68. The method of any of clauses 66 to 67, wherein: the anode comprises graphite particles.

Clause 69. The method of any of clauses 66 to 68, wherein: the anode comprises composite particles, each of the composite particles comprising carbon and silicon.

Clause 70. The method of any of clauses 66 to 69, wherein: the anode comprises a mixture of graphite particles and composite particles that are separate from the graphite particles, each of the composite particles comprising carbon and silicon.

Clause 71. The method of any of clauses 66 to 70, further comprising: carrying out cycling of at least 300 full charge-discharge cycles on the lithium-ion battery or storing the lithium-ion battery in a fully charged state at a temperature of about 60° C. for at least 30 days, wherein: the lithium-ion battery, after the cycling or the storage, exhibits a gradient in a concentration of the at least one transition metal from the cathode across the separator to the anode, the concentration being highest in the cathode.

Clause 72. The method of any of clauses 66 to 71, additionally comprising: carrying out cycling of at least 300 full charge-discharge cycles on the lithium-ion battery or storing the lithium-ion battery in a fully charged state at a temperature of about 60° C. for at least 30 days, wherein: the separator exhibits an atomic ratio of Al to the at least one transition metal in a range of about 1:1 to about 4:1 after the cycling or the storage of the lithium-ion battery.

Clause 73. A method, comprising: providing an electrode coating disposed on a current collector and comprising electrode active material; and coating a dispersion comprising elongate ceramic particles comprising γ-alumina on the electrode coating to form a separator coating on the electrode coating, an integrated electrode-separator component comprising the electrode coating disposed on the current collector and the separator coating disposed on the electrode coating, wherein: a mass fraction of the γ-alumina in the elongate ceramic particles is in a range of about 70 to about 100 wt. %; a Brunauer-Emmett-Teller specific surface area (BET-SSA) of the elongate ceramic particles is in a range of about 30 to about 400 m²/g; an average aspect ratio of the elongate ceramic particles is at least about 3; and a cumulative pore volume of the elongate ceramic particles in a pore width range of 7 to 20 nm is in a range of about 1.0×10⁻² to about 1.0 cm³/g.

Clause 74. The method of clause 73, wherein: the mass fraction is in a range of about 80 to about 100 wt. %.

Clause 75. The method of clause 74, wherein: the mass fraction is in a range of about 90 to about 100 wt. %.

Clause 76. The method of any of clauses 73 to 75, wherein: the cumulative pore volume of the elongate ceramic particles in the pore width range of 7 to 20 nm is in a range of about 3.0×10⁻² to about 0.5 cm³/g.

Clause 77. The method of any of clauses 73 to 76, wherein: a cumulative pore volume of micropores in the elongate ceramic particles is in a range of about 1.0×10⁻³ to about 2.0×10⁻² cm³/g.

Clause 78. The method of any of clauses 73 to 77, wherein: a cumulative pore volume of mesopores in the elongate ceramic particles is in a range of 5.0×10⁻² to 1.0 cm³/g.

Clause 79. The method of any of clauses 73 to 78, wherein: a cumulative pore volume of macropores in the elongate ceramic particles is in a range of about 2.0×10⁻² to about 0.5 cm³/g.

Clause 80. The method of any of clauses 73 to 79, wherein: an average length of the elongate ceramic particles is in a range of about 2 to about 50 μm.

Clause 81. The method of any of clauses 73 to 80, wherein: a total pore volume (TPV) of the elongate ceramic particles is about 2.0×about 10⁻² to 2.0 cm³/g.

Clause 82. The method of any of clauses 73 to 81, wherein: the cumulative pore volume of the elongate ceramic particles in the pore width range of 7 to 20 nm, divided by a total pore volume (TPV) of the elongate ceramic particles, is in a range of about 15 to about 65%.

Clause 83. The method of any of clauses 73 to 82, wherein: the elongate ceramic particles comprise one or more amine-comprising functional groups at one or more respective surfaces.

Clause 84. The method of any of clauses 73 to 83, wherein: a thickness of the separator coating is in a range of about 1.0 to about 20.0 μm.

Clause 85. The method of clause 84, wherein: the thickness is in a range of about 1.0 to about 10.0 μm.

Clause 86. The method of clause 85, wherein: the thickness is in a range of about 1.0 to about 5.0 μm.

Clause 87. The method of clause 86, wherein: the thickness is in a range of about 1.0 to about 3.0 μm.

Clause 88. The method of any of clauses 73 to 87, wherein: the separator coating comprises one or more amine-comprising functional groups.

Clause 89. The method of any of clauses 73 to 88, wherein: the electrode coating comprises a cathode active material comprising at least one transition metal selected from the group consisting of Ni, Mn, Co, and Fe.

Clause 90. The method of clause 89, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Clause 91. The method of any of clauses 89 to 90, further comprising: assembling a lithium-ion battery from at least the integrated electrode-separator component, the electrode coating thereof being configured as a cathode of the lithium-ion battery, an anode in contact with and facing toward the separator coating of the integrated electrode-separator component, and an electrolyte ionically coupling the cathode and the anode.

Clause 92. The method of clause 91, wherein: the anode comprises graphite particles.

Clause 93. The method of any of clauses 91 to 92, wherein: the anode comprises composite particles, each of the composite particles comprising carbon and silicon.

Clause 94. The method of any of clauses 91 to 93, wherein: the anode comprises a mixture of graphite particles and composite particles that are separate from the graphite particles, each of the composite particles comprising carbon and silicon.

Clause 95. The method of any of clauses 91 to 94, further comprising: carrying out cycling of at least 300 full charge-discharge cycles on the lithium-ion battery or storing the lithium-ion battery in a fully charged state at a temperature of about 60° C. for at least 30 days, wherein: the lithium-ion battery, after the cycling or the storage, exhibits a gradient in a concentration of the at least one transition metal from the cathode across the separator coating to the anode, the concentration being highest in the cathode.

Clause 96. The method of any of clauses 91 to 95, further comprising: carrying out cycling of at least 300 full charge-discharge cycles on the lithium-ion battery or storing the lithium-ion battery in a fully charged state at a temperature of about 60° C. for at least 30 days, wherein: the separator coating exhibits an atomic ratio of Al to the at least one transition metal in a range of about 1:1 to about 4:1 after the cycling or the storage of the lithium-ion battery.

Clause 97. The method of any of clauses 73 to 96, wherein: the electrode coating comprises an anode active material.

Clause 98. The method of clause 97, wherein: the anode active material comprises graphite particles.

Clause 99. The method of any of clauses 97 to 98, wherein: the anode active material comprises composite particles, each of the composite particles comprising carbon and silicon.

Clause 100. The method of any of clauses 97 to 99, wherein: the anode active material comprises a mixture of graphite particles and composite particles that are separate from the graphite particles, each of the composite particles comprising carbon and silicon.

Clause 101. The method of any of clauses 73 to 100, further comprising: assembling a lithium-ion battery from at least the integrated electrode-separator component, the electrode coating thereof being configured as an anode of the lithium-ion battery, a cathode in contact with and facing toward the separator coating of the integrated electrode-separator component, and an electrolyte ionically coupling the cathode and the anode, wherein: the cathode comprises a cathode active material comprising at least one transition metal selected from the group consisting of Ni, Mn, Co, and Fe.

Clause 102. The method of clause 101, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Clause 103. The method of any of clauses 101 to 102, further comprising: carrying out cycling of at least 300 full charge-discharge cycles on the lithium-ion battery or storing the lithium-ion battery in a fully charged state at a temperature of about 60° C. for at least 30 days, wherein: the lithium-ion battery, after the cycling or the storage, exhibits a gradient in a concentration of the at least one transition metal from the cathode across the separator coating to the anode, the concentration being highest in the cathode.

Clause 104. The method of any of clauses 101 to 103, further comprising: carrying out cycling of at least 300 full charge-discharge cycles on the lithium-ion battery or storing the lithium-ion battery in a fully charged state at a temperature of about 60° C. for at least 30 days, wherein: the separator coating exhibits an atomic ratio of Al to the at least one transition metal in a range of about 1:1 to about 4:1 after the cycling or the storage of the lithium-ion battery.

Clause 105. A method comprising: carrying out a first instantiation and a second instantiation of the method of any of clauses 73 to 104, the integrated electrode-separator component of the first instantiation being an integrated anode-separator component, the integrated electrode-separator component of the second instantiation being an integrated cathode-separator component; assembling a lithium-ion battery from at least (1) the integrated anode-separator component, the electrode coating thereof being configured as an anode of the lithium-ion battery, (2) the integrated cathode-separator component, the electrode coating thereof being configured as a cathode of the lithium-ion battery, and (3) an electrolyte ionically coupling the anode and the cathode, the separator coating of the integrated anode-separator component and the separator coating of the integrated cathode-separator component being in contact with each other and facing toward each other, constituting a separator; wherein: the electrode active material of the anode is an anode active material; the electrode active material of the cathode is a cathode active material; and the cathode active material comprises at least one transition metal selected from the group consisting of Ni, Mn, Co, and Fe.

Clause 106. The method of clause 105, wherein: the cathode active material comprises one or more of the following: LiNiₓMn_{y}Co_{z}O₂, a sum of x, y, and z being about 1 and at least one of x, y, and z being greater than 0; Li₁₊ₚMn₂—O₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Clause 107. The method of any of clauses 105 to 106, wherein: the anode active material comprises graphite particles.

Clause 108. The method of any of clauses 105 to 107, wherein: the anode active material comprises composite particles, each of the composite particles comprising carbon and silicon.

Clause 109. The method of any of clauses 105 to 108, wherein: the anode active material comprises a mixture of graphite particles and composite particles that are separate from the graphite particles, each of the composite particles comprising carbon and silicon.

Clause 110. The method of any of clauses 105 to 109, further comprising: carrying out cycling of at least 300 full charge-discharge cycles on the lithium-ion battery or storing the lithium-ion battery in a fully charged state at a temperature of about 60° C. for at least 30 days, wherein: the lithium-ion battery, after the cycling or the storage, exhibits a gradient in a concentration of the at least one transition metal from the cathode across the separator to the anode, the concentration being highest in the cathode.

Clause 111. The method of any of clauses 105 to 110, further comprising: carrying out cycling of at least 300 full charge-discharge cycles on the lithium-ion battery or storing the lithium-ion battery in a fully charged state at a temperature of about 60° C. for at least 30 days, wherein: the separator exhibits an atomic ratio of Al to the at least one transition metal in a range of about 1:1 to about 4:1 after the cycling or the storage of the lithium-ion battery.

Additional implementation examples are described in the following numbered Additional Clauses:

Additional Clause 1: Elongate ceramic particles, comprising: γ-alumina, wherein: a mass fraction of the γ-alumina in the elongate ceramic particles is in a range of about 70 to about 100 wt. %; a Brunauer-Emmett-Teller specific surface area (BET-SSA) of the elongate ceramic particles is in a range of about 30 to about 400 m²/g; an average aspect ratio of the elongate ceramic particles is at least about 3; and a cumulative pore volume of the elongate ceramic particles in a pore width range of 7 to 20 nm is in a range of about 1.0×10⁻² to about 1.0 cm³/g.

Additional Clause 2: The elongate ceramic particles of Additional Clause 1, wherein: an average width of the elongate ceramic particles is in a range of about 20 to about 400 nm.

Additional Clause 3: The elongate ceramic particles of any of Additional Clauses 1 to 2, wherein: the mass fraction is in a range of about 80 to about 100 wt. %.

Additional Clause 4: The elongate ceramic particles of any of Additional Clauses 1 to 3, wherein: the mass fraction is in a range of about 90 to about 100 wt. %.

Additional Clause 5: The elongate ceramic particles of any of Additional Clauses 1 to 4, wherein: the cumulative pore volume of the elongate ceramic particles in the pore width range of 7 to 20 nm is in a range of about 3.0×10⁻² to about 0.5 cm³/g; and/or a cumulative pore volume of micropores in the elongate ceramic particles is in a range of about 1.0×10⁻³ to about 2.0×10⁻² cm³/g.

Additional Clause 6: The elongate ceramic particles of any of Additional Clauses 1 to 5, wherein: a cumulative pore volume of mesopores in the elongate ceramic particles is in a range of about 5.0×10⁻² to about 1.0 cm³/g; and/or a cumulative pore volume of macropores in the elongate ceramic particles is in a range of about 2.0×10⁻² to about 0.5 cm³/g.

Additional Clause 7: The elongate ceramic particles of any of Additional Clauses 1 to 6, wherein: an average length of the elongate ceramic particles is in a range of about 1 to about 50 μm.

Additional Clause 8: The elongate ceramic particles of any of Additional Clauses 1 to 7, wherein: a total pore volume (TPV) of the elongate ceramic particles is in a range of about 2.0×10⁻² to about 2.0 cm³/g; and/or the cumulative pore volume of the elongate ceramic particles in the pore width range of 7 to 20 nm, divided by the TPV of the elongate ceramic particles, is in a range of about 15 to about 65%.

Additional Clause 9: The elongate ceramic particles of any of Additional Clauses 1 to 8, wherein: the elongate ceramic particles comprise one or more amine-comprising functional groups at one or more respective surfaces.

Additional Clause 10: An integrated electrode-separator component, comprising: an electrode coating disposed on and/or in a current collector and comprising electrode active material; and a separator coating disposed on the electrode coating comprising the elongate ceramic particles of any of Additional Clauses 1 to 9, wherein: a thickness of the separator coating is in a range of about 1.0 to about 20.0 μm.

Additional Clause 11: The integrated electrode-separator component of any of Additional Clauses 1 to 10, wherein: the thickness is in a range of about 1.0 to about 10.0 μm.

Additional Clause 12: The integrated electrode-separator component of any of Additional Clauses 1 to 11, wherein: the thickness is in a range of about 1.0 to about 5.0 μm.

Additional Clause 13: The integrated electrode-separator component of any of Additional Clauses 1 to 12, wherein: the thickness is in a range of about 1.0 to about 3.0 μm.

Additional Clause 14: The integrated electrode-separator component of any of Additional Clauses 1 to 13, wherein: the separator coating comprises one or more amine-comprising functional groups.

Additional Clause 15: The integrated electrode-separator component of any of Additional Clauses 1 to 14, wherein: the electrode coating comprises a cathode active material comprising at least one transition metal selected from the group consisting of Ni, Mn, Co, and Fe.

Additional Clause 16: The integrated electrode-separator component of any of Additional Clauses 1 to 15, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Additional Clause 17: A lithium-ion battery, comprising: the integrated electrode-separator component of any of Additional Clauses 1 to 16, the electrode coating thereof being configured as a cathode of the lithium-ion battery; an anode in contact with and facing toward the separator coating of the integrated electrode-separator component, the anode comprising an anode active material; and an electrolyte ionically coupling the cathode and the anode.

Additional Clause 18: The lithium-ion battery of any of Additional Clauses 1 to 17, wherein: the anode active material comprises composite particles, each of the composite particles comprising carbon and silicon.

Additional Clause 19: The lithium-ion battery of any of Additional Clauses 1 to 18, wherein: the anode active material comprises a mixture of graphite particles and composite particles that are separate from the graphite particles, each of the composite particles comprising carbon and silicon.

Additional Clause 20: The lithium-ion battery of any of Additional Clauses 1 to 19, wherein: the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator coating to the anode, the concentration being highest in the cathode; and/or the separator coating exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

Additional Clause 21: The integrated electrode-separator component of any of Additional Clauses 1 to 20, wherein: the electrode coating comprises an anode active material.

Additional Clause 22: The integrated electrode-separator component of any of Additional Clauses 1 to 21, wherein: the anode active material comprises composite particles, each of the composite particles comprising carbon and silicon.

Additional Clause 23: The integrated electrode-separator component of any of Additional Clauses 1 to 22, wherein: the anode active material comprises a mixture of graphite particles and composite particles that are separate from the graphite particles, each of the composite particles comprising carbon and silicon.

Additional Clause 24: A lithium-ion battery, comprising: the integrated electrode-separator component of any of Additional Clauses 1 to 23, the electrode coating thereof being configured as an anode of the lithium-ion battery; a cathode in contact with and facing toward the separator coating of the integrated electrode-separator component; and an electrolyte ionically coupling the cathode and the anode, wherein: the cathode comprises a cathode active material comprising at least one transition metal selected from the group consisting of Ni, Mn, Co, and Fe.

Additional Clause 25: The lithium-ion battery of any of Additional Clauses 1 to 24, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Additional Clause 26: The lithium-ion battery of any of Additional Clauses 1 to 25, wherein: the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator coating to the anode, the concentration being highest in the cathode; and/or the separator coating exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

Additional Clause 27: A lithium-ion battery, comprising: a first instantiation and a second instantiation of the integrated electrode-separator component of any of Additional Clauses 1 to 26, the electrode coating of the first instantiation being configured as an anode of the lithium-ion battery, the electrode coating of the second instantiation being configured as a cathode of the lithium-ion battery; the separator coating of the first instantiation and the separator coating of the second instantiation being in contact with each other and facing toward each other, constituting at least part of a separator; and an electrolyte ionically coupling the cathode and the anode, wherein: the anode comprises an anode active material; and the cathode comprises a cathode active material comprising at least one transition metal selected from the group consisting of Ni, Mn, Co, and Fe.

Additional Clause 28: The lithium-ion battery of any of Additional Clauses 1 to 27, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Additional Clause 29: The lithium-ion battery of any of Additional Clauses 1 to 28, wherein: the anode active material comprises composite particles, each of the composite particles comprising carbon and silicon.

Additional Clause 30: The lithium-ion battery of any of Additional Clauses 1 to 29, wherein: the anode active material comprises a mixture of graphite particles and composite particles that are separate from the graphite particles, each of the composite particles comprising carbon and silicon.

Additional Clause 31: The lithium-ion battery of any of Additional Clauses 1 to 30, wherein: the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator to the anode, the concentration being highest in the cathode; and/or the separator exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

Additional Clause 32: A separator, comprising: a polymer membrane; and a separator coating disposed on the polymer membrane comprising the elongate ceramic particles of any of Additional Clauses 1 to 31, wherein: a thickness of the separator coating is in a range of about 1.0 to about 20.0 μm.

Additional Clause 33: The separator of any of Additional Clauses 1 to 32, wherein: the thickness is in a range of about 1.0 to about 3.0 μm.

Additional Clause 34: The separator of any of Additional Clauses 1 to 33, wherein: the thickness is in a range of about 1.2 to about 1.8 μm.

Additional Clause 35: The separator of any of Additional Clauses 1 to 34, wherein: the separator coating comprises one or more amine-comprising functional groups.

Additional Clause 36: A lithium-ion battery, comprising: an anode comprising an anode active material; a cathode comprising a cathode active material comprising at least one transition metal selected from the group consisting of Ni, Mn, Co, and Fe; an electrolyte ionically coupling the anode and the cathode; and the separator of any of Additional Clauses 1 to 35 disposed in a space between the anode and the cathode.

Additional Clause 37: The lithium-ion battery of any of Additional Clauses 1 to 36, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Additional Clause 38: The lithium-ion battery of any of Additional Clauses 1 to 37, wherein: the anode active material comprises composite particles, each of the composite particles comprising carbon and silicon.

Additional Clause 39: The lithium-ion battery of any of Additional Clauses 1 to 38, wherein: the anode active material comprises a mixture of graphite particles and composite particles that are separate from the graphite particles, each of the composite particles comprising carbon and silicon.

Additional Clause 40: The lithium-ion battery of any of Additional Clauses 1 to 39, wherein: the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator to the anode, the concentration being highest in the cathode; and/or the separator exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

Additional Clause 41: A method comprising: providing a polymer membrane; coating a dispersion comprising elongate ceramic particles comprising γ-alumina on the polymer membrane to form a separator coating on the polymer membrane, a separator comprising the polymer membrane and the separator coating disposed on the polymer membrane, wherein: a mass fraction of the γ-alumina in the elongate ceramic particles is in a range of about 70 to about 100 wt. %; a Brunauer-Emmett-Teller specific surface area (BET-SSA) of the elongate ceramic particles is in a range of about 30 to about 400 m²/g; an average aspect ratio of the elongate ceramic particles is at least about 3; and a cumulative pore volume of the elongate ceramic particles in a pore width range of 7 to 20 nm is in a range of about 1.0×10⁻² to about 1.0 cm³/g.

Additional Clause 42: The method of Additional Clause 41, wherein: an average width of the elongate ceramic particles is in a range of about 20 to about 400 nm.

Additional Clause 43: The method of any of Additional Clauses 41 to 42, wherein: the mass fraction is in a range of about 80 to about 100 wt. %.

Additional Clause 44: The method of any of Additional Clauses 41 to 43, wherein: the mass fraction is in a range of about 90 to about 100 wt. %.

Additional Clause 45: The method of any of Additional Clauses 41 to 44, wherein: the cumulative pore volume of the elongate ceramic particles in the pore width range of 7 to 20 nm is in a range of about 3.0×10⁻² to 0.5 cm³/g; and/or a cumulative pore volume of micropores in the elongate ceramic particles is in a range of about 1.0×10⁻³ to about 2.0×10⁻² cm³/g.

Additional Clause 46: The method of any of Additional Clauses 41 to 45, wherein: a cumulative pore volume of mesopores in the elongate ceramic particles is in a range of about 5.0×10⁻² to about 1.0 cm³/g; and/or a cumulative pore volume of macropores in the elongate ceramic particles is in a range of about 2.0×10⁻² to about 0.5 cm³/g.

Additional Clause 47: The method of any of Additional Clauses 41 to 46, wherein: an average length of the elongate ceramic particles is in a range of about 2 to about 50 μm.

Additional Clause 48: The method of any of Additional Clauses 41 to 47, wherein: a total pore volume (TPV) of the elongate ceramic particles is in a range of about 2.0×10⁻² to about 2.0 cm³/g; and/or the cumulative pore volume of the elongate ceramic particles in the pore width range of 7 to 20 nm, divided by a total pore volume (TPV) of the elongate ceramic particles, is in a range of about 15 to about 65%.

Additional Clause 49: The method of any of Additional Clauses 41 to 48, wherein: the elongate ceramic particles comprise one or more amine-comprising functional groups at one or more respective surfaces; and/or the separator coating comprises one or more amine-comprising functional groups.

Additional Clause 50: The method of any of Additional Clauses 41 to 49, wherein: a thickness of the separator coating is in a range of about 1.0 to about 20.0 μm.

Additional Clause 51: The method of any of Additional Clauses 41 to 50, wherein: the thickness is in a range of about 1.0 to about 3.0 μm.

Additional Clause 52: The method of any of Additional Clauses 41 to 51, wherein: the thickness is in a range of about 1.2 to about 1.8 μm.

Additional Clause 53: The method of any of Additional Clauses 41 to 52, further comprising: assembling a lithium-ion battery from at least an anode, a cathode comprising a cathode active material comprising at least one transition metal selected from the group consisting of Ni, Mn, Co, and Fe, an electrolyte ionically coupling the anode and the cathode, and the separator disposed in a space between the anode and the cathode.

Additional Clause 54: The method of any of Additional Clauses 41 to 53, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Additional Clause 55: The method of any of Additional Clauses 41 to 54, wherein: the anode comprises composite particles, each of the composite particles comprising carbon and silicon.

Additional Clause 56: The method of any of Additional Clauses 41 to 55, wherein: the anode comprises a mixture of graphite particles and composite particles that are separate from the graphite particles, each of the composite particles comprising carbon and silicon.

Additional Clause 57: The method of any of Additional Clauses 41 to 56, further comprising: carrying out cycling of at least 300 full charge-discharge cycles on the lithium-ion battery or storing the lithium-ion battery in a fully charged state at a temperature of about 60° C. for at least 30 days, wherein: the lithium-ion battery, after the cycling or the storage, exhibits a gradient in a concentration of the at least one transition metal from the cathode across the separator to the anode, the concentration being highest in the cathode; and/or the separator exhibits an atomic ratio of Al to the at least one transition metal in a range of about 1:1 to about 4:1 after the cycling or the storage of the lithium-ion battery.

Additional Clause 58: A method, comprising: providing an electrode coating disposed on a current collector and comprising electrode active material; and coating a dispersion comprising elongate ceramic particles comprising γ-alumina on the electrode coating to form a separator coating on the electrode coating, an integrated electrode-separator component comprising the electrode coating disposed on the current collector and the separator coating disposed on the electrode coating, wherein: a mass fraction of the γ-alumina in the elongate ceramic particles is in a range of about 70 to about 100 wt. %; a Brunauer-Emmett-Teller specific surface area (BET-SSA) of the elongate ceramic particles is in a range of about 30 to about 400 m²/g; an average aspect ratio of the elongate ceramic particles is at least about 3; and a cumulative pore volume of the elongate ceramic particles in a pore width range of 7 to 20 nm is in a range of about 1.0×10⁻² to about 1.0 cm³/g.

Additional Clause 59: The method of Additional Clause 58, wherein: an average width of the elongate ceramic particles is in a range of about 20 to about 400 nm.

Additional Clause 60: The method of any of Additional Clauses 58 to 59, wherein: the mass fraction is in a range of about 80 to about 100 wt. %.

Additional Clause 61: The method of any of Additional Clauses 58 to 60, wherein: the mass fraction is in a range of about 90 to about 100 wt. %.

Additional Clause 62: The method of any of Additional Clauses 58 to 61, wherein: the cumulative pore volume of the elongate ceramic particles in the pore width range of 7 to 20 nm is in a range of about 3.0×10⁻² to about 0.5 cm³/g; and/or a cumulative pore volume of micropores in the elongate ceramic particles is in a range of about 1.0×10⁻³ to about 2.0×10⁻² cm³/g.

Additional Clause 63: The method of any of Additional Clauses 58 to 62, wherein: a cumulative pore volume of mesopores in the elongate ceramic particles is in a range of 5.0×10⁻² to 1.0 cm³/g; and/or a cumulative pore volume of macropores in the elongate ceramic particles is in a range of about 2.0×10⁻² to about 0.5 cm³/g.

Additional Clause 64: The method of any of Additional Clauses 58 to 63, wherein: an average length of the elongate ceramic particles is in a range of about 2 to about 50 μm.

Additional Clause 65: The method of any of Additional Clauses 58 to 64, wherein: a total pore volume (TPV) of the elongate ceramic particles is about 2.0×about 10⁻² to 2.0 cm³/g; and/or the cumulative pore volume of the elongate ceramic particles in the pore width range of 7 to 20 nm, divided by a total pore volume (TPV) of the elongate ceramic particles, is in a range of about 15 to about 65%.

Additional Clause 66: The method of any of Additional Clauses 58 to 65, wherein: the elongate ceramic particles comprise one or more amine-comprising functional groups at one or more respective surfaces; and/or the separator coating comprises one or more amine-comprising functional groups.

Additional Clause 67: The method of any of Additional Clauses 58 to 66, wherein: a thickness of the separator coating is in a range of about 1.0 to about 20.0 μm.

Additional Clause 68: The method of any of Additional Clauses 58 to 67, wherein: the thickness is in a range of about 1.0 to about 10.0 μm.

Additional Clause 69: The method of any of Additional Clauses 58 to 68, wherein: the thickness is in a range of about 1.0 to about 5.0 μm.

Additional Clause 70: The method of any of Additional Clauses 58 to 69, wherein: the thickness is in a range of about 1.0 to about 3.0 μm.

Additional Clause 71: The method of any of Additional Clauses 58 to 70, wherein: the electrode coating comprises a cathode active material comprising at least one transition metal selected from the group consisting of Ni, Mn, Co, and Fe.

Additional Clause 72: The method of any of Additional Clauses 58 to 71, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Additional Clause 73: The method of any of Additional Clauses 58 to 72, further comprising: assembling a lithium-ion battery from at least the integrated electrode-separator component, the electrode coating thereof being configured as a cathode of the lithium-ion battery, an anode in contact with and facing toward the separator coating of the integrated electrode-separator component, and an electrolyte ionically coupling the cathode and the anode.

Additional Clause 74: The method of any of Additional Clauses 58 to 73, wherein: the anode comprises composite particles, each of the composite particles comprising carbon and silicon.

Additional Clause 75: The method of any of Additional Clauses 58 to 74, wherein: the anode comprises a mixture of graphite particles and composite particles that are separate from the graphite particles, each of the composite particles comprising carbon and silicon.

Additional Clause 76: The method of any of Additional Clauses 58 to 75, further comprising: carrying out cycling of at least 300 full charge-discharge cycles on the lithium-ion battery or storing the lithium-ion battery in a fully charged state at a temperature of about 60° C. for at least 30 days, wherein: the lithium-ion battery, after the cycling or the storage, exhibits a gradient in a concentration of the at least one transition metal from the cathode across the separator coating to the anode, the concentration being highest in the cathode; and/or the separator coating exhibits an atomic ratio of Al to the at least one transition metal in a range of about 1:1 to about 4:1 after the cycling or the storage of the lithium-ion battery.

Additional Clause 77: The method of any of Additional Clauses 58 to 76, wherein: the electrode coating comprises an anode active material.

Additional Clause 78: The method of any of Additional Clauses 58 to 77, wherein: the anode active material comprises composite particles, each of the composite particles comprising carbon and silicon.

Additional Clause 79: The method of any of Additional Clauses 58 to 78, wherein: the anode active material comprises a mixture of graphite particles and composite particles that are separate from the graphite particles, each of the composite particles comprising carbon and silicon.

Additional Clause 80: The method of any of Additional Clauses 58 to 79, further comprising: assembling a lithium-ion battery from at least the integrated electrode-separator component, the electrode coating thereof being configured as an anode of the lithium-ion battery, a cathode in contact with and facing toward the separator coating of the integrated electrode-separator component, and an electrolyte ionically coupling the cathode and the anode, wherein: the cathode comprises a cathode active material comprising at least one transition metal selected from the group consisting of Ni, Mn, Co, and Fe.

Additional Clause 81: The method of any of Additional Clauses 58 to 80, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Additional Clause 82: The method of any of Additional Clauses 58 to 81, further comprising: carrying out cycling of at least 300 full charge-discharge cycles on the lithium-ion battery or storing the lithium-ion battery in a fully charged state at a temperature of about 60° C. for at least 30 days, wherein: the lithium-ion battery, after the cycling or the storage, exhibits a gradient in a concentration of the at least one transition metal from the cathode across the separator coating to the anode, the concentration being highest in the cathode; and/or the separator coating exhibits an atomic ratio of Al to the at least one transition metal in a range of about 1:1 to about 4:1 after the cycling or the storage of the lithium-ion battery.

Additional Clause 83: A method comprising: carrying out a first instantiation and a second instantiation of the method of any of Additional Clauses 58 to 82, the integrated electrode-separator component of the first instantiation being an integrated anode-separator component, the integrated electrode-separator component of the second instantiation being an integrated cathode-separator component; assembling a lithium-ion battery from at least (1) the integrated anode-separator component, the electrode coating thereof being configured as an anode of the lithium-ion battery, (2) the integrated cathode-separator component, the electrode coating thereof being configured as a cathode of the lithium-ion battery, and (3) an electrolyte ionically coupling the anode and the cathode, the separator coating of the integrated anode-separator component and the separator coating of the integrated cathode-separator component being in contact with each other and facing toward each other, constituting a separator; wherein: the electrode active material of the anode is an anode active material; the electrode active material of the cathode is a cathode active material; and the cathode active material comprises at least one transition metal selected from the group consisting of Ni, Mn, Co, and Fe.

Additional Clause 84: The method of any of Additional Clauses 58 to 83, wherein: the cathode active material comprises one or more of the following: LiNiₓMn_{y}Co_{z}O₂, a sum of x, y, and z being about 1 and at least one of x, y, and z being greater than 0; Li₁₊ₚMn₂₋ₚO₄, p being greater than or equal to 0 and p being less than 2; LiNi_{q}Mn_{2-q}O₄, q being greater than or equal to 0 and q being less than 2; and LiFe₁₋ᵣMnᵣPO₄, r being greater than or equal to 0 and r being less than or equal to 1.

Additional Clause 85: The method of any of Additional Clauses 58 to 84, wherein: the anode active material comprises composite particles, each of the composite particles comprising carbon and silicon.

Additional Clause 86: The method of any of Additional Clauses 58 to 85, wherein: the anode active material comprises a mixture of graphite particles and composite particles that are separate from the graphite particles, each of the composite particles comprising carbon and silicon.

Additional Clause 87: The method of any of Additional Clauses 58 to 86, further comprising: carrying out cycling of at least 300 full charge-discharge cycles on the lithium-ion battery or storing the lithium-ion battery in a fully charged state at a temperature of about 60° C. for at least 30 days, wherein: the lithium-ion battery, after the cycling or the storage, exhibits a gradient in a concentration of the at least one transition metal from the cathode across the separator to the anode, the concentration being highest in the cathode; and/or the separator exhibits an atomic ratio of Al to the at least one transition metal in a range of about 1:1 to about 4:1 after the cycling or the storage of the lithium-ion battery.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. Elongate ceramic particles, comprising:
γ-alumina,
wherein:
a mass fraction of the γ-alumina in the elongate ceramic particles is in a range of about 70 to about 100 wt. %;
a Brunauer-Emmett-Teller specific surface area (BET-SSA) of the elongate ceramic particles is in a range of about 30 to about 400 m²/g;
an average aspect ratio of the elongate ceramic particles is at least about 3; and
a cumulative pore volume of the elongate ceramic particles in a pore width range of 7 to 20 nm is in a range of about 1.0×10⁻² to about 1.0 cm³/g.

2. The elongate ceramic particles of claim 1, wherein:
an average width of the elongate ceramic particles is in a range of about 20 to about 400 nm.

3. The elongate ceramic particles of claim 1, wherein:
the mass fraction is in a range of about 80 to about 100 wt. %.

4. The elongate ceramic particles of claim 3, wherein:
the mass fraction is in a range of about 90 to about 100 wt. %.

5. The elongate ceramic particles of claim 1, wherein:
the cumulative pore volume of the elongate ceramic particles in the pore width range of 7 to 20 nm is in a range of about 3.0×10⁻² to about 0.5 cm³/g; and/or
a cumulative pore volume of micropores in the elongate ceramic particles is in a range of about 1.0×10⁻³ to about 2.0×10⁻² cm³/g.

6. The elongate ceramic particles of claim 1, wherein:
a cumulative pore volume of mesopores in the elongate ceramic particles is in a range of about 5.0×10⁻² to about 1.0 cm³/g; and/or
a cumulative pore volume of macropores in the elongate ceramic particles is in a range of about 2.0×10⁻² to about 0.5 cm³/g.

7. The elongate ceramic particles of claim 1, wherein:
an average length of the elongate ceramic particles is in a range of about 1 to about 50 μm.

8. The elongate ceramic particles of claim 1, wherein:
a total pore volume (TPV) of the elongate ceramic particles is in a range of about 2.0×10⁻² to about 2.0 cm³/g; and/or
the cumulative pore volume of the elongate ceramic particles in the pore width range of 7 to 20 nm, divided by the TPV of the elongate ceramic particles, is in a range of about 15 to about 65%.

9. The elongate ceramic particles of claim 1, wherein:
the elongate ceramic particles comprise one or more amine-comprising functional groups at one or more respective surfaces.

10. An integrated electrode-separator component, comprising:
an electrode coating disposed on and/or in a current collector and comprising electrode active material; and
a separator coating disposed on the electrode coating comprising the elongate ceramic particles of claim 1,
wherein:
a thickness of the separator coating is in a range of about 1.0 to about 20.0 μm.

11. The integrated electrode-separator component of claim 10, wherein:
the thickness is in a range of about 1.0 to about 10.0 μm.

12. The integrated electrode-separator component of claim 11, wherein:
the thickness is in a range of about 1.0 to about 5.0 μm.

13. The integrated electrode-separator component of claim 12, wherein:
the thickness is in a range of about 1.0 to about 3.0 μm.

14. The integrated electrode-separator component of claim 10, wherein:
the separator coating comprises one or more amine-comprising functional groups.

15. The integrated electrode-separator component of claim 10, wherein:
the electrode coating comprises a cathode active material comprising at least one transition metal selected from the group consisting of Ni, Mn, Co, and Fe.

16. The integrated electrode-separator component of claim 15, wherein:
the cathode active material comprises one or more of the following:
LiNiₓMn_{y}Co_{z}O₂, a sum of x, y, and z being about 1 and at least one of x, y, and z being greater than 0;
Li₁₊ₚMn₂₋ₚO₄, p being greater than or equal to 0 and p being less than 2;
LiNi_{q}Mn_{2-q}O₄, q being greater than or equal to 0 and q being less than 2; and
LiFe₁₋ᵣMnᵣPO₄, r being greater than or equal to 0 and r being less than or equal to 1.

17. A lithium-ion battery, comprising:
the integrated electrode-separator component of claim 15, the electrode coating thereof being configured as a cathode of the lithium-ion battery;
an anode in contact with and facing toward the separator coating of the integrated electrode-separator component, the anode comprising an anode active material; and
an electrolyte ionically coupling the cathode and the anode.

18. The lithium-ion battery of claim 17, wherein:
the anode active material comprises composite particles, each of the composite particles comprising carbon and silicon.

19. The lithium-ion battery of claim 17, wherein:
the anode active material comprises a mixture of graphite particles and composite particles that are separate from the graphite particles, each of the composite particles comprising carbon and silicon.

20. The lithium-ion battery of claim 17, wherein:
the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator coating to the anode, the concentration being highest in the cathode; and/or
the separator coating exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

21. The integrated electrode-separator component of claim 10, wherein:
the electrode coating comprises an anode active material.

22. The integrated electrode-separator component of claim 21, wherein:
the anode active material comprises composite particles, each of the composite particles comprising carbon and silicon.

23. The integrated electrode-separator component of claim 21, wherein:
the anode active material comprises a mixture of graphite particles and composite particles that are separate from the graphite particles, each of the composite particles comprising carbon and silicon.

24. A lithium-ion battery, comprising:
the integrated electrode-separator component of claim 21, the electrode coating thereof being configured as an anode of the lithium-ion battery;
a cathode in contact with and facing toward the separator coating of the integrated electrode-separator component; and
an electrolyte ionically coupling the cathode and the anode,
wherein:
the cathode comprises a cathode active material comprising at least one transition metal selected from the group consisting of Ni, Mn, Co, and Fe.

25. The lithium-ion battery of claim 24, wherein:
the cathode active material comprises one or more of the following:
LiNiₓMn_{y}Co_{z}O₂, a sum of x, y, and z being about 1 and at least one of x, y, and z being greater than 0;
Li₁₊ₚMn₂₋ₚO₄, p being greater than or equal to 0 and p being less than 2;
LiNi_{q}Mn_{2-q}O₄, q being greater than or equal to 0 and q being less than 2; and
LiFe₁₋ᵣMnᵣPO₄, r being greater than or equal to 0 and r being less than or equal to 1.

26. The lithium-ion battery of claim 24, wherein:
the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator coating to the anode, the concentration being highest in the cathode; and/or
the separator coating exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

27. A lithium-ion battery, comprising:
a first instantiation and a second instantiation of the integrated electrode-separator component of claim 10, the electrode coating of the first instantiation being configured as an anode of the lithium-ion battery, the electrode coating of the second instantiation being configured as a cathode of the lithium-ion battery;
the separator coating of the first instantiation and the separator coating of the second instantiation being in contact with each other and facing toward each other, constituting at least part of a separator; and
an electrolyte ionically coupling the cathode and the anode,
wherein:
the anode comprises an anode active material; and
the cathode comprises a cathode active material comprising at least one transition metal selected from the group consisting of Ni, Mn, Co, and Fe.

28. The lithium-ion battery of claim 27, wherein:
the cathode active material comprises one or more of the following:
LiNiₓMn_{y}Co_{z}O₂, a sum of x, y, and z being about 1 and at least one of x, y, and z being greater than 0;
Li₁₊ₚMn₂₋ₚO₄, p being greater than or equal to 0 and p being less than 2;
LiNi_{q}Mn_{2-q}O₄, q being greater than or equal to 0 and q being less than 2; and
LiFe₁₋ᵣMnᵣPO₄, r being greater than or equal to 0 and r being less than or equal to 1.

29. The lithium-ion battery of claim 27, wherein:
the anode active material comprises composite particles, each of the composite particles comprising carbon and silicon.

30. The lithium-ion battery of claim 27, wherein:
the anode active material comprises a mixture of graphite particles and composite particles that are separate from the graphite particles, each of the composite particles comprising carbon and silicon.

31. The lithium-ion battery of claim 27, wherein:
the lithium-ion battery, after at least 300 full charge-discharge cycles, or after storage, in a fully charged state at a temperature of about 60° C., for at least 30 days, exhibits a gradient in a concentration of the at least one transition metal from the cathode across the separator to the anode, the concentration being highest in the cathode; and/or
the separator exhibits an atomic ratio of Al to the at least one transition metal in a range of about 1:1 to about 4:1 after the lithium-ion battery has undergone at least 300 full charge-discharge cycles, or storage, in a fully charged state at a temperature of about 60° C., for at least 30 days.

32.-87. (canceled)
